(19) United States
(12) Patent Application Publication
(10) Pub. No.: US 2005/0210263 A1
(43) Pub. Date: Sep. 22, 2005

(54) Electronic form routing and data capture system and method

(76) Inventors: Robert George Levas, Mt. Laurel, NJ (US); Samuel Garst, Philadelphia, PA (US); Michael Goldstein, Princeton, NJ (US); Vincent Di Felice, Unionville, PA (US); Benjamin Paul Hollin, Havertown, PA (US); Hong Xiang Gao, Downingtown, PA (US); Robert Lusardi, Portland, OR (US); David J. Ruggieri, Flourtown, PA (US); Carl A. Gunter, Urbana, IL (US)

Correspondence Address: Daniel H. Golub, 1701 Market Street, Philadelphia, PA, 19103, US

(21) Appl. No.: 10/949,540

(22) Filed: Sep. 24, 2004

Related U.S. Application Data
(63) Continuation-in-part of application No. 10/339,792, filed on Jan. 9, 2003.
(63) Continuation-in-part of application No. 10/339,792, filed on Jan. 9, 2003.
Application No. 10/339,792 is a continuation-in-part of application No. 09/842,266, filed on Apr. 25, 2001.
Application No. 10/339,792 is a continuation-in-part of application No. 09/841,732, filed on Apr. 25, 2001.
Application No. 10/339,792 is a continuation-in-part of application No. 09/842,268, filed on Apr. 25, 2001.
Application No. 10/339,792 is a continuation-in-part of application No. 09/841,733, filed on Apr. 25, 2001.
Application No. 10/339,792 is a continuation-in-part of application No. 09/842,267, filed on Apr. 25, 2001.
Application No. 10/339,792 is a continuation-in-part of application No. 09/841,731, filed on Apr. 25, 2001.
Application No. 10/339,792 is a continuation-in-part of application No. 09/842,269, filed on Apr. 25, 2001, now Pat. No. 6,885,388.
Application No. 10/339,792 is a continuation-in-part of application No. 10/090,689, filed on Mar. 5, 2002.
Application No. 10/339,792 is a continuation-in-part of application No. 10/090,680, filed on Mar. 5, 2002.
Application No. 10/339,792 is a continuation-in-part of application No. 10/090,681, filed on Mar. 5, 2002.
Application No. 10/339,792 is a continuation-in-part of application No. 10/090,679, filed on Mar. 5, 2002.
(60) Provisional application No. 60/506,251, filed on Sep. 26, 2003.
(60) Provisional application No. 60/531,431, filed on Dec. 18, 2003.
(60) Provisional application No. 60/347,392, filed on Jan. 9, 2002.
(60) Provisional application No. 60/378,305, filed on May 7, 2002.

(51) Int. Cl. H04K 1/00; H04L 9/00; H04L 9/32; G06F 11/30; G06F 12/14

(52) U.S. Cl. 713/182; 713/201

(57) ABSTRACT

An electronic form routing system that includes a front-end server accessible to the users over a network via an encrypted link and a secure back-end database for storing the electronic forms and the data input by users into the form.

### CROSS REFERENCE TO RELATED APPLICATIONS

This application claims priority to U.S. Provisional Patent Application No. 60/506,251, filed Sep. 26, 2003, entitled “System and Method for Secure Deployment of Electronic Forms”, and to U.S. Provisional Patent Application No. 60/531,431, filed Dec. 18, 2003, entitled “Electronic Form Routing System”, and is a continuation in part of application Ser. No. 10/339,792, filed Jan. 9, 2003, which is a continuation in part of application Ser. Nos. 09/842,266; 09/841,732; 09/842,268; 09/841,733; 09/842,267; 09/841,731; and 09/842,269 filed Apr. 25, 2001; and Ser. No. 10/090,689; 10/090,680; 10/090,681; 10/090,679, filed Mar. 5, 2002; and which claims the benefit of Provisional Application Ser. Nos. 60/347,392, filed Jan. 9, 2002 and 60/378,305 filed May 7, 2002, all of which are incorporated herein in their entirety.

### BACKGROUND OF THE INVENTION

1. Field of the Invention

The present invention is directed generally to methods and systems for routing electronic forms and capturing data.

2. Description of the Background

Within any large organization are many different business forms. Many are mandated by regulations or the requirements of financial reporting. Others are required simply to operate the enterprise. Most business forms are still on paper, or on dowloadable files, and managed manually.

Computerizing these business forms is one of the most important ways organizations can achieve operational improvements and lower costs. Until now, full automation has seemed out of reach. Faster than new systems can be designed and deployed, shifting strategies, new regulations, and legal decisions demand changes. Enterprise models can take years to build. Process models require detailed, up-front design work before any benefits are realized, and development projects often take longer than promised and benefits fall short of expectations. Yet, increasingly stringent obligations for security, data privacy, regulatory compliance, and tighter budgets make computer support more important than ever before. What is needed is a simpler and quicker way for organizations to deploy computer-aided business processes.

### BRIEF SUMMARY OF THE INVENTION

The present invention is directed to a method and system for routing an electronic form. The electronic form includes at least two sections, at least one of the sections including at least one data field for receiving data input by one or more users. The users are provided with access to a front-end server over a network via an encrypted link. The electronic forms and the data are stored in a secure back-end database. Multiple mechanisms for allowing the user to authenticate to the front-end server are supported.

The present invention is further directed to a method and system for routing an electronic form. The electronic form includes at least two sections, at least one of the sections including at least one data field for receiving data input by one or more users. The users are provided with access to a front-end server over a network via an encrypted link. The electronic forms and the data are stored in a secure back-end database. Rights of the user to view select data in the electronic form are controlled by the server, wherein an electronic signature is applied to one or more of the sections that include the select data.

The present invention is also directed to a method and system for routing an electronic form. The electronic form includes multiple sections. The sections are indicated by tags and at least one of the sections includes at least one data field for receiving data input by one or more users. The users are provided with access to a front-end server over a network via an encrypted link. The electronic forms and the data are stored in a secure back-end database. Rights of the user to view select data in the electronic form is controlled by the server based on the section tags.

The present invention is further directed to a method and system for routing an electronic form. The electronic form includes multiple sections, wherein the sections are indicated by tags and at least one of the sections includes at least one data field for receiving data input by one or more users. The users are provided with access to a front-end server over a network via an encrypted link. The electronic forms and the data are stored in a secure back-end database. Rights of the user to edit at least one of select sections and select data in the electronic form are controlled by the server based on the section tags.

The present invention is further directed to a method and system for routing an electronic form. The electronic form includes at least two sections, wherein the sections are indicated by tags and at least one of the sections includes at least one data field for receiving data input by one or more users. The users are provided with access to a front-end server over a network via an encrypted link. The electronic forms and the data are stored in a secure back-end database. Attributes are assigned to the users wherein a form creator indicates, using one or more of the tags, which of the sections of the form can be viewed or edited by the users based on the attributes assigned to the users.

The present invention is further directed to a method and system for routing an electronic form. The electronic form includes at least two sections, wherein the sections are indicated by tags and at least one of the sections includes at least one data field for receiving data input by one or more users. The users are provided with access to a front-end server over a network via an encrypted link. The electronic forms and the data are stored in a secure back-end database. A form creator indicates, using one or more of the tags, which of the sections of the form can be viewed or edited by the users based on rules expressed in boolean logic.

Finally, the present invention is directed to a method and system for routing an electronic form. The electronic form includes at least two sections, at least one of the sections including at least one data field for receiving data input by one or more users. The users are provided with access to a front-end server over a network via an encrypted link. The electronic forms and the data are stored in a secure back-end database. One or more triggers to execute a set of one or more tasks are invoked upon the user inputting the data into one of the electronic forms and routing the form.

### BRIEF DESCRIPTION OF THE DRAWINGS

FIG. 1 illustrates an exemplary system for carrying out a preferred embodiment of the present invention;

FIG. 2 illustrates an exemplary system for carrying out a preferred embodiment of the present invention;

FIG. 3a illustrates an exemplary transaction model of a preferred embodiment of the present invention;

FIG. 3b illustrates exemplary components of a system for carrying out a preferred embodiment of the present invention;

FIG. 4 illustrates an exemplary form used in connection with a preferred embodiment of the present invention;

FIGS. 5 through 11 are flow charts illustrating preferred embodiments of the methods of the present invention;

FIG. 12 illustrates an exemplary system for carrying out a preferred embodiment of the present invention; and

FIGS. 13a and 13b illustrate an exemplary database schema that may be used in connection with one embodiment of the present invention.

### DETAILED DESCRIPTION

Reference will now be made in detail to the preferred embodiments of the present invention, examples of which are illustrated in the accompanying drawings. It is to be understood that the figures and descriptions of the present invention included herein illustrate and describe elements that are of particular relevance to the present invention, while eliminating, for purposes of clarity, other elements.

Those of ordinary skill in the art will recognize that other elements are desirable and/or required in order to implement the present invention. However, because such elements are well known in the art, and because they do not facilitate a better understanding of the present invention, a discussion of such elements is not provided herein.

Introduction

The present invention relates to an electronic forms application that supports a flexible workflow model within a highly secure, audited system. It supplies extensive support for real world business processes, such as optional routing, withdrawing forms, copying forms to other users and data masking. A full audit trail is maintained in the preferred embodiment, preserving the full transaction history of the forms. In addition, a full version history of every form may be maintained, thereby allowing earlier versions of a form to be viewed. The invention is embodied in a web-based application, in the preferred embodiment, and all functionality is available using a web browser. A forms repository may also be used in connection with the invention. The forms repository provides a simple interface for users to search for forms. In the preferred embodiment, the forms repository can support any file type, so that a form can be called up in, e.g., a Microsoft Word document, an Adobe PDF document or an electronic routable form.

For example, an electronic form may be developed, which may be identical to an existing paper form, and linked to the inventive platform. Once linked, data capture, reporting, process security and compliance documentation are automatically provided by the present invention. The electronic form can be fully or partially automated. Users can open a form in their browser, fill in required information, digitally sign, and route to the next recipient, over secure links. The inventive system manages routing of the form to successive, authorized users, capturing form data in a centrally maintained database, reporting process status to participants and managers, and maintaining a comprehensive audit trail.

The present invention eliminates the vulnerability of paper and first-generation electronic forms through an integrated, defense-in-depth approach to form security. In particular, form data is maintained on secure, centrally managed servers. Forms are “logically routed”, while remaining on the server, rather than physically routed from client to client. Communications with these servers are via encrypted connections. Database and presentation servers can be uncoupled, and sensitive data stored behind layered, increasingly-secure firewalls.

The present invention also allows for comprehensive, real-time status reporting such that all users involved in a particular process are aware of the status of the form. The business process can be documented from beginning to end. For example, data such as the identity of the users involved in the process; the identity of individuals who viewed or edited data; and the information such users viewed or edited can be tracked. Participants in the process can be authenticated and data access logged.

The inventive system fully supports digital signatures based on, e.g., passwords, smart cards or software certificates. Each signature effectively confirms the data contents of the form at the time of signature, and is maintained in the central database along with other process data.

Creating a process in accordance with a preferred embodiment of the present invention commences with the creation of a standard HTML form. Once the HTML form has been built, form tags are automatically inserted into the HTML document using a tool, described further herein. Once integrated, the new business process can take advantage of the reporting, routing, and data export capabilities of the inventive platform. Data need not be re-keyed and integration with legacy applications is accomplished using a web services interface.

System Description

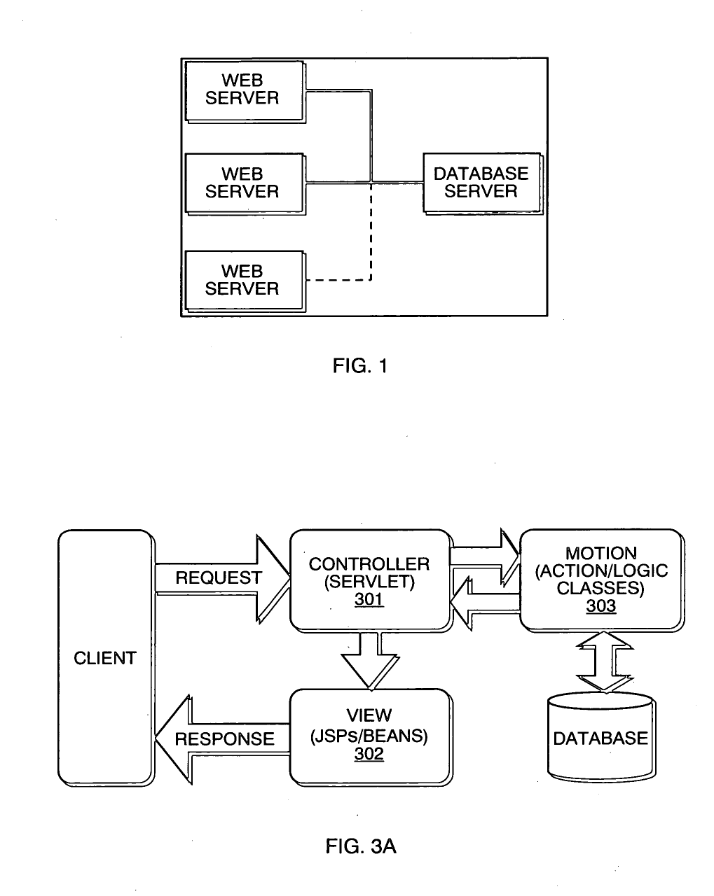

With reference to FIG. 1, a preferred embodiment of a system for carrying out the present invention includes a two tiered application, including a web server front end, connecting to a back-end database. This stable architecture lends itself to scalability, fail over and redundancy. The front end web servers are accessible to users (via the public internet or intranet), while the database server is secured in a tightly controlled DMZ. Processing occurs on the front end, while data is stored centrally on the backend database. In the preferred embodiment, the only client-side requirement is installation of an operating system and a web browser. Optionally, an application to support creation and validation of digital signatures using personal digital certificates (such as Microsoft's CAPICOM) and/or third-party Smart Card drivers may be installed.

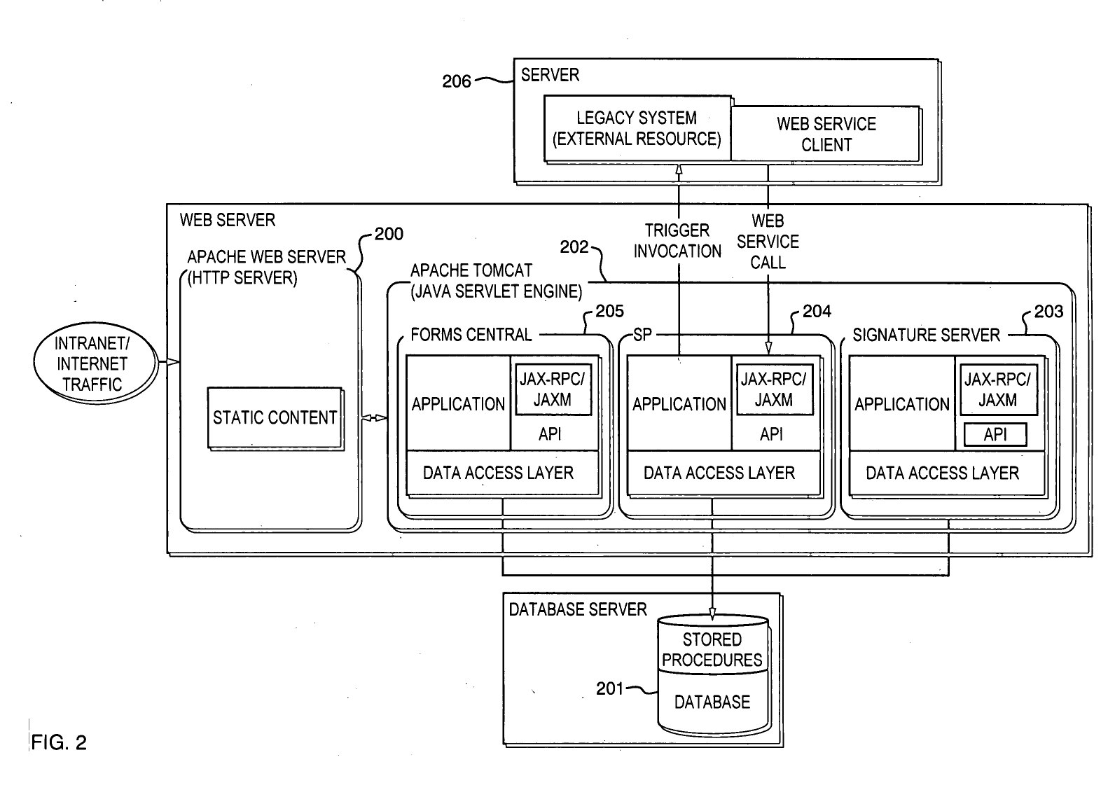

With reference to FIG. 2, a preferred embodiment of the system architecture is depicted at the server level, including the following components: an Apache web server 200, with Secure Sockets Layers (SSL) enabled; a Tomcat Java servlet engine 202; a web services engine for implementing Simple Object Access Protocol (SOAP) (e.g., Sun Microsystem's JAX-RPC and JAXM libraries); an Oracle 9i relational database 201 to store system user and form data; a signature server for managing signature images 203; a secure process server, which provides the core electronic form engine 204; and the form repository 205. In one preferred embodiment, the inventive system is in communication with the servers 206 of external systems. In other embodiments, additional components may be included and/or certain of the components illustrated in FIG. 2 may be omitted, within the scope of the present invention.

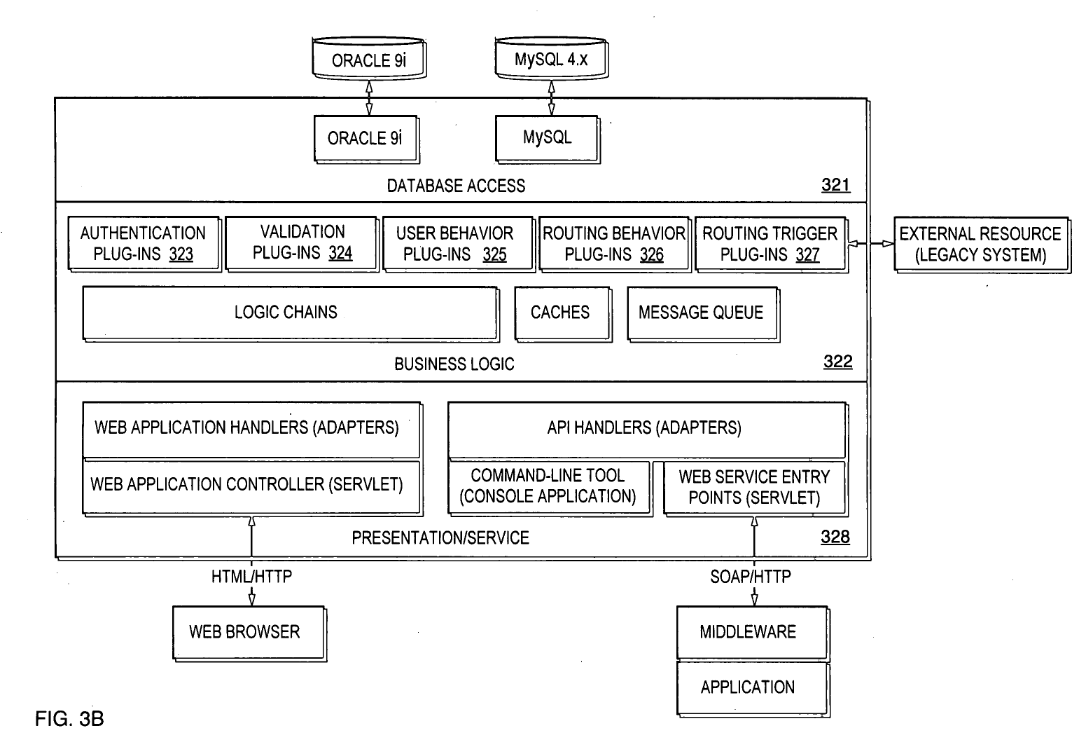

In the preferred embodiment, the inventive system employs the standard model-view-control (“MVC”) paradigm, as illustrated with reference to FIG. 3a. The actual processing of a request is controlled by the servlet 301, which includes determining which Java servlet page (“JSP”) to load, which objects to instantiate, and where to pass control. The actual business logic is encapsulated in the Java Beans 302, while the user interfaces are handled by the JSP pages.

The controller in this implementation of the MVC architecture is a single servlet that parses each HTTP request to determine the action requested by the user. The method in which the action is determined is by parsing the requested URL. Each URL is expected to be in the following format:
<scheme>://<server>/<context>/<requested-action>.do

The controller servlet finds the <requested-action> portion of the URL and looks-up the appropriate action class to call. To increase the performance of the system, on both startup and runtime, action classes are loaded as necessary and then cached. The process of looking up action classes includes first looking in the cache for an action associated with the <requested-action> portion of the requested URL. If an appropriate class is not found, the class name of the class designated to handle the requested action is looked-up from the actions resource bundle. During this second attempt to find the action handler class, two error conditions may be encountered:
1) No handler is specified in the resource bundle
2) The specified class in the resource bundle cannot be loaded
   a. Due to class not found error
   b. Due to class initialization error

In either case, the controller servlet remains in control of the operation and causes an error view to be sent to the client. However, if an action handler class 303 is found, control is passed on to it where the request is further processed. When the action handler is done processing, it returns instructions as to how the controller should behave. These instructions are in the form of a routing request. The routing request tells the controller servlet to either forward to another action or to a view; or it indicates whether to force the client to send a subsequent HTTP POST or HTTP GET request.

The class that implements this controller servlet is
com.probaris.sp.servlet.ActionServlet.

This class is derived from javax.servlet.http.HttpServlet and overrides the following methods:
public void init(ServletConfig in_config)
public void destroy( )
public String getServletInfo( )
protected void doGet(HttpServletRequest in_request,
   HttpServletResponse in_response)
protected void doPost(HttpServletRequest in_request,
   HttpServletResponse in_response)

When a POST or a GET request is received, the appropriate method (doPost or doGet) is called. These methods call the ActionServlet's processRequest method where the requested URL is parsed and the appropriate action class is invoked.

When the action class completes, an ActionRouter (com.probaris.sp.action.ActionRouter) is returned and the controller servlet then proceeded to route control to the specified view. ActionRouter is an abstract class that is used to create specific routing mechanisms. This class provides implementations for performing server transfer or forward actions, as well as forcing the client to send a post or get requests. ActionRouter implementations are as follows:
com.probaris.sp.action.GetExplicitActionRouter
Forces the client to send a HTTP GET request for the specified URL
   com.probaris.sp.action.GetKeyActionRouter
Forces the client to send a HTTP GET request for the URL identified via a lookup from a specific resource bundle using some key
   com.probaris.sp.action.PostExplicitActionRouter
Forces the client to set a HTTP POST request for the specified URL and parameter set
   com.probaris.sp.action.PostKeyActionRouter
Forces the client to send a HTTP POST request for the URL identified via a lookup from a specific resource bundle using some key
   com.probaris.sp.action.ForwardExplicitActionRouter
Forces the server to forward control to some specified servlet or JSP
   com.probaris.sp.action.ForwardKeyActionRouter
Forces the server to forward control to some servlet or JSP identified via a lookup from a specific resource bundle using some key
   com.probaris.sp.action.HttpErrorCodeActionRouter
Sends an HTTP error response back to the client
   com.probaris.sp.action.NoOpActionRouter
Causes nothing further to be done. This is generally used when the servlet controls the view on its own rather then allows the controller servlet do it (e.g., sending a file). Each class derived from ActionRouter implements the following method:
   void route(GenericServlet in_servlet, HttpServletRequest in_request, HttpServletResponse in_response) throws IOException, ServletException

In some cases, one more layer of abstraction is used to aid in determining the URL to use for the route. These classes are:
com.probaris.sp.action.KeyActionRouter
   Uses a specified key to lookup a URL from a resource bundle for use in routing actions
com.probaris.sp.action.ExplicitActionRouter
   Uses the specified URL for routing actions

The model in this implementation of the MVC architecture is represented by a set of action classes 303. Each action handler is declared in the actions resource bundle and must implement the Action (com.probaris.sp.action.Action) interface. In certain cases, there are one or more layers of abstraction that action classes should inherit from. For example, one set of functionality aides in preventing unauthenticated users from accessing the action.

In general, however, action classes further parse requests to determine what the user is attempting to do. The is accomplished by retrieving action-specific request parameters and interpreting them appropriately. Once it is determined what the user is attempting to do, the action handler uses logic classes to perform the necessary steps to satisfy the user. If the user is not permitted to perform one or more of the steps or the input data is not valid, the logic classes return errors that are parsed by the action handler. However, if the logic classes succeed in performing the requested tasks, the appropriate data will be returned. In either case, the action handler properly formats the information, populates the context (request, session, application), and then generates the routing information necessary for the controller to continue the process.

Most of the time, the resulting routing information dictates the controller to forward processing to a JSP in order to create the desired view. A mapping of view names to JSP files are maintained in a factory class and are looked-up at the instance the forwarding request is acted upon.

Other routing results may cause the controller to generate HTTP responses that force the client to immediately create HTTP POST or HTTP GET requests, which in turn may cause further action requests. On certain occasions, the action may require the user to be forwarded to other actions with out intervention from the client.

All action classes must implement the com.probaris.sp.action.Action interface, which declares
public ActionRouter perform(HttpServlet in_servlet, HttpServletRequest in_request, HttpServletResponse in_response) throws IOException, ServletException
   The controller, in response to handling user requests, invokes this method. When completed, it is expected that the returned ActionRouter is not null and is valid so that the controller may route the request appropriately.

In most cases, one or more layers of abstraction sit between this interface and the actual action implementation. Generally, the top-most layer is the AbstractAction abstract class (com.probaris.sp.action.AbstractAction). This class implements functionality that may be used by actions to help with navigation and the creation of ActionRouter objects. Other abstractions include:
com.probaris.sp.action.AbstractAuthenticatedAction
Derived from the AbstractAction class
Adds functionality to protect access to an action such that only authenticated users may invoke them. If it is determined that the user is not authenticated, control is forwarded to the authentication mechanism.
   com.probaris.sp.action.forminstanceactions.AbstractFormInstanceAction
Derived from the AbstractAuthenticatedAction
Adds functionally with obtaining and saving form instance information when valid authorization permits.

The implementation of each action class depends on the action being handled. However, it is intended that the action classes perform little logic beyond gathering information from the /request and formatting it to pass to the logic layer; and then taking the return data from the logic layer and formatting to pass to the user interface layer.

The view in this implementation of the MVC architecture is represented by a set of JSP files. Each JSP file is written specifically to handle generating a specific view as dictated by the action handler that was invoked due to the request made by the user. Generally, the resulting output of the JSP is an HTML document that is sent to the client; however, this may not always be the case. No matter what type of document is generated, sending a view to the client signifies the end of the request.

To aid in generating the user interface, a set of beans and custom form tag handlers are available. Action classes and form tag handlers have the ability to place beans into the context for use in the user interface. As a convention, only page and request scope beans should be used in this layer. Though beans may exist in the session and application scopes, they should be avoided, except for certain circumstances. For example, the acting and authenticated user session beans are typically correct and will rarely change throughout a user's session.

With reference to FIG. 3b, an exemplary transaction model associated with the system described in FIGS. 1 and 2 is illustrated.

With reference to database access layer 321, the inventive system can be configured to support one of several databases. In one preferred embodiment, the inventive system contains data access layer implementations for Oracle 9i and MySQL 4.x. The architecture allows for the easy addition of new database access layer implementations.

The business logic layer 322 provides access control and basic logic flow. It supports a plug-in architecture that can be used to enhance the features of the inventive system as well as provide integration points. The following is a brief overview of the plug-in types.

The authentication plug-in 323 architecture allows the system to support multiple authentication modalities. In one preferred embodiment of the present invention, two authentication plug-ins are implemented. The first authenticates users based on a simple username (email address) and password combination. The section authenticates users using an X.509 certificate stored in, e.g., the Microsoft Windows Certificate Store and within Smart Cards, in one exemplary embodiment. New authentication plug-ins may be created to integrate with existing infrastructures. For example, they may validate credentials from an LDAP server. The following credential types are supported in the preferred embodiment, but systems that support additional/different credential types are within the scope of the present invention: (1) password (a username and password that is entered by the user); (2) X.509 Certificate (an X.509 certificate that is validated against a digital signature applied to a server-generated token; the signing key may be chosen from one of the certificate stored available from Microsoft's CAPICOM ActiveX Control, e.g., Local Machine Certificate Store, Current User Certificate Store, Smart Card Certificate Store); (3) external data (tokens or other data posted to the inventive system via HTTP POST or HTTP GET requests; request parameters and header values may be used to authenticate a user as desired).

Aside from authentication, authentication plug-ins aid in registering and updating credentials stored in the database. For example, a new authentication plug-in may check to see if a certificate is not expired before allowing it to be registered as credentials for some user.

The validation plug-ins 324 architecture provides validation routines to validate input for property values such as user profile properties and role privileges. Each validation plug-in can indicate a discrete list of valid values or accept user-entered string values. When invoked, a validation plug-in declares a given value as valid or not. The invoking mechanism is required to handle the result appropriately.

To implement automatic behaviors used for Robot Users, user behavior plug-ins 325 are invoked. When a form instance is routed, copied, or transferred to a robot, a message is set to the system's message queue to invoke the relevant user behavior plug-in. In general, user behaviors are used to either transfer or copy form instances to other users of the system. All information related to the relevant form instance may be used to determine how to act. Such information includes form instance revision data (field data) and form instance status information.

To help guide a form instance from origination to finalization, routing behavior plug-ins 326 are used. These plug-ins provide information used to determine how to route a form instance by declaring the collection of sections a form may be route to and the users (including robot users) who are to be the recipients. Optionally, as part of the collection of routing options, the suggested recipient of a route may be declared editable or read-only, so that a user may be forced to route a certain section of a form instance to some particular user. Routing behavior plug-ins have access to the form instance's revision data and state. Using this information, routing options may be dynamically created. In one preferred embodiment, two routing plug-ins are used. The first is a default routing behavior plugin, through which either the next section of the form or a collection of all subsequent sections of the form can be declared by the form designer. For example, if a form has 4 sections and the user is routing from the first section, either the second section is returned or the second through the fourth sections are returned. The default implementation is to return only the next section. The first is an explicit routing behavior plugin, through which a form designer declares the set of routable sections and the suggested (or required) recipient of the route.

To push form instance data outside of the system or trigger external events, such as invoking a process in some other application, a routing trigger plug-in 327 may be used. A single routing trigger plug-in may be assigned to a section of a form by a form designer such that it is triggered when routing that section. From within the trigger, one or more operations may be performed; however, no operation may alter the state of the form. For example, form instance field data may not be changed. Because trigger plug-ins may potentially consume a great deal of resources, they are invoked outside the scope of a given route (or finalization) request. To do this, a message is appended to the system's message queue declaring the trigger to invoke and the relevant form instance.

The presentation and service layer 328 is the interface between the inventive system and other systems. The web application interface is accessible to users using a supported web browser such as Internet Explorer, where the inventive system's web service API is assessable to users or servers able to send and receive SOAP messages.

The system's web application is implemented using a standard MVC architecture, described with reference to FIG. 3a, written using Java Servlets and JSPs. One preferred embodiment runs within a standard Java Servlet container such as Apache Tomcat 4.1. The web services API is implemented using a similar model to a MVC architecture and is written using Java Servlets and Sun's JAXM implementation for messaging. It runs within a standard Java Servlet container such as Tomcat 4.1 and may coexist with the system's web application in the same application context or run in its own context.

Forms

The following provides a description of the electronic forms, including how they are built; how they are represented, managed, digitally signed and printed; routing of electronic forms, including the types of routing supported, methods for distributing workload, and support for collaboration; data capture, reporting and auditing, including how data is captured in the database; and options for data export, status reporting, and details of the comprehensive audit trail.

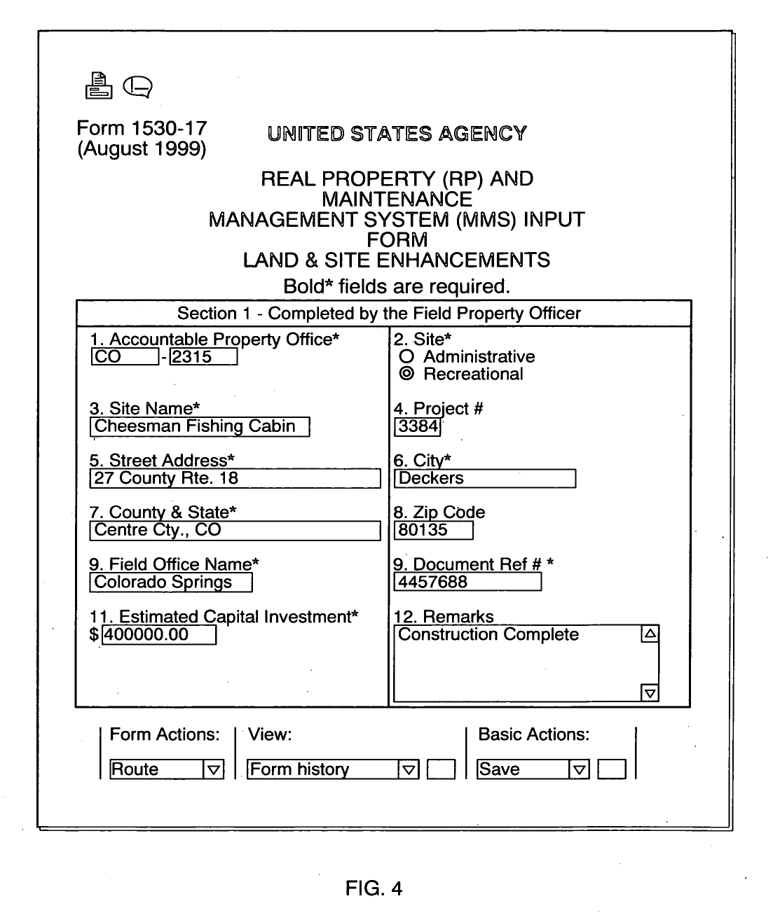

With reference to FIG. 4, a business form is the starting point for representing a business process in accordance with the present invention. The electronic forms are, in the preferred embodiment, very similar to the paper forms they replace. The preferred embodiment of the present invention supports standard HTML forms. Automated tools provided in connection with the invention substitute form tags for the equivalent HTML input fields, linking them to the database and services as part of the form integration process. Only section headings and digital signature fields (for which there are no standard HTML equivalents) need to be added manually.

Use of standard HTML confers a number of advantages. First, existing HTML forms can be readily converted to forms usable in connection with the present invention. In addition, the forms can be run in standard browsers (IE 5.5 and later). No proprietary plug-in or specially licensed client software is necessary. Further, forms developed for use in connection with the present invention can be readily re-purposed for use in any web application that supports HTML. Form developers can use any standard HTML editing tool. In one embodiment, a search and replace engine that automates insertion of specific form tags is used. A description of this utility follows.

The HTML conversion utility parses a specified HTML document to find all relevant elements that can be converted into form tags. For each found element, a conversion routine is invoked to translate the HTML element and its attributes into a form tag that can be used within the inventive application. However, in the present embodiment, this tool will not automatically place form tags delimiting the different sections of the form nor will it place form tags declaring signature regions. In both cases, the HTML document does not contain enough information to allow the tool to properly determine where such form tags should exist.

The conversion tool will only convert the HTML elements that have form tag equivalents. Such elements are:
form
input
   where the type attribute is one of the following:
      text
      password
      checkbox
      radio
textarea
select/option

When processing an HTML “form” element, the element and all of its attributes are replace by an SPForm:Form tag. The required “name” attribute of this tag must be manually edited by the form designer to make the resulting document a valid form. For example:

<form action=“submit.cgi” method=“post” name=“main form” ...
is converted to
<SPForm:Form name=“”>

When processing an HTML “input” element, the “type” attribute of that element is inspected to determine how to translate it. The translations are done as follows:

text

<input ... type=“text” ... >
is converted to
<SPForm:TextBox ... />

Password

<input ... type=“password” ... >
is converted to
<SPForm:TextBox ... ispassword=”true ... />

Checkbox

<input ... type=“checkbox” ... >
is converted to
<SPForm:CheckBox ... />

Radio

<input ... type=“radio” ... >
is converted to
<SPForm:RadioButton ... />

Once the SPForm tag type is determined, a subset of the declared attributes may be retained to specify attributes of the corresponding form tag. The following attributes will be retained:
onblur
onchange
onclick
ondblclick
onfocus
onkeydown
onkeypress
onkeyup
onmousedown
onmousemove
onmouseout
onmouseover
onmouseup
onselect
accept
alt
accesskey
align
styleclass
dir
id
lang
name
readonly
size
style
tabindex
title
value

The result of this translation process is a valid form tag; however, the form tag specific attributes that do not get added during this process may be added manually any time before the form is installed. The following lists the form tag specific attributes:
blockedvalue
blockedsections
allowedsections
validator

When processing an HTML “textarea” element (including its corresponding closing tag), the HTML element is replaced by an SPForm:TextArea form tag. A subset of the original HTML “textarea” element attributes will be retained in the resulting form tag. They are as follows:
cols
rows
accesskey
styleclass
dir
readonly
id
lang
name
onblur
onchange
onclick
ondblclick
onfocus
onkeydown
onkeypress
onkeyup
onmousedown
onmousemove
onmouseout
onmouseover
onmouseup
onselect
style
tabindex
title

The result of this translation process is a valid form tag; however, the form tag specific attributes that do not get added during this process may be added manually any time before the form is installed. The following lists the form tag specific attributes:
blockedvalue
blockedsections
allowedsections
validator

When processing the HTML “select” elements, the HTML element is replaced with the corresponding form tag, SPForm:Select. Because there is no equivalent to the multiple selection box, the “multiple” attribute will be ignored forcing the field to be in a single item select mode.

The following HTML “select” attributes will be retained during the translation into the corresponding form tag:
styleclass
readonly
dir
id
lang
name
onblur
onchange
onclick
ondblclick
onfocus
onkeydown
onkeypress
onkeyup
onmousedown
onmousemove
onmouseout
onmouseover
onmouseup
style
tabindex
title
selectedIndex

The result of this translation process is a valid form tag; however, the form tag specific attributes that do not get added during this process may be added manually any time before the form is installed. The following lists the Form tag specific attributes:
blockedvalue
blockedsections
allowedsections
validator

When processing HTML “option” elements, it is expected that the “option” element's “value” attribute is the same as the declared viewable value. For example:
<option value=“some value”>some value</option>
   The translation process for this element converts the HTML “option” element to the form tag, SPForm:Option, ignoring the text after the opening HTML element (or within the body of the HTML “option” element).

The following HTML “option” attributes will be retained during the translation into the corresponding form tag:
styleclass
dir
id
label
lang
onclick
ondblclick
onkeydown
onkeypress
onkeyup
onmousedown
onmousemove
onmouseout
onmouseover
onmouseup
style
title
value

The following provides a description of they way in which a form developer can create a form. In particular, described is the creation of the blank form and the processing of each instance of the form from its origination, through the routing of the form to the people who must enter information and/or approve it, to its final disposition.

A description of some of the terms used herein follows. An editor is an end user (an individual or robot user) responsible for filling in a form section. An instance is one electronic copy of a form, which, in the normal course of events, will be filled-in by one or more editors, approved and filed. To originate a form means to create a new instance of a form. Routing a form is the sending of an instance of a form to the next authorized editor in its lifecycle. A robot user is a function that permits a form to be routed to a pool of users with similar responsibilities. In one embodiment, a robot user manager periodically logs in to distribute form instances sent to robot users among the pool of users. A section is a subdivision of a form. Each section of a form is meant to be filled in by one editor. The editor can be a specific person or a robot user. A form is an electronic form used in connection with the present invention. The inventive system enables forms to be routed electronically and have security features, such as electronic signature capability and a complete audit trail. Form tags are HTML-like tags used in the creation of forms. A template is a blank electronic form. In the preferred embodiment, each form requires a corresponding XML guide document, which contains the routing instructions for the form.

The following identifies individuals who may work in connection with the inventive system, and a brief description of their roles. A form designer designs and tests forms and XML guide documents. The form designer works closely with and may also play role of forms administrator. The forms administrator analyzes operations to model workflow and form routing, and is responsible for deploying forms. The forms administrator works closely with and may also play role of form designer. The forms central administrator manages the forms repository, which stores form templates and is accessible in one embodiment through an intranet website. The system administrator installs and configures the inventive system and required components of the preferred embodiment, as discussed in more detail above. The end user originates, routes, signs, and finalizes forms. The end user sends templates (blank forms) to other users and may also be referred to herein as an editor.

The following describes the parts the are used to create a form in accordance with a preferred embodiment of the present invention.

Form Job Order (e.g., form blueprint, form design blueprint, form design document): As the forms administrator works with the business owner (i.e., who knows about the paper form and how it is used) to analyze a paper form, the forms administrator collects the information required to create the routable version of the form. This information is contained in the form job order, which is the blueprint for creating the electronic version of the form.

Form Document: The form itself is, in the preferred embodiment, a Web page created in much the same way as any other HTML document. The form designer creates it using familiar HTML tags such as input, checkbox and so on. After it is created as an HTML document, it is converted to a document (i.e., a form) used in connection with present invention.

XML Guide Document: Every form is associated with a corresponding XML guide document, which contains the routing logic for the form. This is created at the time the form is created.

Routing Behavior Plugin: The routing behavior plugin is a compiled Java class file. It is the system's routing “engine.” It reads a document's XML guide document to determine what routing options exist for a form.

The following describes how a form is built, in accordance with a preferred embodiment of the present invention. First, the information required to build the form is obtained from the forms administrator. The forms administrator has discussed with the business owner how the paper version of the form is used. They have decided how the form should be broken up into sections, which fields should go into which sections, which fields require signatures and to whom each section should be routed. The forms administrator records this information on the form job order, to which the form designer will refer as the form is built. Next, the page is built in DreamWeaver, in one embodiment. Some tags must be hand coded or may be unrecognized by DreamWeaver. The form may also be hand coded using a text editor preferred by the form designer. Then, the page is saved as a conventional HTML file. Although not required, this step is preferred because, after a page has been converted into a form, there is no function that can convert it back to HTML. Thereafter, the page is converted to a form, by converting HTML tags into their corresponding form tags from the tag library (see Appendix A). Again, the form can be hand coded using tags in a text editor. The form is then saved, using an extension indicating it association with the system of the present invention. Finally, the form's XML guide document is created (although, in some embodiments, the guide document can be created prior to the creation of the form in other embodiments).

A form is enclosed in opening and closing form tags. In the preferred embodiment, it contains two or more sections. The two required sections are the origination and final sections. Forms are broken into more than two sections if more than one editor (individuals and/or robot users) will be entering information into the form. A section may or may not require an electronic signature. If it does, all of the fields that will be validated by the signature will be enclosed in Signature tags. Note that the signature attests to fields, not sections.

A SignatureAction tag indicates the location on the page where the user will click to sign electronically. In the exemplary structure below, none of the fields in Section 1 require an electronic signature, while in Section 2 certain fields do. The business owner and forms administrator analyze the existing paper form to determine which fields, if any, need to be signed electronically.
Opening Form Tag
   Opening Tag for Section 1
      Routing behavior plugin Tag
      Form Element Tag (text box, radio button etc.)
      Form Element Tag
      Form Element Tag
   Closing Tag for Section 1
   Opening Tag for Section 2
      Routing behavior plugin Tag
      Form Element Tag
      Form Element Tag
   Opening Signature Tag
      Form Element Tag
      Form Element Tag
      Form Element Tag
      Signature Action Tag
   Closing Signature Tag
   Closing Tag for Section 2
Closing Form Tag
   In the preferred embodiment, a form does not have header and body sections like a conventional HTML document does. In some embodiments, fields that are to be signed can be named, rather than embedded in the SignatureAction tag body. This additional mechanism allows for a single field to be able to exist in more than one signature.

The present invention uses form tags that resemble HTML tags. In the preferred embodiment, the form tags look more like XHTML (extensible HTML). XHTML has a stricter syntax than HTML, for example, closing tags cannot be omitted; empty tags must end with a space and a “/” before the closing angle bracket; and attributes must always be quoted. However, in the preferred embodiment, the form tags of the present invention do not follow all XHTML conventions; specifically, capital letters are used in element and attribute names to make them easier to read.

Form tags begin with a specific designator (e.g., <SPForm:) for ease of identification. The following describes exemplary form tags and describes how they are used:

<SPForm:Form name=“name”>

Form goes here.

</SPForm:Form>

Encloses the entire form much as the <HTML></HTML> tags enclose an HTML document.

<SPForm:Section name=“name”>

Section goes here. This is where form elements like check boxes, text areas, radio buttons and the like are included.

</SPForm:Section>

Encloses a form section.

<SPForm:Signature name=“name”>

All form fields for which the user is signing are placed between the Signature tags. A SignatureAction tag must appear somewhere between the Signature tags.

</SPForm:Signature>

Encloses a form section.

<SPForm:SignatureAction/>

Creates the button the user clicks to sign a section. Note that this an empty tag. The location of the SignatureAction tag in a form section is important. Recalling that the user signs for fields, not sections, it is important to indicate to the user for which fields he or she is signing. If the user is signing for all fields in the section, the SignatureAction tag can be placed as the last tag in the section. It must be indicated which fields are being signed for. The following provides two examples of how this might be accomplished:

The fields for which the user is signing can be indicated in the signature box, for example:

9. Signature

Sign

Click to sign for fields 2, 6, and 8.

Alternatively, the fields being signed for can be indicated in numbered instructions at the bottom of a page, for example:
6. Enter the dollar amount.

7. Enter the name of the District Office
8. Enter today's date.

9. Click “Sign” to sign for fields 2, 6, and 8.

Form element tags correspond to HTML form element tags. Form element tags that are empty end with a space character and a slash before the closing right angle bracket.

The following creates a text box with the name name of length nn.

<SPForm:TextBox name=″name″ size=″nn″ validator=”JavaScript
Function”
allowedsections=”section(s)” | blockedsections=” section(s)”
blockedvalue=”value”
autofillproperty=“propertyname”/>

The validator attribute is optional. It is used to invoke a JavaScript function that will validate the data entered (e.g., to confirm that a currency amount or date is entered in the required format). The allowedsections and blockedsections attributes are optional and mutually exclusive. These can be used to enumerate which section editors are permitted to see the contents of a field (all others cannot) or which section editors are not permitted (all others can) to see the contents. For example, a user might have to enter some personal information such as a social security number in Section 1 of a five section form. Using either of these attributes allows for the blocking of the field contents from the editors of sections 2 through 4. The editor of the final section can always see all fields (because logically he or she is the person to whom the form is directed). If one of these attributes is used, the blockedvalue attribute can be used to specify the character string that will display in the field (e.g., a string of stars, the word “restricted” etc.).

The following creates a text area with the name name that is yy rows deep and xx columns wide.

<SPForm:TextArea name=″name″ rows=″yy″ cols=″xx″
allowedsections=”section(s)” |
blockedsections=” section(s)” blockedvalue=”value”
autofillproperty=”propertyname”/>

The following creates a radio (option) button. As with HTML, all radio buttons of the same name form a group in which only one option can be selected. The blockedvalue attribute is not used. If the a radio group is blocked, all options appear gray to unauthorized users.

SPForm:RadioButton name=″radiogroupname″ value=″value″
allowedsections=”section(s)” |
blockedsections=” section(s)”/>

The following creates a dropdown list with the name name. As many options as required can be used, one for each item in the list.

<SPForm:Select name=″name″>

<SPForm:Option value=”First Menu Item″ />
<SPForm:Option value=”Second Menu Item″ />
<SPForm:Option value=”Third Menu Item″ />

</SPForm:Select/>

Appendix B provides a more detailed description of an exemplary set of tags available within the form tag library.

In a preferred embodiment, the forms use JavasScript extensively for functions such as data validation. The following provides information regarding the most commonly used scripts and their functions.

Javascript code is composed of individual functions appropriate for this particular form. The most commonly used functions are ValidateDate( ) and Required( ). This script is used in many forms. It includes functions to validate that data is entered in the proper format for currency and date field types. In addition, it has a function to determine whether a field is required to be filled in. The following provides exemplary code:

<script language=“JavaScript” type=“text/javascript”>
<!--
function FormatCurrency(field){

num = field.value;
if(isNaN(num)){

alert(“Invalid currency field, correct example 352.34”);
field.value=“”;
return false;

}
num = num.toString( );
decLoc = num.indexOf(‘.’);
if(decLoc==−1){

dec = “00”;

} else {

dec = num.substring(decLoc + 1, num.length);
if(dec.length==1){

dec = dec + “0”;

} else if(dec.length>2){

dec = dec.substring(0, 2);

}
num = num.substring(0, decLoc);

}
field.value=num+‘.’+dec;
return true;

}
function ValidateDate(field, required){

var pattern = /\hat{ }\d{1,2}\/\d{1,2}\/\d{4}$/
if (field.value==“”){

if (required==true){

alert(“A required field was not filled in!”);
field.focus( );
return false;

} else {

return true;

}

} else if (!pattern.test(field.value)){

alert(“Invalid date!(mm/dd/yyyy)”);
field.focus( );
return false;

}

```
  return true;
  }
function Required(field){
```

if(field.value==“”){

alert(“A required field was not filled in!”);
field.focus( );
return false;

} else {

return true;

}

}
// -->
</script>

In addition to including the JavaScript at the top of the page, the proper function in each field must be invoked where the function is required. The following provides examples for each function:
Currency Format Validator
   function FormatCurrency(field)
   The field parameter is the name of the field to be validated.

Example:

$ <SPForm:TextBox name=“OriginalCost” id=“OriginalCost”
onblur=“FormatCurrency(this)” size=“15”/>

Date Validator
   function ValidateDate(field, required)
   The field parameter is the name of the field to be validated. The required parameter determines if the Required Validator should be invoked.

Example:

<SPForm:TextBox name=“Date” id=“Date” size=“10”
validator=“ValidateDate(document.formname.Date, false)” />

Required Field Validator
   function Required(field)

Example:

<b>12.Building Noun/Name*</b><br />
<input name=“BuildingName” type=“text” id=“BuildingName” size=“24”
validator=“Required(document.Form153018.BuildingName)” />

The XML guide document generated in connection with the present invention provides for automatic routing of the form. For example, after an editor fills in a section of a form, he or she routes the form to the next editor who should get the form. To route the form, the editor selects a “route” option the Form Actions drop down list of the user interface and, when the editor clicks OK, the routing page opens. The editor receiving the form can be a specific person. For example, a particular person may have to review every instance of a particular form. In this case, the person's e-mail address appears automatically in the “To” field. The editor receiving the form may also be a robot user. For example, a particular request may go to Human Resources. If any number of people in HR can handle the form, the form administrator creates a robot user for the section. In that case, the robot user's email address appears automatically in the “To” field. The editor receiving the form may be an individual of which the system does not need to keep track. In this case, the “To” field is blank and the editor enters the email address of choice in the field.

The XML guide document matches its associated form document, section for section. The following provides an example of an XML guide document followed by an explanation for each line.

| 1 | <?xml version=“1.0” encoding=“UTF-8”?> |
|---|---|
| 2 | <!DOCTYPE form SYSTEM “sp form” |
| | “http://jupiter.probaris.com/SP/sp_form.dtd”> |
| 3 | <form name=“DI-102”> |

| | |
|---|---|
| 4 | <origination-section name=“Section1” |

description=“Receiving Officer”>

| | |
|---|---|
| 5 | <routing-plugin name=“default”> |
| 6 | </routing-plugin> |

| 7 | </origination-section> |
|---|---|
| 8 | <final-section name=“Section2” description=“Waiting |
| | for Completion”> |
| 9 | </final-section> |

| | |
|---|---|
| 10 | </form> |

1 Processing Instruction—It tells a browser (or other user-agent) that this document conforms to XML version 1.0 and that it uses the UTF-8 character encoding scheme.
2 Document Type Declaration—The root element is named “form” and the URL in parentheses is the location of the DTD document.
3 The name of the form that corresponds to this document.
4 Opening tag of the origination section. The section must have a name (Section1, in this case) and a description.
5 Identifies which routing behavior plugin this form uses.
6 The closing routing behavior plugin tag.
7 The closing tag for the origination section.
8 Opening tag of the final section.
9 The closing tag for the final section.
10 The closing form tag.

As with all HTML and XML documents, the XML guide document is governed by a DTD (Document Type Definition), which describes valid elements and their allowable attributes. In the preferred embodiment, the XML guide document uses elements and attributes that are developed to be used in connection with the present invention and, thus, an understanding of the DTD is necessary. The DTD defines 17 elements, in the preferred embodiment. Appendix C provides a reference for each XML tag.

In a further embodiment, validation may be performed from an XML Schema rather than a DTD. This alternative format is as follows:

| | |
|---|---|
| 1 | <?xml version=“1.0” encoding=“UTF-8”?> |
| 2 | <form xmlns=“urn:probaris:sp:form-metadata:1.5” |

| | xmlns:xsi=http://www.w3.org/2001/XMLSchema-instance |
|---|---|
| | xsi:schemaLocation=“urn:probaris:sp:form-metadata:1.5 sp_{—} |
| | form.xsd” name=“DI-102”> |
| 3 | <origination-section name=“Section1” |

| | description=“Receiving Officer”> |
|---|---|
| 4 | <on-route> |

| | |
|---|---|
| 5 | <routing-plug-in name=“Default”> |
| 6 | </routing-plugin> |

| | |
|---|---|
| 7 | </on-route> |

| | |
|---|---|
| 8 | </origination-section> |
| 9 | <final-section name=“Section2” |

description=“Waiting for Completion”>

| | |
|---|---|
| 10 | </final-section> |

| | |
|---|---|
| 11 | </form> |

1 Processing Instruction—It tells a browser (or other user-agent) that this document conforms to XML version 1.0 and that it uses the UTF-8 character encoding scheme.
2 Document Declaration—The root element is named “form” and it conforms to the XML Schema defined for the XML Namespace of um:probaris:sp:form-metadata: 1.5 (which is located in the sp_form.xsd file). Other XML names spaces that may be referenced in this document is the standard XML Schema Instance, which is located at the following URL:
   http://www.w3.org/2001/XMLSchema-instance
The form must be named using the “name” attribute of this element.
3 Opening tag of the origination section. The section must have a name (Section1, in this case) and a description.
4 Opening tag of the on-route section. This section specifies details on how to handle the routing of the origination section of the form.
5 Identifies which routing plug-in this form uses.
6 The closing routing plug-in tag.
7 The closing tag for the on-route section.
8 The closing tag for the origination section.
9 Opening tag of the final section.
10 The closing tag for the final section.
11 The closing form tag.

The following provides a description of which routing behavior plugin to specify for a section. The form designer specifies which plugin to use immediately after the opening section tag, for example:

<section name=“Section2” description=“Waiting HQ Approval”>

<routing-plugin name=“ExplicitRoutingBehavior”>

A plugin specifies to which sections the current section of a form can be routed. In particular, the inventive system allows for the possibility that the next numbered section in a form might not be the next section that should be filled in. Thus, the user would route the form to (the person who is responsible for filling in) a different section. By way of example, assume a user is filling in Section 1 of a form. In this section, there is a field that accepts a dollar amount. If the amount is over $1,000, then the user has to obtain approval from someone who will digitally sign Section 2 to show approval. If the dollar amount is below $1,000, the user does not need that approval. In that case, the user would route the form “to” Section 3, instead of Section 2.

The following describes the two plugins of a preferred embodiment of the present invenyion—the Default plugin and the Explicit Plugin.

The Default plugin operates in two modes: NextAvailable and AllAvailable. The default mode for the Default plugin is NextAvailable. The Next Available plugin displays only the next section in the Send menu (dropdown list). Thus, if it is used in Section 1, it will display only Section 2 (or Section 1a, if you've named the section that way). The AllAvailable plugin displays all available sections. Thus, if it is used in Section 1 of a five section form, the Send menu will display sections 2, 3, 4 and 5.

The Explicit Plugin allows the form designer to specify to which section the current section can be routed. Consider this example:

<origination-section name=“Section1” description=“Waiting
for HQ”>

<routing-plugin name=“ExplicitRoutingBehavior”>

<route-options>

<route-option>

<parameter name=“SectionName”
value=“Section2” />

</route-option>
<route-option>

<parameter name=“SectionName”
value=“Section3” />
<parameter name=“Recipient”
value=“hq@agency.gov” />
<parameter name=“ReadOnly” value=“false” />

</route-option>

</route-options>

</routing-plugin>

</origination-section>

When the user opens the Send menu (dropdown box) he or she will see two entries, Section 2 and Section 3. If Section 2 is selected, the To field will remain empty. If Section 3 is chosen, the To field will be populated with hq@agency.gov. However, because the ReadOnly parameter has a value of false, the user can overwrite the suggested recipient.

Sectioning and Security

The present invention uses form sections to deliver data security. Editing rights are managed by the server at the section-level, so that a participant in the process can edit only the information in the currently active section. Data in other sections of the form are view-only and cannot be tampered with. The server also manages viewing rights at section- and field-levels. Data in a field outside of the currently editable section can be masked (hidden), if desired. This enables sensitive information such as credit card or social security numbers to remain confidential even as the form is processed by individuals not authorized to view this information. By managing editing and viewing rights at the server, the present invention provides substantially improved data security compared to systems which depend on form files circulating from client to client, making them vulnerable to hacking or data tampering.

Each form must be cut into two or more Sections; where each Section includes a set of 0 or more field elements. The first section is the Origination section in which the user who is the owner of this section is labeled as the “Originator” of the form. The last section is the Finalization section, which defines the “Form Owner” who is allowed to finalize or close out the form. All other sections have no special meaning beyond the functionality they expose by grouping sets of fields together for the purpose of determining field-level access control.

The sections of a form are used to control access to the fields within them. A section may be in one of two states (read-only or editable). If the section is read-only, the fields within that section are read-only as well. In this case, the data within the fields may not be altered. In addition to being unalterable, a read-only field may also be blocked (or masked) from view depending on who is viewing the form. A form designer may declare this set of users and optionally what value is to be placed in the field to indicate it has been blocked from the user's view. If the section is editable, all of the fields within it are editable as well and cannot be blocked.

At any given point in time, at most one Section of a form instance may be editable, and only a single user may be declared as the editor of it. When viewing a form instance, all sections of that form instance are displayed to the viewer. One of those sections may be marked as editable; however, if the viewer is not declared as the editor of that section, it will appear to the user as being in a read-only state (including the blocking rules defined by the form designer).

Within the sections of a form, zero or more fields may be declared. The following field types are available:
Text Box
Text Area
Checkbox
Radio Button
Select Box
Signature (and associated action button)
   Each field has defined set of attributes used to declare its behavior and contents, as discussed in more detail previously.

To prevent data from being seen by certain users of the system, forms designers have the ability to block or mask fields depending on the user viewing them. Adding either the allowedsections or blockedsections attribute to the field elements does this. The allowedsections attribute declares the set of section owners allowed to view the field (causing everyone else to be blocked) where the blockedsections attribute declares the set of section owners blocked from viewing the field (allowing everyone else to view it). The list of section owners is declared by listing the name of the section for which the section owner owns. For example, a form may have three sections (“Section1”, “Section2”, and Section3), the owners of “Section2” and “Section3” may be blocked from viewing a field in “Section 1” using one of the following:
allowedsections=“Section 1”
   Only the section owner of Section1 will be able to view the data.
blockedsections=“Section2, Section3”
   The section owner of Section1 will be able to view the data as well as all other users as long as they do not own “Section2” or “Section3”.

If a section is to appear blocked to some viewer, some valid other than the “real” value will be displayed. For fields that display text (not radio buttons or checkboxes) “######” is displayed by default; however the form designer may declare their own value by setting the blockedvalue attribute. For checkboxes and radio buttons, an appropriate shaded (or grayed out) image is displayed.

No matter which field type is being blocked, the actual raw field data is never sent to the client machine. This hides the data from the user even if they are sophisticated enough to view the HTML source of the page with the blocked field on it. However, due to the way digital signatures are generated, the values of the blocked fields are used within a hashing algorithm (MD5) when computing the hash value of the section they exist within. This hash value is then used to compute future digital signatures of data on the form. In the event the values of the blocked fields are constrained to a small set of data, it may be possible for a sophisticated user to brute-force compute the blocked values. For example, if two fields are blocked within a section where on field declares gender (male or female) and the other declares an age (generally an integer between 0 and 100), it is possible to determine the blocked values by computing the MD5 hash of the possible values, which may yield at most 200 trial runs. This is discussed in more detail below.

Digital Signatures

The present invention supports use of digital signatures. Users can digitally sign a form by clicking on a signature field and following on-screen prompts. A preferred embodiment of the system of the present invention can take advantage of whatever digital certificates are available to the user, including stored software-certificates or smart cards. Thus, in order to digitally sign a form, the user must have a personal digital certificate, either stored on his or her workstation or available via smart card, along with any hardware or middleware required to generate digital signatures and encrypt data. In other embodiments, however, a “click and sign” feature may be implemented so that users without digital certificates can sign forms.

As discussed above, form designers can implement a digital signature simply by embedding a digital signature tag from the tag library. The tag allows the designer to control which fields of the form need to be included in the signature, and the specific meaning of the signature. Once signed, the database captures and stores the signature along with other section-specific form data. Subsequent process participants can check validity, but cannot tamper with the signature, or invalidate it by editing fields that should not be edited.

Because the present invention allows for masking of certain fields for an editor of a given section, a unique problem is presented relating to signatures. While it is preferable that the signature be applied to designated fields within the current section as well as all fields in any previous sections, in order to sign a piece of data, that data must be visible to the browser. The present invention solves this problem by having the signature include not the data, but a hash of the data that is computed on the server. Embedding the hash does not compromise the confidentiality because the nature of hashes makes it very difficult to recreate the data from the hash. Thus, when a form is viewed using the inventive system, hashes for each inactive section are embedded in the HTML. Also embedded in the HTML is a hash of the form template itself. This binds the signature not only to the data itself, but the manner in which the data was presented. Because of this binding, the Form template can also be used to determine exactly what a user saw when he signed a document.

In the preferred embodiment, the signature is encoded as Base64 text before being submitted to the server and is stored this way. If anything about the way data is signed has to change, a version number can be prepended to signatures before they are stored in the database. This version number can be stripped out before the signature is passed back to a user. The inventive system will know to look for the version number, and if one does not exist, it will treat it like the first version. Thus, the signatures are forward compatible.

The structure of the data that is signed is described as follows with reference to an example. In the example, it is assume that the signature will be in the second section of a three-section form. This structure is generated only when signing and verifying signatures, and is not stored anywhere. The data structure conforms to the following DTD:

<!ELEMENT data (formHash, section*, dataset, section*, extensions)>
<!ELEMENT formHash (#PCDATA)>
<!ELEMENT section (name, hash)>
<!ELEMENT dataset (field+)>
<!ELEMENT name (#PCDATA)>
<!ELEMENT hash (#PCDATA)>
<!ELEMENT field (name, value)>
<!ELEMENT value (#PCDATA)>
<!ELEMENT extensions (extension+)>
<!ELEMENT extension (name, value)>

The following provides an example of what the data would look like (with white space included in the example for readability):

<data>

<formHash>[HEX]</formHash>
<section>

<name>Section 1</name>
<hash>[HEX]</hash>

</section>
<dataset>

<field>

<name>Field 1</name>
<value>Value 1</value>

</field>
<field>

<name>Field 2</name>
<value>Value 2</value>

</field>
<field>

<name>Field 3</name>
<value>Value 3</value>

</field>

</dataset>
<section>

<name>Section 3</name>
<hash>[HEX]</hash>

</section>

</data>

The following provides a further explanation of elements in the above example: <data>—The data element indicates the beginning of the XML that will be signed. The end of the XML is indicated by the closing data tag (</data>).
<formHash>—A version number and the hexadecimal representation of the SHA-1 hash of the contents of the form template, separated by a colon. This is generated on the server.
<section>—A section element represents the data in a particular section of a form. All section elements will represent sections either prior to or after the active section.
<name>—A name element represents the name of either a section or a field, depending on whether it is located inside a section or field element.
<hash>—The hexadecimal representation of the SHA-1 hash of a dataset element containing every field in that section. This is generated on the server.
<dataset>—The dataset element contains the data that the signer has entered themselves.
<field>—A field element represents one field on the form.
<value>—A value element represents the value of a field on the form.

If any other data, not in the form, needs to be signed as well (e.g. a reason for signing), an extensions element can be added to the end of the body of the data element:

<extensions>

<extension>

<name>Reason</name>
<value>Because I approve</value>

</extension>

</extensions>

There are various ways extensions could be inserted. To give just one example, the user could be taken to another page when attempting to sign. This page could show the additional information that will be added as an extension to the signature data. The extension data will need to be stored in the database to allow for signature verification.

Each form field tag will be translated into a <field> element as follows:

SPForm:TextBox:

<field>

<name>[TextBoxName]</name>
<value>[TextBoxValue]</value>

</field>

SPForm:TextArea:

<field>

<name>[TextAreaName]</name>
<value>[TextAreaValue]</value>

</field>

SPForm:Select (the SelectValue is the value of the selected option from the dropdown list):

<field>

<name>[SelectName]</name>
<value>[SelectValue]</value>

</field>

SPForm:RadioButton:

<field>

<name>[RadioButtonName]_[RadioButtonValue]</name>
<value>[RadioButtonValue]</value>

</field>

SPForm:CheckBox:

<field>

<name>[CheckBoxName]_[CheckBoxValue]</name>
<value>[CheckBoxValue]</value>

</field>

SPForm:Signature:

<field>

<name>[SignatureName]</name>
<value>[SignatureValue]</value>

</field>

Each form field tag knows the proper way to compute the XML for the field that it represents and generates the appropriate JavaScript to do so. Once the entire XML document has been constructed, it is signed. Another problem with masked fields is apparent here. In order to verify a signature, the client needs to have access to the data that was signed, but some of the data may be masked. Again, this problem is solved using hashes. A SHA-1 hash of the XML document is computed and represented as a hexadecimal string. This string is what is actually signed. The signature is packaged in a PKCS #7 signed data structure along with the signing certificate, which is then Base64 encoded and eventually sent back to the server. In order to verify signatures, the server needs to send the hexadecimal hash string to the client. This means that the server must rebuild the XML from the saved form data and compute its hash. With the hash string and the PKS #7 signed data, the client will be able to verify the signature and display the certificate, if so desired.

In the preferred embodiment, the necessary cryptographic work on the client can be performed using Microsoft's CAPICOM, which is a COM wrapper around the Microsoft Cryptography API. Documentation for the API can be found on msdn.microsoft.com, which documentation is incorporated herein by reference. Internet Explorer interacts with CAPICOM through JavaScript and ActiveX. CAPICOM is used for computing the hash of the XML document, interacting with the certificate store, and for signing and verifying signed data.

Forms Respository

Many organizations have hundreds of electronic business forms, sometimes in legacy formats that need to be supported for the foreseeable future. The present invention provides an integrated, searchable form repository that provides a single, easy-to-maintain website for users to find all of the online business forms they need, in any file format. Clicking on a form automatically launches the application in the user's browser.

An administrator of the forms repository can provide multiple ways for users to find the forms they need, including:
Hierarchical Folders. Administrators can create and name folders which, in turn, can contain additional folders or forms. Links to the appropriate form can appear in multiple folders, enabling multiple pathways to the same form.
Form Number Search. Users often know commonly used forms by form numbers (e.g. IRS 1040), and can jump directly to a particular form by entering it.
Key Word or Title Search.

Printing

A preferred embodiment of the present invention works around the conventional problems with printing HTML from browsers by first rendering a static-PDF image of a printed form. The PDF file can then be printed by users, providing better control over margins and page breaks, or saved in a file.

Routing/Workflow

As referred to herein, routing includes sending a form from one user to the next. In accordance with the present invention, form data is “logically” rather than “physically” routed. Form data always resides within the database server behind a firewall, and is presented in a user's “Action Items” list which is only accessible via encrypted links. Workflow refers to the accumulation of multiple routing steps to the completion of a form. The following types of routing are supported by a preferred embodiment of the present invention:
“Free-form” routing, where the user decides the routing steps. As described in more detail below, the present invention supports system- and form-roles that further enhance security, while real-time status reporting and audit trails ensure that the process integrity is maintained.
“Explicit” routing, where the user chooses from one or more routing options for each form section. In one embodiment, the form designer can decide how many options to offer, how to prompt the user in making a selection, and whether to permit the user to override the selection. Again, system- and form-roles further enhance security and limit the ability of non-trusted users to make mistakes.
“Logic based” routing via a Java plug-in. The present invention computes a routing option based on various combinations of form data, user data, and logic. This includes conditional branching based on business rules (e.g., “send to VP if salary exceeds $35,000; otherwise send to HR”); and exception processes (e.g. managing around users on vacation).
Shared workload routing. The present invention automatically distributes high volume forms within a workgroup on a round robin basis.

Roles

In certain embodiments of the present invention, process security is increased by limiting certain actions to users in specified roles. For example, a typical action subject to such controls would be the right to override suggested routing. Users in trusted roles are allowed to change automated routing in certain forms; less trusted users are not.

The preferred embodiment of the present invention recognizes and takes advantage of two kinds of roles. Form-context roles are assigned by the system in the course of filling out a form. For example, a process may require that two or more form sections always be filled out by the same user (e.g., the same person who applies for travel reimbursement in one section of a form has to acknowledge receipt of funds in the final section of the form). The editor of any form section takes on a “form context role”. The form designer can specify that, once one section of the form is filled in, later sections of the form must be filled in by the same person.

“Registration roles” are assigned to users at registration time. System administrators can define as many registration roles as they wish. For example, system administrators can define a role in the system called “Approver”. The form designer can designate certain sections as requiring “Approver” status, and the system will then reject attempts to route those sections to someone without the specified role. Each role is made of several system-named properties for which the administrator may change the value. By way of example, assume a property of a role called “Allowed_to_change_routing”. The system administrator may change the value of this property to either “yes” or “no”.

Roles allow flexibility to trusted end users, but ensure that user decisions meet basic organizational requirements. In fact, registration roles are employed within a preferred embodiment of the present invention to affect not only routing, but also a variety of system “personality” attributes, such as whether a user is allowed to copy a form to another user, withdraw a form, etc. These allow enormous flexibility in empowering trusted end users to handle exceptions, while ensuring process integrity.

Every registered user of the system has a standard set of properties that represent the user's identity needed by the system. In addition to this identity is a set of custom properties that are specified by a system administrator. Combined, these properties make up the user's profile.

The standard set of user properties include:
First name
Last name
Email address
Status (active, inactive, etc. . . . )
Role
Administrative level (0: None-255: Master)
Time zone
Recently originated forms
Maximum number of recently originated forms to maintain
Email notifications (on/off)
Recently used email addresses
Maximum number of recently used email addresses
Organization affiliation
Authority level
Security level

These properties are spread into different tables in the database.
SystemUser
   First name
   Last name
   Email address
   Status
   Role
   Administrative level
   Time zone
UserProperty/Property
   Recently originated forms
   Maximum number of recently originated forms to maintain
   Email notifications (on/off)
   Maximum number of recently used email addresses
   Organization affiliation
   Authority level
   Security level

In addition to the standard set of properties in the user profile, custom properties may be added. A system administrator may add properties to the user profile by using the administration user interface. Each custom property is defined using the following information:
Name
   The unique name for the property
Description
   An optional text description of the property to be displayed in a user interface
Default Value
   An optional default value for the property
Type (or validator plug-in)
   Refers to a ValidatorPlugin used to validate the field
   May be null if validation is not necessary
User Editable
   A Boolean value indicating whether the property may be changed by a non-administrative user
   May be used for display purposes in a user interface
Hidden
   A Boolean value indicating whether the property may be shown to a non-administrative user
   May be used for display purposes in a user interface
Minimum Number of Values
   An integer indicating the minimum number of values allowed to be associated with the property
   A number greater than 1 indicates the property may not be empty
Maximum Number of Values
   An integer indicating the maximum number of values allowed to be associated with the property
   For example: Favorite Color: Red; Green; Blue

The implementation of custom properties at the database level is done using two tables:

Property

| | | |
|---|---|---|
| PropertyID | NUMBER | The is the unique identifier of the |
| | (INT) | property. |
| PropertyName | VARCHAR2 | This is the unique of the property. |
| | (VARCHAR) | |
| PropertyType | VARCHAR2 | The scope for this property. This |
| | (VARCHAR) | should be either “user” [user property] |
| | | or “role” [role privledge] |
| Description | VARCHAR2 | Descriptive information about this |
| | (VARCHAR) | propery. For use in user interfaces. |
| DefaultValue | VARCHAR2 | This is the default value for the |
| | (VARCHAR) | property. Initally a user will |
| | | inherit properties with default |
| | | values. |
| ViewLevel | NUMBER | The minimum administrative value a |
| | (INT) | user needs to view the existence of |
| | | the property. |
| EditLevel | NUMBER | The minimum administrative value a |
| | (INT) | user needs to edit the value of the |
| | | property. |
| ManageLevel | NUMBER | The minimum administrative value a |
| | | user needs to manage (edit/remove) |
| | | the property. |
| Allow Any | BOOL | Indiccates a wildcard value |
| | (INT) | declaring any value is allowed. |
| AllowNone | BOOL | Indicates a wildcard value |
| | (INT) | declaring no value is allowed. |
| MinValues | NUMBER | This is either a number indicating |
| | (INT) | the minimum number of values the |
| | | property requried, or NULL meaning |
| | | there is no minimum. In this case |
| | | 0 and NULL are equivalent |
| MaxValues | NUMBER | This is either a number indicating |
| | (INT) | the maximum number of values the |
| | | property allows, or NULL indicating |
| | | no maximum is specified. |
| ValidatorData | NUMBER | This is a unique identifier of a |
| SetID | (INT) | validator that may be used for this |
| | | property. |

This exemplary Property table contains information about the available properties for a user or a role. Each property has a name and scope that create a unique identity for the property when combined. Properties may be declared as editable or hidden. Properties may also declare minimum and maximum limits on values associated with them.

UserProperty

| | | |
|---|---|---|
| SystemUserID | NUMBER | This is a unique identifier of the |
| | (INT) | user who is associated with the |
| | | record. |
| PropertyID | NUMBER | This is a unique identifier of the |
| | (INT) | property that is associated with |
| | | the record. |
| PropertyValue | VARCHAR2 | The string value of the property |
| | (VARCHAR) | with respect to the user |
| ActionDataSetID | NUMBER | The unique identifier declaring |
| | (INT) | the action (behavior) plug-in |
| | | related to this property. |

The UserProperty table declares user-specific values for properties in the Property table.

To get the properties for a user, a UserProfile (com.probaris.sp.bean.UserProfile) should be obtained by calling the getProfile(Long in_userId) method of User (com.probaris.sp.bean.User). If available, a cached UserProfile will be returned; else a new one will be created.

Once the UserProfile object is obtained, its getProperty(String in_name) method may be called. If available, a UserProperty (com.probaris.sp.bean.UserProperty) object will be returned. Calling UserProperly's getValue( ) method may then be used to retrieve the value of this property. Since all property values are of the type String, it may be necessary to convert the value to a more convenient type (for example Long, or int).

To set the properties of a user, a Map of the property names and values must be created. This Map and the relevant UserProfile objects are to be passed into the updateUserProfile(UserProfile in_profile, Map in_updateValues) method of the UserProfiles (com.probaris.sp.logic.UserProfiles) object. Any item in the Map that has a property name that does not exist in the supplied UserProfile will be skipped. This goes for any item that has not been changed as well. All other items will be stored in the database appropriately given it passes any necessary validation implemented by the specified ValidatorPlugin, if any. When complete, the UserProfile will be updated accordingly.

To add custom user properties, a system administration is required to use the administrative user interface. The user interface provides a form that must be filled out. The following fields exist on the form:
Property Name
   Text field
   Must not be blank
   Value must be unique across all user properties
Description
   Text field
   May be blank
Default Value
   Text field
Validation
   Drop down list consisting of “None” plus a list of available ValidatorPlugin Instance names (Default is “None”)
User Editable
   Selection or radio buttons [yes/no]
Hidden
   Selection or radio buttons [yes/no]
Minimum Number of Values
   Text field that accepts some integer or empty (meaning no minimum)
   If not empty and greater than 0, the value in “Default Value” must validate according to the selected vazlidator plug-in
Maximum Number of Values
   Text field that accepts some integer or empty (meaning no maximum)

Once completed and submitted, the data in the form is validated. If any errors are found, the form and contents are displayed back to the user along with the error message or messages. However, if no errors are found, a record is created within the Property table in the database. Also, a record for each existing user (stored in the SystemUser table) is created in the UserProperty table such that for user, U, and newly added property, P:
SystemUserID: unique identifier of U
PropertyID: unique identifier of P
PropertyValue: default value of P
ActionDataSetID: empty

Certain details about a custom property may be updated. The following lists modifiable fields:
Name
Description
User Editable
Hidden

By changing the data within these fields, only cosmetic changes will incur. However, other fields yield deeper issues if modified:
Validation
   Changing the Validator plug-in associated with a property may yield invalid values that already exist for the given property. For example, before modification, a property has a validator that allows either “yes” or “no” values. Therefore, all values in the UserProperty table associated with the property in question have either “yes” or “no” values. If the validator for the property is changed such that “on” and “off” are the only valid values, then all of the existing values for the property are invalid. Testing for this becomes a performance issue being all existing values will need to be tested against the new validator. Another issue relates to dealing with the invalid values. Each user will need to be prompted to fix the issue; however, unexpected results will occur if the value is not altered before a consumer of the property is invoked.
Min Values
   Changing the minimum number of values associated with a property may yield invalid property values. For example, before the property is changed, the minimum number of values may be set to 1; after the change, the minimum number of values may be set to 2. With this, there may be property values set such that only one value is specified. This would invalidate those property values. Determining this would create a performance issue. Also, the invalid parameters would need to be flagged and displayed to the relevant user in some way.
Max Values
   Changing the maximum number of values associated with a property may yield invalid property values. For example, before the property is changed, the maximum number of values may be set to 2; after the change, the maximum number of values may be set to 1. With this, there may be property values set such that more than one value is specified. This would invalidate those property values. Determining this would create a performance issue. Also the invalid parameters would need to be flagged and displayed to the relevant user in some way.

Custom user properties may be removed; however, the system administrator must be warned that doing so may yield unexpected results. Upon removing a user property, the relative record in the Property table is removed as well as all related records in the UserProperty table. Once removed, the operation may not be undone; however, an identically named property may be added.

To allow users to edit their profile, the set of properties must be displayed such that an input box for each property is properly rendered. To determine how to render an input box, it is necessary to query information from the property's details as well as details from any relevant validator. The details of the property will indicate whether the property may be viewed. If viewable, then it will indicate whether the property may be edited. Information from the validator may yield data that declares the set of valid values that must be used.

The following lists the different rendering scenarios:
Viewable
   Editable
      Max values=1
         Enumerated
         Drop-down box of available values
         Non-enumerated
         Free-form text input box
      Max values>1
         Enumerated
         Drop-down box of available values
         List box of selected values
         Buttons to add and remove values
         JavaScript enforcing minimum and maximum value counts
         Non-enumerated
         Free-form text input box
         List box of selected values
         Buttons to add and remove values
         JavaScript enforcing minimum and maximum value counts
   Non-editable
      Text representation of the property value
Non-viewable
   No representation of the property is displayed

The following describes the relevant Java Classes:
com.probaris.sp.bean.Property
   Encapsulates the data necessary to define the properties that make up the set of privileges for roles. The data includes
   Name
   Default value
   Description
   Minimum number of values
   Maximum number of values
   Is property hidden?
   Is property editable?
   Relevant ValidatorPlugin
com.probaris.sp.bean.User
   Encapsulates information about users of the system. This class holds most of the standard properties that make up the user's profile.
   First name
   Last name
   Email Address
   Status
   Role
   Administrative level
      It also allows for access to the dynamic set of user profile properties via the getprofile( ) method. The getprofile( ) method returns the relevant UserProfile (com.probaris.sp.bean.UserProfile). To do this, it first checks for a cached profile object and then queries the database if necessary.
com.probaris.sp.bean.UserProfile
   Encapsulates the set of non-standard properties that make up the user's profile. The properties are maintained as name/value pairs where the types of both the name and value are Strings.
com.probaris.sp.logic.UserProfiles
   Provides the logic for setting and getting user profile information.

Every registered user of the system must have a role (or system role) declared. This role dictates the amount (or lack of) privileges a user has for performing operations within the system as well as their ability to interact with forms. A system role is essentially a named grouping of properties that make up the set of privileges to be assigned to user. The name of a role may be used within the meta-data of the forms to indicate whether users of particular roles have or do not have authorization to fill out certain sections of or even originate them.

The administrators configure the system with roles that are specific to their needs. To mange roles, a user must have an administrative level equal to or greater then a System Administrator. User Administrators may not manage roles though they do have the right to assign them to registered user accounts.

A System Role is defined with a name and a set of privileges. The role name is any string (200 characters or less) that is unique among all other role names.

Once named, the associated privileges must be configured. The following is a list of those privileges:
Allowed authentication modality
   None|Any|A sub-set of the existing authentication modalities
      “None” indicates no authentication allowed (i.e., the user may not log in to the system)
Allowed to override routing recommendations
   Yes|No
Allowed to route to
   None|Any|A sub-set of the existing system roles
      “None” indicates not allowed by user
Allowed to set deadlines/reminders
   Yes|No
Allowed to copy forms to
   None|Any|A sub-set of the existing system roles
      “None” indicates not allowed by user
Allowed to suspend forms
   Yes|No
Allowed to suspend forms for paper processing
   Yes|No
Allowed to finalize forms
   Yes|No
Allowed levels to transfer back
   0|1|Any
      0 indicates transfer back is not allowed
Allowed transfer forms to
   None|Any|A sub-set of the existing system roles
      “None” indicates not allowed by user
Allowed to withdraw forms
   Yes|No
Allowed to withdraw forms more than one level if Originator
   Yes|No
Allowed to send editing requests to
   None|Any|A sub-set of the existing system roles
      “None” indicates not allowed by user
Allowed to send review requests to
   None|Any|A sub-set of the existing system roles
      “None” indicates not allowed by user
Allowed to send blank forms to
   None|Any|A sub-set of the existing system roles
      “None” indicates not allowed by user
Allowed to view sender's identity
   Yes|No
Allowed to view receiver's (or current editor's) identity
   Yes|No
Allowed to view form comments
   Yes|No
Allowed to view form attachments
   Yes|No
Allowed to add form attachments
   Yes|No
Allowed to view form routing history (a.k.a. form history)
   Yes|No
Allowed to view form transaction log
   Yes|No
Allowed to view historical form data
   Yes|No
Allowed to change user id (email address)
   Yes|No
Allowed to change common name (first/last name)
   Yes|No
Allowed to change time zone
   Yes|No
Allowed to change status to “on leave”
   Yes|No
Allowed to change declare to be non-routable
   Yes|No
Allowed to change authentication modality
   Yes|No
Allowed to invite unregistered users to the system
   Yes|No

Like the properties of the user profile, role privileges are stored in the Property table within the database. The configuration values, relative to the particular roles, are then stored in the RoleProperty table.

Exemplary tables relevant to system roles are as follows:

Role

| | | |
|---|---|---|
| RoleID | NUMBER | The is the unique identifier of the role. |
| | (INT) | |
| RoleName | VARCHAR2 | This is the unique name of the property. |
| | (VARCHAR) | |

The Role table contains the set of roles configured within the system. Each entry in this table should have related entries in the RoleProperty table. Together, the two tables are used to generate roles and their sets of privileges.

The Property table contains information about the available properties for a user or a role. Each property has a name and scope that create a unique identity for the property when combined. Properties may be declared as editable or hidden. Properties may also declare minimum and maximum limits on values associated with them.

RoleProperty

| | | |
|---|---|---|
| RoleID | NUMBER | This is a unique identifier of the |
| | (INT) | role that is associated with the |
| | | record. |
| PropertyID | NUMBER | This is a unique identifier of the |
| | (INT) | property that is associated with the |
| | | record. |
| PropertyValue | VARCHAR2 | The string value of the property with |
| | (VARCHAR) | respect to the user |

The RoleProperty table declares role-specific values for relevant properties in the Property table.

To get the set of information that makes up the set of user privileges, a UserRole object must be retrieved from either the User (com.probaris.sp.bean.User) or UserRoles (com.probaris.sp.logic.UserRoles) objects. Ideally the getRole( ) method from the User object is used. This is because the role is cached within the user object and therefore a call to the UserRoles object and possibly the database will be avoided.

If a call to one of the getUserRole methods is made on the UserRoles singleton, the appropriate role will be chosen from an internal cache. In the event the specified role does not exist in the cache, one will be built from information stored in the database. The implementation of the UserRoles object is such that a cache of roles is maintained. If a role is requested, its age is checked and if older than some max age (e.g., by default 5 minutes), it is dropped and a new one is created. This allows for privilege changes to be acknowledged, in the even an administrator alters a system role while the system is running.

In the event a new UserRole object needs to be built, a call to the database is made such that an inner join is created using the Role and RoleProperty tables. The dataset that returned from this join includes the role's name as well as the properties that make up its set of privileges.

Users with an administrative level equal to or greater than System Administrator may add System Roles to an installation via the administrative user interface or command line utility. To add a new role to the system, a unique role name must be chosen. If the role name is determined to be valid, the new role will be created in the database. This process includes inserting a record in the Role table that includes the unique role name and a unique identifier (labeled RoleID). Then, using the RoleID of the new role, one record for each “role” related record in the Property table is added to the RoleProperty table using the property's DefaultValue as the role privilege's PropertyValue. When complete, a role with a default set of privileges is created.

To customize the new role, the data that configures the set privileges may be changed. To do this, either the command line utility or user interface may be used. If using the command line utility, the administrator must know the set of valid choices for any given privilege; however, if using the user interface, the administer will be presented with relevant choices (see System Roles User Interface Specifics). In either case, upon submitting data, each value will be validated against an appropriate validation routine implemented by the ValidatorPlugin (see ValidatorPlugins) specified by the Property that represents the privilege. If all values validate, the role will be updated.

Users with an administrative level equal to or greater than System Administrator may delete System Roles from the installation. However, only roles that are not associated with users may be removed. Using the user interface or command line utility, the system role to remove may be specified. If any users are assigned to that role, an error will occur and the role will not be deleted. If a role is to be deleted, the relevant record in the Role table is removed as well as all RoleProperty records that make up the roles set of privileges.

Caution must be used when deleting roles. Though only unassigned roles may be deleted, forms may use role names for access control purposes. It may be possible to render a form unusable in the event a form declares the deleted role as the only role able to originate the form.

To allow administrative users to edit role privileges, the set of properties must be displayed such that an input facility for each property is properly rendered. To determine how to render an input box it is necessary to query information from the property's details as well as details from any relevant validator. Information from the validator may yield data that declares the set of valid values that must be used.

The following lists the different rendering scenarios:
Max values=1
   Enumerated
      Drop-down box of available values
   Non-enumerated
      Free-form text input box
Max values>1
   Enumerated
      Drop-down box of available values
      List box of selected values
      Buttons to add and remove values
      JavaScript-enforcing minimum and maximum value counts
   Non-enumerated
      Free-form text input box
      List box of selected values
      Buttons to add and remove values
      JavaScript enforcing minimum and maximum value counts

The following describes the relevant Java classes:
com.probaris.sp.bean.Property
   Encapsulates the data necessary to define the properties that make up the set of privileges for roles. The data includes
Name
Default value
Description
Minimum number of values
Maximum number of values
Relevant ValidatorPlugin
com.probaris.sp.bean.User
   Encapsulates information about users of the system. An instance of this class may hold a cached UserRole; therefore a call to User.getRole( ) is preferable than a call to one of the UserRoles.getRole( . . . ) methods. User.getRole( ) will call UserRoles.getRole( . . . ) in the event a cached UserRole is not available.
com.probaris.sp.bean.UserRole
   Encapsulates the set of properties that define the privileges of a user's role. The properties are maintained as name/value pairs where the types of both the name and value are Strings.
com.probaris.sp.logic.UserRoles
   Provides the logic for setting and getting user role information.

Robot Users

Robot users are accounts that correspond to departments or other organizational units set up for routing forms in accordance with the present invention and provide powerful business process functionality. Any number of robot accounts may be created in accordance with the preferred embodiment. Naming follows email conventions and it is preferred that corresponding email accounts be set up for robot account administrator. Examples of robot accounts include:
NJ_State_Office@agency.gov
claims@insurance_company.com
division_HR@mega-industries.com
form_{—}177-34@government.gov

Robot users cannot process forms; instead, they must transfer the forms to “real” users for processing in the preferred embodiment, ensuring legal accountability. These transfers can be automated (e.g., round-robin within a workgroup) or performed by an administrator. Every robot user has at least one administrator, usually a business-user directly responsible for processing forms.

Routing initially to robot users achieves powerful benefits. First, the business process is insulated from individual job changes. Individuals typically change job responsibilities more frequently than organizations change business processes. By routing to a robot account, neither end users nor IT professionals need to change a business process when a user changes jobs. That responsibility devolves to a robot account administrator, who can make the change instantly, keeping responsibility with the business unit responsible for delivering service. Second, distribution of workload is facilitated. Robot accounts can automatically distribute forms as they arrive to a work-group on a “round-robin” basis. The target work-group list is under the control of the robot account administrators, who can modify it to manage vacation or sick-leaves, or variations in form volume. Alternately, administrators can log in and assign forms to real users in batches. Either way, workload can scale to huge volumes. Automatic rerouting can also be managed by a Java plug-in which can use any data value in the database for making transfer decisions, allowing highly sophisticated, automatic re-routing algorithms to be deployed. Finally, robot account provide shared access. Robot accounts can automatically “copy” forms to every individual in a work group. This enables “read only” access to selected forms throughout a department (e.g. Customer Service), and enables anyone in the workgroup to view current data contents, track progress, and review form history.

Deadlines and Reminders

Virtually all routing transactions supported by the present invention enable users to establish deadlines and set up automatic reminders. Deadlines show up with the form in the “Action Items” listing described above. Reminders automatically trigger emails either to the sender or the recipient, or both, at a date and time specified by the sender, and prompt the user to take action if a deadline is in danger of being missed. Reminders are automatically cancelled if the form is already routed.

Public and Private Comments

The present invention enables process participants to record comments with form transactions. Comments may be “public” or “private.” Public comments are part of the general form record, and may be viewed by anyone with access to the form from the “comment history” icon. Private comments are only viewable by the recipient of the form transaction.

Supporting Informal Collaboration

The inventive process supports informal collaboration among users while preserving the data security, status reporting, and audit facilities of the platform. The following “form actions” supported by the platform help enable collaboration:

Copy Action: Any authorized user of the system with access to a form can “copy” it to another authorized user (subject to appropriate roles for both). The copied user can now view the current state of form data, track progress and routing history, and view historical states of the data. The copy transaction, and any viewing of the data, is logged in the detailed audit trail. As with all routing transactions performed in accordance with the present invention, the form data never leaves the secure database server; the new user now simply has viewing rights to it.

Send for Edit Action: An authorized editor of a form section temporarily transfers edit responsibility to another user (subject to appropriate roles for both). The temporary editor can view the current form state, subject to data masking if applicable, and can edit the section to which the original editor had rights. This enables any authorized editor to enlist the help of any other appropriate user to help complete a form. When finished, the temporary editor can only return the form to the original editor (who retains responsibility for final review and routing) with comments. Afterwards, the temporary editor can no longer view or track the form unless explicitly “copied” by the original editor. The send for edit transaction, comments, and all edit sessions by the temporary editor, are logged in the detailed audit trail.

Send for Review Action: An authorized editor of a form section temporarily transfers viewing rights to other user(s) (subject to appropriate roles). The temporary viewers can read the sender's comments and view the current form state, subject to data masking if applicable, and can reply with comments and an opinion as to whether the form is ready for submission. This enables any authorized editor to enlist the help of as many other appropriate users as necessary to review and comment on a form. When finished, the temporary reviewer loses viewing and tracking rights to the form, unless explicitly “copied” by the original editor. The send for review transaction, and responses by each reviewer, are logged in the detailed audit trail.

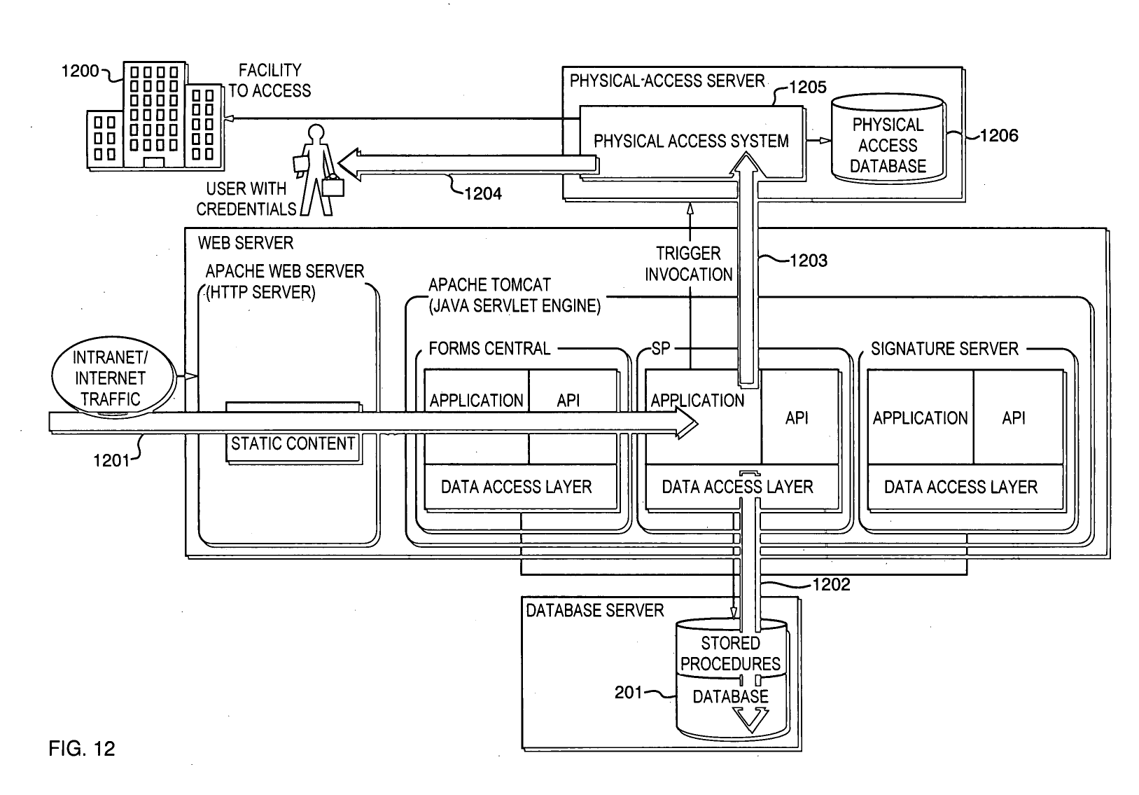

Send Blank: Users have the option to send a blank form to another user. The blank form, along with sender's comments, shows up in the “Action Items” listing of the recipient. Examples of this include a customer service agent sending a form to a customer; an HR specialist sending an application to an employee, or a supervisor sending a self-evaluation form to those she supervises. The advantage of sending blank (rather than referring another user to the forms repository), is the sender can now closely monitor progress of the form. The sender has the ability to view form contents and monitor progress (equivalent to a copy recipient). In addition, as with all routing transactions, the sender can set up deadlines and reminders for the recipient. For example, as shown in FIG. 9, the top form was “sent blank”, indicated by the status being “0 of 3”.

Authorizations

Most operations performed in connection with the inventive system require some sort of authorization check in order to perform them. Some operations simply require that the user is authenticated; others require the user to have some attribute or set of attributes. The following attributes may be used to determine authorization of an operation:
User Role
User Administrative Level
   0=None
   <N>=Other administrative levels
   255=System Administrator
User Property: Security Level
   Integer between 0 and 100
User Property: Authority Level
   Integer between 0 and 100
User Property: Registration Method
   Integer between 0 and 100
      Registration by administrator may be 99
      “Delegator-Style” registration may be 70
      Self Registration may be 1
User Property: Organization Affiliation
   String in dotted notation declaring organization hierarchy
      Company.Engineering.Coder
      Company.Engineering.Management
      company.Sales
      Enterprise.Business.Level.Position
Environment: User Authentication Modality
   Integer between 0 and 100
      Password may be 10
      Smart Card may be 90
Form Relationship: Section Owner
   String declaring the name of a section

In general, most system level actions (as opposed to “Form Level” actions) are based on attributes of the role that is assigned to the acting user; however some are based on the acting user's administrative level. For example, the ability to add users to the system is based on the user Administrative Level attribute while the ability to set deadlines is based on the value of the relevant property of the user's assigned role.

User administrators (or applications with User Administrator rights) assign roles to users. Each role has the same properties; however, the value of those properties may differ from role to role (this is set by users with system administrator rights). By default, all users have an administrative level of 0 or NONE. If desired, a Master System Administrator may change a user's administrative level such that they have one or more of the following rights:
User Administrator
   May create and edit users
   May create and edit robot users
Form Administrator
   May create and edit SP forms (not form instances)
System Administrator
   May edit system preferences
      Add/Edit/Remove Roles
      Add/Edit/Remove User Profile Properties

Form Level actions are also based on the rights granted by the acting user's assigned role. On top of this, the form designer may create rules used to limit those rights. A user's right to perform the desired action is calculated using the most restrictive rules.

All administrative actions require the user to have some level of administrative rights to perform them. This level is determined by the user's Administrative Level attribute, which is an integer value between 0 and 255. This value is stored in the SystemUser table in the AdminLevel column and can be retrieved using the getAdminLevel method of the User bean.

Essentially, this value is a bitmap representing the different administrative levels a user may have. The following lists those values:
0: None
1: Form Administrator
2: User Administrator
4: System Administrator
255: Master System Administrator

A user may possess the rights of zero or more administrative levels. Most users will be normal users and have an administrative level of 0. Some will be either a system, user, or form administrator or even a combination of them. For example, a user with system and user administrative rights will have an administrative level of 6.

$$\frac{\begin{matrix}0000 & 0010 ( user administrator [ 2 ] ) \\ ‖ 0000 & 0100 ( system administrator [ 4 ] ) \end{matrix}}{\begin{matrix} 0000 & 0110 ( user \& system administrator [ 6 ] )\end{matrix}}$$

Using the above example, we can apply a bitmask to determine whether the user can perform some task requiring User Administrator rights.

$$\frac{\begin{matrix}0000 \; 0110 & ( user \& system administrator [ 6 ] ) \\ \&\& 0000 \; 0010 & ( user administrator [ 2 ] )\end{matrix}}{\begin{matrix}0000 \; 0010 & ( user administrator [ 2 ] rights exist )\end{matrix}}$$

On the other hand, if the user is not assigned User Administrator rights, he will not be allowed to perform the task.

$$\frac{\begin{matrix}0000 \; 0100 & ( system administrator [ 6 ] ) \\ \&\& 0000 \; 0010 & ( user administrator [ 2 ] )\end{matrix}}{ \begin{matrix} 0000 \; 0000 & ( user administrator [ 2 ] rights do not exist )\end{matrix}}$$

Further, Master System Administrators may perform all administrative tasks

$$\frac{\begin{matrix}1111 \; 1111 & ( master system administrator [ 255 ] ) \\ \&\& 0000 \; 0010 & ( user administrator [ 2 ] )\end{matrix}}{\begin{matrix}0000 \; 0010 & ( user administrator [ 2 ] rights exist )\end{matrix}}$$

$$\frac{\begin{matrix}1111 \; 1111 & ( master system administrator [ 255 ] ) \\ \&\& 0000 \; 0010 & ( user administrator [ 4 ] )\end{matrix}}{\begin{matrix}0000 \; 0010 & ( user administrator [ 4 ] rights exist )\end{matrix}}$$

The following is a list of operations that require some level of administrative rights:

| Operation | Minimal Administrative Level |
|---|---|
| Add Form | Form Administrator |
| Activate Form | Form Administrator |
| Edit Form | Form Administrator |
| Remove Form | Form Administrator |
| Add Form Repository Folder | Form Administrator |
| Edit Form Repository Folder | Form Administrator |
| View Role List (for management) | System Administrator |
| Add User Role | System Administrator |
| View User Role | System Administrator |
| Edit User Role | System Administrator |
| Remove User Role | System Administrator |
| Add User Profile Property | System Administrator |
| Remove User Profile Property | System Administrator |
| View User List (for management) | User Administrator |
| Add User | User Administrator |
| View User Details (not self) | User Administrator |
| View User Profile (not self) | User Administrator |
| Edit User Details (not self) | User Administrator |
| Edit User Profile (not self) | User Administrator |
| Change User Authentication Properties | User Administrator |
| (not self) | |
| Change User Authentication Modality | User Administrator |
| (not self) | |

To test for proper administrative privileges, one of several options may be used:
1) The User bean, representing the user to authorize, may be used by calling one of the following methods on it:
   boolean canActAsAdministrator(UserAdminLevel in_level)
      Returns true if the user represented by the User bean may act as the specified administrator level
   boolean canActAsAdministrator(int in_levelValue)
      Returns true if the user represented by the User bean may act as the specified administrator level
   boolean canActAsAdministrator( )
      Returns true if the user represented by the User bean may act as some type of administrator (user, form, or system).
2) The UserAdminLevel bean retrieved from the relevant User bean, using the getAdminLevel method, maybe be used by calling one of the following methods on it:
   boolean canActAsAdministrator(UserAdminLevel in_level)
      Returns true if the UserAdmin level implies the specified administrator level
   boolean canActAsAdministrator(int in_levelValue)
      Returns true if the UserAdmin level implies the specified administrator level
   boolean canActAsAdministratoro
      Returns true if the UserAdmin level implies some type of administrator (user, form, or system).

Most actions are authorized using at the acting user's role assignment. Each role has a set of properties representing the privileges it encapsulates. Each role has the following properties (or privileges):
Allowed authentication modality (_System.AuthenticationModalities)
   None|Any|A sub-set of the existing authentication modalities
      “None” indicates no authentication allowed (i.e., the user may not log in to the system)
Allowed to override routing recommendations (_System.OverrideRoutingRecommendations)
   Yes|No
Allowed to route to (_System.RouteTo)
   None|Any|A sub-set of the existing system roles
      “None” indicates not allowed by user
Allowed to set deadlines/reminders (_System.SetDeadLines)
   Yes|No
Allowed to copy forms to (_System.CopyTo)
   None|Any|A sub-set of the existing system roles
      “None” indicates not allowed by user
Allowed to suspend forms (₁₃ System.CanSuspend)
   Yes|No
Allowed to suspend forms for paper processing (_System.CanSuspendForPaper)
   Yes|No
Allowed to finalize forms (_System.CanFinalize)
   Yes|No
Allowed levels to transfer back (_System.TransferBackLevels)
   0|1|Any
      0 indicates transfer back is not allowed
Allowed transfer forms to (_System.TransferTo)
   None|Any|A sub-set of the existing system roles
      “None” indicates not allowed by user
Allowed to withdraw forms (_System.CanWithdraw)
   Yes|No
Allowed to withdraw forms more than one level if Originator (_System.CanWithdrawMulti)
   Yes|No
Allowed to send for edit (_System.CanSendForEdit)
   Yes|No
Allowed to send for review (_System.CanSendForReview)
   Yes|No
Allowed to send blank forms (₁₃ System.CanSendBlank)
   Yes|No
Allowed to view identity of senders, receivers, attacher, copy recipient, etc. (_System.CanViewIdentities)
   Yes|No
Allowed to view form history, comments, revisions (_System.CanViewHistory)
   Yes|No
Allowed to view form attachments (_System.CanViewAttachments)
   Yes|No
Allowed to add form attachments (₋System.CanAddAttachments)
   Yes|No
Allowed to change user id (email address) (_System.CanChangeEmailAddress)
   Yes|No
Allowed to change common name (first/last name) (_System.CanChangeName)
   Yes|No
Allowed to change declare to be non-routable (_System.CanChangeRoutable)
   Yes|No
Allowed to change authentication modality (_System.CanChangeModality)
   Yes|No
Allowed to edit configurable user properties (_System.CanEditProfile)
   Yes|No
Allowed to browse forms (or create form instances) (_System.CanCreateFormInstances)
   Yes|No
Allowed to invite unregistered users to the system (_System.CanInviteUsers)
   Yes|No

It is expected that the appropriate authorization check be made before an attempt is made to perform an operation. Also, it is expected that if possible the set of available operations show to the acting user are limited to what that user may perform. Because all information necessary to check authorization for a user to perform an operation is not available, some operations may be available for users to select only to find out that after supplementary information is entered, the operation is not allowed. This scenario will be common when combining a user's privileges dictated by their role assignment with rules imposed by a form designer on a particular form.

To determine if a user's role allows a particular operation, a UserRole object is to be retrieved from the User object representing the acting user. From the UserRole object, a RoleProperty object representing the privilege should be found. To get the appropriate RolePropery object, the getPropery method of the UserRole object may be called with the specific property (or privilege) name (as indicated above). For example, to retrieve the RoleProperty representing the privilege of inviting a user to the system, the getProperty method is called with the argument of “_System.CanInviteUsers”. The returned RoleProperty object will contain the value of that property. For this particular property the value is expected to be a “Yes” or a “No”. The application should interpret the value appropriately such that if the value is “Yes” the operation is allowed (or shown as an option to the user). Else if the value is “No”, the operation is not allowed (nor is shown as an option to the user).

As previously mentioned, some actions are allowed using values from the acting user's assigned role as well as by the rules asserted by the designer of a particular form. These assertions are in the form of Boolean expressions associated with actions one can perform on a form at the form or section level, meaning rules can be asserted on the form in its entirety while more limiting rules may be applied to a given section. For example, a form designer may limit the editors of a form to those users who have a role with the name of “Employee” and then also limit the editors of “Section 3” to those user who have an “authority level” greater than 75. Thus, the editor of “Section 3” must be a user with the role of “Employee” AND have an “authority level” of 76 or above.

To do this, a form designer declares the rules in the meta-data file of the form. This meta-data file is an XML document conforming to the DTD. Form designers may assert rules for the following categories:

| Form Level | Section Level |
|---|---|
| Edit | Edit |
| View | Transfer |
| Export | |
| Copy | |
| Transfer | |

For each category, the form designer can declare authorization rules using, for example, the following DTD section:

<!ENTITY % expression
“role-name|organization-affiliation|approval-level|security-
level|registration-method|authentication-method|section-owner”>
<!ENTITY % expression_and_or_not “%expression;|and|or|not”>
<!ELEMENT expression (%expression_and_or_not;)>
<!ELEMENT and ((%expression_and_or_not;),
(% expression_and_or_not;)+)>
<!ELEMENT or ((%expression_and_or_not;),
(% expression_and_or_not;)+)>
<!ELEMENT not (%expression_and_or_not;)?>

| | |
|---|---|
| <!ELEMENT role-name | (eq\|neq)> |

<!ELEMENT organization-affiliation (eq|neq|gt|gte)>

| | |
|---|---|
| <!ELEMENT approval-level | (eq\|neq\|lt\|lte\|gt\|gte)> |

| | |
|---|---|
| <!ELEMENT security-level | (eq\|neq\|lt\|lte\|gt\|gte)> |

<!ELEMENT registration-method (eq|neq|lt|lte|gt|gte)>
<!ELEMENT authentication-method (eq|neq|lt|lte|gt|gte)>

| | |
|---|---|
| <!ELEMENT section-editor | (eq\|neq)> |
| <!-- Equals --> | |
| <!ELEMENT eq EMPTY> | |

<!ATTLIST eq value CDATA #REQUIRED>
<!-- Not Equals -->
<!ELEMENT neq EMPTY>
<!ATTLIST neq value CDATA #REQUIRED>
<!-- Less Than -->
<!ELEMENT lt EMPTY>
<!ATTLIST lt value CDATA #REQUIRED>
<!-- Less Than or Equal To -->
<!ELEMENT lte EMPTY>
<!ATTLIST lte value CDATA #REQUIRED>
<!-- Greater Than -->
<!ELEMENT gt EMPTY>
<!ATTLIST gt value CDATA #REQUIRED>
<!-- Greater Than or Equal To -->
<!ELEMENT gte EMPTY>
<!ATTLIST gte value CDATA #REQUIRED>

Each rule set designates who can perform the relevant operation. Thus, if the rule evaluates to TRUE, the acting user may perform that operation.

To enhance the user's experience, the logic of the system should prevent operations that would result in FALSE results in future authorization checks. Thus, if a user intends to route a section of a form to some other user, the operation should only succeed if the intended recipient is allowed to edit that section. Unfortunately, one piece of information that may be necessary to determine this will not be available: authentication-method, because the system to know how a user will authenticate in the future. For this, the infrastructure will need to supply the appropriate value to ensure that part of the expression will always evaluate to TRUE.

To programmatically determine whether the form designer's rules are met, the appropriate rule-set from the form meta-data are to be processed. Upon installing a form instance, each rule-set indicated by the form designer is parsed and recompiled into configuration data for the Boolean evaluator “plug-in”. The configuration data is then stored in the database such that relevant “plug-in instances” are created. Each “plug-in instance” is named as follows:
<form url>. [<section name>].<operation>Rules

Examples:

DataSet

| | | |
|---|---|---|
| DataSetID | NUMBER | This is a unique identifier that must |
| | (INT) | be unique among all data sets in this |
| | | table. |
| DataSetName | VARCHAR2 | This is the descriptive name of the |
| | (VARCHAR) | data set or the plug-in instance. |
| | | This name must be unique across all |
| | | plug-ins of the same type |
| | | (Plugin.PluginType) |
| PluginID | NUMBER | This is a unique identifier of the |
| | (INT) | plug-in implementation that this |
| | | data set is for. |
| DataSetValue | BLOB | This is the value of the data set |
| | | that contains the plug-in specific |
| | | configuration information. The |
| | | format of the data within this field |
| | | is dependant on the plug-in the reads |
| | | and writes it. NULL is a valid data |
| | | set, if the relavant plug-in accepts |
| | | it. |

The following database table is used for this:

fc://a1a1a1.EditRules
fc://a1a1a1.Section1.EditRules
fc://a1a1a1.Employee Data.TransferRules

The following is an example of how this plug-in architecture works:

DataSet

| | | | DataSet |
|---|---|---|---|
| DataSetID | DataSetName | PluginID | Value |
| 12 | fc://a1a1a1.EditRules | NULL | { . . . } |
| 13 | fc://a1a1a1.Section1.EditRules | NULL | { . . . } |
| 14 | fc://a1a1a1.Employee | NULL | { . . . } |
| | Data.TransferRules | | |

To determine if authorization is granted based on the criteria defined by a form designer, the application must obtain a RuleSet from the RulesSets singleton (cache). This is done by calling RuleSets.getRuleSet( ) giving it the unique identifier of the dataset that contains that appropriate XML rule set. If no RuleSet is found, it can be assumed that no rules have been declared and thus authorization is automatically granted. However; if one does exist, that RuleSet must be evaluated by calling either RuleSet.evaluateForActingUser or RuleSet.evaluateForRecipient. RuleSet.evaluateForActingUser is used to evaluate a rule set from the point of view of the user attempting to perform an action where RuleSet.evaluateForRecipient is used to evaluate a rule set from the point of view of the recipient of the action, or rather in preparation of the recipient attempting to perform the action in the future. The main difference between these two methods is that the recipient user (from the point of view of the acting user) is not authenticated at the time of evaluation; therefore environmental variables are not available. The main example for this is the recipient user's mode of authentication.

In an alternate embodiment, the form designer may declare authorization rules using the following XML Schema section:

<xsd:complexType name=“ExpressionValue_String”>

<xsd:sequence/>
<xsd:attribute name=“value” type=“xsd:string”/>

</xsd:complexType>
<xsd:complexType name=“ExpressionValue_Integer”>

<xsd:sequence/>
<xsd:attribute name=“value” type=“xsd:integer”/>

</xsd:complexType>
<xsd:element name=“vars_and_or_not” abstract=“true”/>
<xsd:complexType name=“EqNeq_String”>

<xsd:choice>

<xsd:element maxOccurs=“1” minOccurs=“1” name=“eq”

type=“ExpressionValue_String”/>

<xsd:element maxOccurs=“1” minOccurs=“1” name=“neq”

type=“ExpressionValue_String”/>

</xsd:choice>

</xsd:complexType>
<xsd:complexType name=“EqNeqGtGte_String”>

<xsd:choice>

<xsd:element maxOccurs=“1” minOccurs=“1” name=“eq”

type=“ExpressionValue_String”/>

<xsd:element maxOccurs=“1” minOccurs=“1” name=“neq”

type=“ExpressionValue_String”/>

<xsd:element maxOccurs=“1” minOccurs=“1” name=“gt”

type=“ExpressionValue_String”/>

<xsd:element maxOccurs=“1” minOccurs=“1” name=“gte”

type=“ExpressionValue_String”/>

</xsd:choice>

</xsd:complexType>
<xsd:complexType name=“EqNeqLtLteGtGte_Integer”>

<xsd:choice>

<xsd:element maxOccurs=“1” minOccurs=“1” name=“eq”

type=“ExpressionValue_Integer”/>

<xsd:element maxOccurs=“1” minOccurs=“1” name=“neq”

type=“ExpressionValue_Integer”/>

<xsd:element maxOccurs=“1” minOccurs=“1” name=“lt”

type=“ExpressionValue_Integer”/>

<xsd:element maxOccurs=“1” minOccurs=“1” name=“lte”

type=“ExpressionValue_Integer”/>

<xsd:element maxOccurs=“1” minOccurs=“1” name=“gt”

type=“ExpressionValue_Integer”/>

<xsd:element maxOccurs=“1” minOccurs=“1” name=“gte”

type=“ExpressionValue_Integer”/>

</xsd:choice>

</xsd:complexType>
<xsd:complexType name=“TwoOrMoreOperations”>

<xsd:group maxOccurs=“unbounded” minOccurs=“2”
ref=“vars_and_or_not”/>

</xsd:complexType>
<xsd:complexType name=“ZeroOrOneOperation”>

<xsd:group maxOccurs=“1” minOccurs=“0”
ref=“vars_and_or_not”/>

</xsd:complexType>
<xsd:complexType name=“OneOperation”>

<xsd:group maxOccurs=“1” minOccurs=“0”
ref=“vars_and_or_not”/>

</xsd:complexType>
<xsd:complexType name=“FormTwoOrMoreOperations”>

<xsd:group maxOccurs=“unbounded” minOccurs=“2”
ref=“Form_vars_and_or_not”/>

</xsd:complexType>
<xsd:complexType name=“FormZeroOrOneOperation”>

<xsd:group maxOccurs=“1” minOccurs=“0”
ref=“Form_vars_and_or_not”/>

</xsd:complexType>
<xsd:complexType name=“FormOneOperation”>

<xsd:group maxOccurs=“1” minOccurs=“0”
ref=“Form_vars_and_or_not”/>

</xsd:complexType>
<xsd:group name=“vars_and_or_not”>

<xsd:choice>

<xsd:element name=“role-name” type=“EqNeq_String”/>
<xsd:element name=“organization-affiliation”
type=“EqNeqGtGte_String”/>
<xsd:element name=“approval-level”
type=“EqNeqLtLteGtGte_Integer”/>
<xsd:element name=“security-level”
type=“EqNeqLtLteGtGte_Integer”/>
<xsd:element name=“registration-method”
type=“EqNeqLtLteGtGte_Integer”/>
<xsd:element name=“authentication-method”
type=“EqNeqLtLteGtGte_Integer”/>
<xsd:element name=“section-owner”
type=“EqNeq_String”/>
<xsd:element name=“and” type=“TwoOrMoreOperations”/>
<xsd:element name=“or” type=“TwoOrMoreOperations”/>
<xsd:element name=“not” type=“ZeroOrOneOperation”/>

</xsd:choice>

</xsd:group>
<xsd:group name=“Form_vars_and_or_not”>

<xsd:choice>

<xsd:element name=“role-name” type=“EqNeq_String”/>
<xsd:element name=“organization-affiliation”
type=“EqNeqGtGte_String”/>
<xsd:element name=“approval-level”
type=“EqNeqLtLteGtGte_Integer”/>
<xsd:element name=“security-level”
type=“EqNeqLtLteGtGte_Integer”/>
<xsd:element name=“registration-method”
type=“EqNeqLtLteGtGte_Integer”/>
<xsd:element name=“authentication-method”
type=“EqNeqLtLteGtGte_Integer”/>
<xsd:element name=“and”
type=“FormTwoOrMoreOperations”/>
<xsd:element name=“or”
type=“FormTwoOrMoreOperations”/>
<xsd:element name=“not”
type=“FormZeroOrOneOperation”/>

</xsd:choice>

</xsd:group>
<xsd:complexType name=“Section”>

<xsd:sequence>

<xsd:element maxOccurs=“1” minOccurs=“0”
name=“edit-requirements”

type=“OneOperation”/>

<xsd:element maxOccurs=“1” minOccurs=“0”
name=“transfer-requirements”

type= “OneOperation”/>

<xsd:element maxOccurs=“1” minOccurs=“0”
name=“on-route”
type=“OnRoute”/>

</xsd:sequence>
<xsd:attribute name=“name” type=“xsd:string”
use=“required”/>
<xsd:attribute name=“description” type=“xsd:string”
use=“required”/>

</xsd:complexType>
<xsd:complexType name=“FinalSection”>

<xsd:sequence>

<xsd:element maxOccurs=“1” minOccurs=“0”
name=“edit-requirements”

type=“OneOperation”/>

<xsd:element maxOccurs=“1” minOccurs=“0”
name=“transfer-requirements”

type=“OneOperation”/>

<xsd:element maxOccurs=“1” minOccurs=“0”
name=“on-finalize” type=“OnFinalize”/>

</xsd:sequence>
<xsd:attribute name=“name” type=“xsd:string”
use=“required”/>
<xsd:attribute name=“description” type=“xsd:string”
use=“required”/>

</xsd:complexType>
<xsd:complexType name=“Form”>

<xsd:sequence>

<xsd:element maxOccurs=“1” minOccurs=“0”
name=“edit-requirements”

type=“FormOneOperation”/>

<xsd:element maxOccurs=“1” minOccurs=“0”
name=“view-requirements”

type=“FormOneOperation”/>

<xsd:element maxOccurs=“1” minOccurs=“0”
name=“export-requirements”

type=“FormOneOperation”/>

<xsd:element maxOccurs=“1” minOccurs=“0”
name=“copy-requirements”

type=“FormOneOperation”/>

<xsd:element maxOccurs=“1” minOccurs=“0”
name=“transfer-requirements”

type=“FormOneOperation”/>

<xsd:element maxOccurs=“1” minOccurs=“1”
name=“origination-section”

type=“Section”/>

<xsd:element maxOccurs=“unbounded” minOccurs=“0”
name=“section” type=“Section”/>
<xsd:element maxOccurs=“1” minOccurs=“1”
name=“final-section” type=“FinalSection”/>

</xsd:sequence>
<xsd:attribute name=“name” type=“xsd:string”/>

</xsd:complexType>

Before a user is allowed to perform an action on a form, several authorization checks must be made. These checks are broken up into two groups: pre-qualification and post-qualification. The pre-qualification checks validate general rights a user has related to the particular actions where the post-qualification checks validate the rights a user has related to the particular actions after that action's properties have be specified. For example, a user's right to transfer a particular form instance is a pre-qualification check where the post-qualification check will validate that the user has the right to transfer the form instance to some particular recipient. One reason to split out the two groups is that the pre-qualification checks will help to generate the user interfaces such that only valid actions are available.

Below is a list of the validations for each action broken into the two authorization groupings:
Route:
   Pre-qualification
      Form is in editable state
      Active section is in editable state
      Active section is NOT “finalization” section
      Acting user is Section Owner and Current Editor of active section
      Acting user's role allows routing
   Post-qualification
      Recipient is valid according to assigned routing behavior
      Recipient is allowed to edit forms according to recipient's assigned role
      Recipient is allowed to edit the routed section according to form requirements
         Recipient's role
         Recipient's profile information
   Finalize:
      Pre-qualification
         Form is in editable state
         Active section is in editable state
         Active section is “finalization” section
         Acting user is Section Owner and Current Editor of active section
         Acting user's role allows finalization
      Post-qualification
         <NONE>
   Copy:
      Pre-qualification
         Form is in viewable state
         Acting user is Section Owner of ANY section
         Acting user's role allows copying
         Form requirements allow copying
      Post-qualification
         All copy recipients are allowed to be copy recipients according to the recipients' assigned role
         All copy recipients are allowed to view the copied form according to form requirements
            Recipient's role
            Recipient's profile information
   Transfer:
      Pre-qualification
         Form is in viewable or editable state
         Acting user is Section Owner of ANY section
         Acting user's role allows transferring at all
         Form requirements allow transferring at all
            Per section
            Per form
      Post-qualification
         Recipient is not the Section Owner of transferred section
         Recipient is allowed to edit forms to the recipient's assigned role
         Recipient is allowed to edit the form according to form requirements
            Recipient's role
            Recipient's profile information
   Send for Edit
      Pre-qualification
         Form is in editable state
         Active section is in editable state
         Acting user is Section Owner and Current Editor of active section
         Acting user's role allows sending for edit
   Post-qualification
      Recipient is not the Section Owner of active section
      Recipient is allowed to edit form according to recipient's assigned role
      Recipient is allowed to edit the active section according to form requirements
         Recipient's role
         Recipient's profile information
   Send for Review
      Pre-qualification
         Form is in editable state
         Active section is in editable state
         Acting user is Section Owner and Current Editor of active section
         Acting user's role allows sending for review
      Post-qualification
         Recipient is not the Section owner of active section
         Recipient is allowed to view forms according to recipient's assigned role
         Recipient is allowed to view the form according to form requirements
            Recipient's role
            Recipient's profile information
   Return Send for Edit
      Pre-qualification
         Form is in editable state
         Active section is in temporary editable state
         Acting user is Current Editor of active section
      Post-qualification
         <NONE>
   Return Send for Review
      Pre-qualification
         Form is in editable state
         Active section is in review state
         Acting user is Current Editor of active section
      Post-qualification
         <NONE>
   Cancel Send for Edit
      Pre-qualification
         Form is in editable state
         Active section is in temporary editable state
         Acting user is Section Owner of active section
         Acting user is NOT Current Editor of active section
      Post-qualification
         <NONE>
   Cancel Send for Review
      Pre-qualification
         Form is in editable state
         Active section is in review state
         Acting user is Section Owner of active section
         Acting user is NOT Current Editor of active section
      Post-qualification
         <NONE>
   Suspend
      Pre-qualification
         Form is in editable state
         Active section is in editable state
         Acting user is Section Owner and Current Editor of active section
         Acting user's role allows suspending
      Post-qualification
         <NONE>
   Un-suspend
      Pre-qualification
         Form is in suspended state
         Acting user is Section Owner and Current Editor of active section
      Post-qualification
         <NONE>
   Suspend for Paper
      Pre-qualification
         Form is in editable state
         Active section is in editable state
         Acting user is Section Owner and Current Editor of active section
         Acting user's role allows suspending to paper
      Post-qualification
         <NONE>
   View Form Revision
      Pre-qualification
         Forms instance revision is in viewable state
         Acting user's role allows view of forms
         Acting user is a Section Owner or Copy Recipient of form instance OR is the Process Owner of the form
         Acting user is allowed to view the form according to form requirements
            Acting User's role
            Acting User's profile information
      Post-qualification
         <NONE>
   Create Form
      Pre-qualification
         Acting user's role allows creation of forms
         Acting user's role allows editing of forms
         Acting user is allowed to edit the form according to form requirements
            Acting User's role
            Acting User's profile information
         Acting user is allowed to edit the form's “origination” section according to form requirements
            Acting User's role
            Acting User's profile information
      Post-qualification
         <NONE>
   Edit Form
      Pre-qualification
         Forms instance revision is in editable state
         Acting user's role allows editing of forms
         Acting user is the Current Editor of the active section
         Acting user is allowed to edit the form according to form requirements
            Acting User's role
            Acting User's profile information
         Acting user is allowed to edit the active section according to form requirements
            Acting User's role
            Acting User's profile information
      Post-qualification
         <NONE>
   Send Blank Form
      Pre-qualification
         Acting user's role allows sending blank forms
      Post-qualification
         Recipient is allowed to edit forms according to recipient's assigned role
         Recipient is allowed to edit the origination section according to form requirements
            Recipient's role
            Recipient's profile information
   Transfer Back
      Pre-qualification
         Form is in editable state
         Active section is in editable state
         Active section is NOT “origination” section
         Acting user is Section Owner and Current Editor of active section
         Acting user's role allows transferring back
      Post-qualification
         <NONE>
   Transfer Back Accept/Reject
      Pre-qualification
         Form is in a pending transfer state
         Acting user is Section Owner and Current Editor of active section
      Post-qualification
         <NONE>
   Withdraw
      Pre-qualification
         Form is in editable state
         Active section is in editable state
         Acting user is Section Owner of previously active section
         Acting user's role allows withdrawing
      Post-qualification
         <NONE>
   Export
      Pre-qualification
         Form instance revision is in viewable state
         Acting user's role allows export of forms
         Acting user is a Section Owner or Copy Recipient of form instance OR is the Process Owner of the form
         Acting user is allowed to export the form according to form requirements
            Acting User's role
            Acting User's profile information
      Post-qualification
         <NONE>
   View Form Instance History
      Pre-qualification
         Acting user's role allows the viewing of form histories
         Acting user is a Section Owner or Copy Recipient of form instance OR is the Process Owner of the form
      Post-qualification
         <NONE>
   Add Form Instance File Attachments
      Pre-qualification
         Forms instance revision is in editable state
         Acting user's role allows adding attachments
         Acting user is a Section Owner of form instance OR is the Process Owner of the form
      Post-qualification
         <NONE>
   Retrieve Form Instance File Attachments
      Pre-qualification
         Acting user's role allows the viewing of form attachments
         Acting user is a Section Owner or Copy Recipient of form instance OR is the Process Owner of the form
      Post-qualification
         <NONE>

Plug-ins

An advanced feature of the system is its plug-in architecture. The following classes of functionality are built using the plug-in API:
Authentication Modules
Routing Behaviors
User Behaviors
Validators
Form Access
Routing Triggers

The plug-in API allows for plug-in classes as well as plug-in instances to be managed and used. A plug-in class is the actual class that implements the behavior of the plug-in. A plug-in instance is a combination of the plug-in class and a set of configuration data that fine-tunes its behavior. For example, one of the standard authentication plug-ins implements Signature authentication. However, this plug-in yields as least two plug-in instances such that one set of configuration data pulls digital certificate information from Microsoft's software certificate store (Certificate) and the other pulls the digital certificate from a Smart Card reader supported by Microsoft's CAPI (Smart Card).

The plug-in architecture is based on a set of tables that contains plug-in class information as well as plug-in instance configuration information. The exemplary Plugin table, below, identifies the plug-in implementation and allows for categorizing them based on functionality (for example authentication or routing behavior). In order for an instance of a plug-in to be configured, the plug-in implementation class must be declared in this table.

Plugin

| | | |
|---|---|---|
| PluginID | NUMBER | This is a unique identifier that must be |
| | (INT) | unique among all plug-ins in this table. |
| PluginType | VARCHAR2 | This is the descriptive type of the |
| | (VARCHAR) | plug-in. The system recognizes the |
| | | following types (or categories): |
| | | authentication |
| | | user_behavior |
| | | routing_behavior |
| | | property_validator |
| | | form_access |
| | | finalization_behavior (future) |
| PluginName | VARCHAR2 | This is the descriptive name of the |
| | (VARCHAR) | plug-in. Ideally this name is unique |
| | | within each plug-in type or category. |
| ClassName | VARCHAR2 | This is the classname of Java class that |
| | (VARCHAR) | implements the plug-in. |

Once a plug-in implementation class has been registered with the system (i.e., a record for that plug-in class exists in the Plugin table), a plug-in instance must be declared so it may be used by the system. To do this, a row must be inserted into the DataSet table making a relationship between the plug-in implementation data and a dataset that configures a plug-in instance. It should be noted that an empty dataset is a valid dataset.

DataSet

| | | |
|---|---|---|
| DataSetID | NUMBER | This is a unique identifier that must be |
| | (INT) | unique among all data sets in this table. |
| DataSetName | VARCHAR2 | This is the descriptive name of the data |
| | (VARCHAR) | set or the plug-in instance. This name |
| | | must be unique across all plug-ins of |
| | | the same type (Plugin.PluginType) |
| PluginID | NUMBER | This is a unique identifier of the |
| | (INT) | plug-in implementation that this data |
| | | set is for. |
| DataSetValue | BLOB | This is the value of the data set that |
| | | contains the plug-in specific |
| | | configuration information. The format |
| | | of the data within this field is |
| | | dependant on the plug-in the reads and |
| | | writes it. NULL is a valid data set, if |
| | | the relavant plug-in accepts it. |

In general, the dataset values for the default plug-in are in XML; however this is not a requirement. Because the field that holds this value can accommodate binary data, there are no limits to the format of the data. An example dataset value may be as follows:

<?xml version=‘1.0’ encoding=‘utf-8’?>
<!DOCTYPE signature-authentication-dataset [

<!ELEMENT signature-authentication-dataset
(action-time-out?, certificate-store)>
<!ELEMENT action-time-out EMPTY>
<!ATTLIST action-time-out seconds CDATA #REQUIRED>
<!ELEMENT certificate-store EMPTY>
<!ATTLIST certificate-store location (1|2|3|4) #REQUIRED>
<!ATTLIST certificate-store name CDATA #REQUIRED>]>

<signature-authentication-dataset>

<action-time-out seconds=“30” />
<certificate-store location=“4” name=“” />

</signature-authentication-dataset>

This DataSet value represents the configuration data for the Signature Authentication plug-in. In particular, this dataset configures the plug-in for the Smart Card Authentication modaltiy.

The following is an example of how this plug-in architecture works:

Plugin

| PluginID | PluginType | PluginName | ClassName |
|---|---|---|---|
| 3 | routing_{—} | DefaultRoutingBehavior | com.probaris.sp |
| | behavior | | . . . |
| 4 | routing_{—} | ExplicitRoutingBehavior | com.probaris.sp |
| | behavior | | . . . |
| 7 | authentication | Signature | com.probaris.sp |
| | | | . . . |

DataSet

| | | | DataSet |
|---|---|---|---|
| DataSetID | DataSetName | PluginID | Value |
| 4 | Default | 3 | NULL |
| 5 | 1234-07.Section1 | 4 | { . . . } |
| 6 | 1043-02.Section3 | 4 | { . . . } |
| 9 | Certificate | 7 | { . . . } |
| 10 | Smart Card | 7 | { . . . } |

The above example shows that there are three plug-in implementations registered with the system. There are two routing behavior plug-in implementations (DefaultRoutingBehavior and ExplicitRoutingBehavior) and one authentication plug-in implementation (Signature). Using the three registered implementations, five plug-in instances are available:

| | |
|---|---|
| Dummy: | An instance of the DefaultRoutingBehavior plug-in |
| 1234_07.Section1: | An instance of the ExplicitRoutingBehavior plug-in |
| 1042_02.Section3: | An instance of the ExplicitRoutingBehavior plug-in |
| Certificate: | An instance of the Signature plug-in |
| Smart Card: | An instance of the Signature plug-in |

It should be noted that, though not shown here, the DataSetName column is unique only among other plug-ins of the same type. Therefore, it is possible for two or more plug-in instances to have the DataSetName of “Default”; however, they must be associated with different plug-in implementation types (i.e., “authentication” or “routing_behavior”).

To implement a class of plug-in and plug-in instances, a plug-in factor class must be implemented as well as the plug-in implementation classes. Each needs to adhere to a specific interface.

All plug-in factory classes must be derived from the Plugins (com.probaris.sp.plugin.Plugins) abstract class. This class provides implementations for installing plug-ins and plug-in instances as well as a generic means to query for and create plug-in object instances.

All plug-in implementation classes must be derived from the Plugin (com.probaris.sp.plugin.Plugin) abstract class. This class provides generic functionality that each plug-in needs to be properly used within the system. In general, this is not enough to use for implementing a plug-in, so another layer of abstraction is added to provide for plug-in type specific functionality. For example, the Signature plug-in implementation class is derived from AuthenticationPlugin, which in turn is derived from Plugin.

The following provides the interface specifics for the identified plugins:
com.probaris.sp.plugin.Plugins
protected final Plugin createPluginInstance(PluginInstanceDetails in_details)
   Given the details about a plug-in instance, loads the class, creates an instance, and then initializes it
protected final Plugin createPlugin(PluginDetails in_details)
   Given the details about a plug-in implementation class, loads the class and creates an instance of it.
protected final List createPluginInstances(List in_detailsList)
   Given the details about a plug-in instance, loads the class, creates an instance, and initializes it
protected static final boolean exists(Connection in_connection, PluginType in_pluginType, String in_pluginName) throws SQLException
   Tests to see if the specified plug-in implementation exists
protected static final boolean exists(Connection in_connection, PluginType in_pluginType, String in_pluginName, String in_pluginInstanceName) throws SQLException
   Tests to see if the specified plug-in instance exists
protected final boolean deletePlugin(Connection in_connection, PluginType in_pluginType, String in_pluginName) throws IllegalArgumentException
   Removes the specified plug-in implementation and its instances
protected final boolean deletePlugin(Connection in_connection, PluginType in_pluginType, Long in_pluginid) throws IllegalArgumentException
   Removes the specified plug-in implementation and its instances
protected static final boolean insertPlugin(Connection in_connection, PluginType in_pluginType, String in_pluginName, String in_pluginClassName) throws IllegalArgumentException, NonUniquePluginException
   Inserts a plug-in implementation class
protected static final Long insertPluginInstance(Connection in_connection, PluginType in_pluginType, String in_pluginName, String in_pluginInstanceName, byte[ ] in_pluginDataSet) throws IllegalArgumentException, NonUniquePluginException
   Inserts the data necessary to create plug-in instances of the specified plug-in implementation class
protected static final boolean setPluginInstanceDataSet(Connection in_connection, PluginType in_pluginType, Long in_pluginInstanceId, byte[ ] in_pluginDataSet) throws Illegal ArgumentException
   Changes the configuration data for the specified plug-in instance
protected final Plugin getPluginInstance(Connection in_connection, PluginType in_pluginType, Long in_pluginInstanceId) throws IllegalArgumentException
   Creates a instance of the specified plug-in instance
protected final Plugin getPluginInstance(Connection in_connection, PluginType in_pluginType, String in_instanceName) throws IllegalArgumentException
   Creates a instance of the specified plug-in instance
protected final Plugin getPlugin(Connection in_connection, PluginType in_pluginType, String in_pluginName) throws IllegalArgumentException
   Creates a non-configured instance of the specified plug-in implementation class
protected final List getPluginInstances(Connection in_connection, PluginType in_pluginType)
   Creates all instances of all plug-in implementations for a given plug-in type (i.e., all authentication plug-ins)
protected java.util.Properties getPropertiesFromResouce(String in_fileName) throws java.io.IOException
   For help in installing plug-ins, loads a resource bundle and obtains a set of properties public static final void installPluginClass(Connection in_connection, String in_pluginClassName, PluginType in_pluginType)
   Installs a plug-in implementation class
protected final void install(Connection in_connection, java.util.Properties in_properties, PluginType in_pluginType)
   Given the properties about a set of plug-ins, attempts to install the implementation class and it instances
public static void installPlugins(Connection in_connection)
   Should be overridden by plug-in factories to help install plug-in instances
public Long insertPluginInstance(String in_pluginName, String in_pluginInstanceName, byte[ ] in_pluginDataSet) throws NonUniquePluginException, IllegalArgumentException
   Should be overridden by plug-in factories to help install plug-in instances
public abstract Long insertPluginInstance(Connection in_connection, String in_pluginName, String in_pluginInstanceName, byte[ ] in_pluginDataSet) throws NonUniquePluginException, IllegalArgumentException
   Must be implemented by plug-in factories to help install plug-in instances public abstract PluginType getSupportedType( )
   Must be implemented by plug-in factories to return the plug-in type supported by the factory
com.probaris.sp.plugin.Plugin
protected Long m_pluginId
   A common property among all plug-ins: unique plug-in implementation identifier
protected String m_pluginName
   A common property among all plug-ins: plug-in implementation name
protected PluginType m_pluginType
   A common property among all plug-ins: plug-in implementation type
protected String m_pluginInstanceName
   A common property among all plug-ins: plug-in instance name
protected Long m_pluginInstanceId
   A common property among all plug-ins: plug-in instance unique identifier
public final String getName( )
   Returns the name of the plug-in implementation
public final String getInstanceName( )
   Returns the name of the plug-in instance
public final Long getId( )
   Returns the unique identifier of name of the plug-in implementation
final void setId(Long in_value)
   Sets the unique identifier of the plug-in implementation
public final Long getInstanceId( )
   Returns the unique identifier of the plug-in implementation
final void setInstanceId(Long in_value)
   Sets the unique identifier of the plug-in implementation
public final PluginType getType( )
   Returns the type of the plug-in implementation
public final boolean initialize(Long in_pluginId, String in_pluginName, PluginType in_pluginType, Long in_pluginInstanceId, String in_pluginInstanceName, byte[ ] in_configData) throws IllegalArgumentException, PluginException, PluginConfigurationException
   Initializes the plug-in instance by configuring the plug-in implementation using the instance-specific configuration data
public final void destroy( ) throws PluginException
   Destroys the plug-in instance (allows for resources to be released)
protected java.util.Properties getPropertiesFromResouce(String in_fileName) throws IOException
   For help in installing plug-ins, loads a resource bundle and obtains a set of properties
protected void installPluginInstance(java.sql.Connection in_connection, java.util.Properties in_properties, PluginType in_pluginType, String in_pluginName)
   Installs an instance of the plug-in implementation
protected void install(java.sql.Connection in_connection, java.util.Properties in_properties, PluginType in_pluginType)
   Installs instances of the plug-in implementation based on installation properties
public void install(java.sql.Connection in_connection, PluginType in_pluginType)
   Installs instances of the plug-in implementation based on installation properties
public abstract byte[ ] packageDataSet(Properties in_properties) throws IOException, PluginConfigurationException
   Returns a byte array representing the configuration data represented by the specified set of properties for the plug-in instance (used to persists the configuration data)
public abstract byte[ ] packageDataSet(InputStream in_xmlInputStream) throws IOException, PluginConfigurationException
   Returns a byte array representing the configuration data represented by the specified XML document for the plug-in instance (used to persists the configuration data)
public abstract byte[ ] packageDataSet( ) throws IOException
   Returns a byte array representing the internal configuration data of the plug-in instance
   (used to persists the configuration data)
protected abstract void cleanup( ) throws PluginException
   Must be implemented by the plug-in implementation (on behalf of the plug-in instance) to clean up any resource before being destroyed
protected abstract boolean initialize(byte[ ] in_configData) throws PluginException, PluginConfigurationException
   Must be implemented by the plug-in implementation (on behalf of the plug-in instance) to allow for the configuration of the plug-in instance
public abstract Map getConfiguration( )
   Must be implemented by the plug-in implementation (on behalf of the plug-in instance) to return a map of the plug-in instance's configuration data
public abstract boolean setConfiguration(Map in_config, boolean in_saveData) throws PluginException, PluginConfigurationException
   Must be implemented by the plug-in implementation (on behalf of the plug-in instance) to allow for the configuration data to be set (usually by some user interface)

The following provides a description of plug-in installation.

Plug-ins are installed using the plug-in installation Java application that parses an appropriate XML file and processes directives for database connection information as well as plug-ins to install. The XML document must conform to the following XML Schema:

<?xml version=“1.0” encoding=“UTF-8”?>
<xsd:schema xmlns:xsd=“http://www.w3.org/2001/XMLSchema”

```
  targetNamespace=“urn:probaris:sp:plugins:1.5”
  xmlns=“urn:probaris:sp:plugins:1.5”
  elementFormDefault=“qualified”
  attributeFormDefault=“unqualified”>
<xsd:simpleType name=“PluginType”>
```

<xsd:restriction base=“xsd:string”>

<xsd:enumeration value=“authentication”/>
<xsd:enumeration value=“user_behavior”/>
<xsd:enumeration value=“routing_behavior”/>
<xsd:enumeration value=“property_validation”/>
<xsd:enumeration value=“routing_trigger”/>

</xsd:restriction>

</xsd:simpleType
<xsd:complexType name=“PluginInstance”>

<xsd:sequence>

<xsd:any processContents=“skip” minOccurs=“0” />

</xsd:sequence>
<xsd:attribute name=“name” type=“xsd:string”
use=“required” />

</xsd:complexType>
<xsd:complexType name=“Plugin”>

<xsd:sequence>

<xsd:element maxOccurs=“unbounded” minOccurs=“0”
name=“instance”

type=“PluginInstance”/>

</xsd:sequence>
<xsd:attribute name=“name” type=“xsd:string”
use=“required”/>
<xsd:attribute name=“type” type=“PluginType”
use=“required”/>
<xsd:attribute name=“classname” type=“xsd:string”
use=“required”/>

</xsd:complexType>
<xsd:complexType name=“DatabaseConfiguration”>

<xsd:attribute name=“driver” type=“xsd:string”
use=“required”/>
<xsd:attribute name=“dao” type=“xsd:string” use=“required”/>
<xsd:attribute name=“url” type=“xsd:string” use=“required”/>
<xsd:attribute name=“username” type=“xsd:string”
use=“required”/>
<xsd:attribute name=“password” type=“xsd:string”
use=“required”/>

</xsd:complexType>
<xsd:complexType name=“Plugins”>

<xsd:sequence>

<xsd:element maxOccurs=“unbounded” minOccurs=“0”
name=“plugin”

type=“Plugin”/>

</xsd:sequence>

</xsd:complexType>
<xsd:complexType name=“Configuration”>

<xsd:sequence>

<xsd:element maxOccurs=“1” minOccurs=“1”
name=“database”

type=“DatabaseConfiguration”/>

</xsd:sequence>

</xsd:complexType>
<xsd:complexType name=“Installer”>

<xsd:sequence>

<xsd:sequence>

<xsd:element minOccurs=“1” maxOccurs=“1”
name=“configuration”

type=“Configuration”/>

<xsd:element minOccurs=“1” maxOccurs=“1”
name=“plugins”
type=“Plugins”/>

</xsd:sequence>

</xsd:sequence>

</xsd:complexType>

<xsd:element name=“installer” type=“Installer”/>

</xsd:schema>

Example:

| | |
|---|---|
| 1 | <?xml version=“1.0” encoding=“UTF-8”?> |
| 2 | <plugin-installer:installer |

| | xmlns:plugin-installer=“urn:probaris:sp:plugins:1.5” |
|---|---|
| | xmlns:xsi=“http://www.w3.org/2001/XMLSchema-instance”> |
| 3 | <plugin-installer:configuration> |
| 4 | <plugin-installer:database |

```
  driver=“com.mysql.jdbc.Driver”
  dao=“com.probaris.sp.dataaccess.mysql.MySQLDAO”
  url=“jdbc:mysql://localhost:3306/db”
  username=“username”
  password=“password”/>
```

| 5 | </plugin-installer:configuration> |
|---|---|
| 6 | <plugin-installer:plugins> |
| 7 | <plugin-installer:plugin name=“MyPlugin” |
| | type=“authentication” |

| | classname=“example.MyPlugin”> |
|---|---|
| 8 | <plugin-installer:instance name=“My Plug-in |
| | Instance”> |

| | |
|---|---|
| 9 | <my-plugin-dataset> |

| | |
|---|---|
| 10 | ... |

| | |
|---|---|
| 11 | </my-plugin-dataset> |

| | |
|---|---|
| 12 | </plugin-installer:instance> |

| | |
|---|---|
| 13 | </plugin-installer:plugin> |
| 14 | </plugin-installer:plugins> |

| | |
|---|---|
| 15 | </plugin-installer:installer> |

1 Processing Instruction—It tells a browser (or other user-agent) that this document conforms to XML version 1.0 and that it uses the UTF-8 character encoding scheme.
2 Document Declaration—The root element is named “installer” and it conforms to the XML Schema defined for the XML Namespace of urn:probaris:sp:plugins:1.5 (which is shown above). Other XML names spaces that may be referenced in this document is the standard XML Schema Instance, which is located at the following URL:
   http://www.w3.org/2001/XMLSchema-instance
3 Opening tag of the configuration section. The section must declare the necessary data to configure the installer tool so it may work properly.
4 Tag declaring the database configuration. The section must declare the following attributes (used to set up the connection to the database):
   driver
      The class name of the JDBC driver to use for the connection implementation
   dao
      The Data Access Object (DAO) class to use to implement the data access layer.
   url
      The JDBC driver-specific connection URL to use to connect to the database
   Usename
      The user name to use to login to the database
   Password
      The password to use to login to the database
5 The closing tag for the configuration section
6 Opening tag of the plug-ins section. The section must include one or more plug-in declaration sections.
7 Opening tag of the plug-in section. The plug-in's name, type, and class name must be declared.
   name
      simple and descriptive name of the plug-in implementation
   type
      one of the valid SP plug-in types: authentication, validator, routing behavior, routing trigger, etc. . . .
   classname
      absolute class name of the Java class that implements the plug-in
8 Opening tag of the plug-in instance section. The plug-in-instance's name, must be declared.
   name
      simple and descriptive name of the plug-in instances name
   Note: A “plug-in instance” is a specialization of a plug-in implementation.
9 Opening tag of the plugin-instance's plug-in-specific configuration data set
10 Plug-in-specific configuration data (any valid XML can go here)
11 Closing tag of the plugin-instance's plug-in-specific configuration data set
12 Closing tag of the plugin-instance section.
13 Closing tag of the plugin section.
14 Closing tag of the plugins section.
15 Closing tag of the installer section.

With regard to implementing plug-ins, the following should be considered:
Plug-in Factory Classes
   Must extend com.probaris.sp.pluginPlugins
   Should implement methods to obtain instances of plug-in implementations as well as plug-in instances. Such methods should utilize functionality from com.probaris.sp.pluginPlugins.
Plug-in Implementation Classes
   Must extend com.probaris.sp.pluginPlugin
   Should implement methods to perform operations specific to the plug-in type.

Authentication plug-ins are an implementation of the plug-in architecture. The basics of this implementation include a plug-in factory class, AuthenticationPlugins (com.probaris.sp.authentication.AuthenticationPlugins), and an abstract class AuthenticationPlugin (com.probaris.sp.authentication.AuthenticationPlugin). AuthenticationPlugins is the factory class used to mange implementations and instances of authentication plug-ins. It provides methods to perform the following operations:
Install authentication plug-in implementation classes
Install authentication plug-in instances (configuration data associated with plug-in implementation classes)
Remove authentication plug-in implementation classes
Remove authentication plug-in instances (configuration data associated with plug-in implementation classes)
Get plug-in implementation instances (non-configured instances of plug-in implementation classes)
Get plug-in instance instances (configured instances of plug-in implementation classes)
Update plug-in instance configuration data
   Generic functionality to perform these operations is provided by the Plugins class.

AuthenticationPlugin is an abstract class extended by all authentication plug-in implementations. AuthenticationPlugin extends Plugin to enforce a standard interface and to provide functionality useful to all authentication plug-in implementations. Specific to authentication plug-in implementation classes, AuthenticationPlugin enforces the following interface:
public AuthenticationPluginResponse login(HttpServlet in_servlet, HttpServletRequest in_request) throws IOException, ServletException, AuthenticationPluginException
   Called by the authentication controller to perform authentication plug-in specific operations to allow a requesting user to authenticate. The implementing authentication plug-in returns an AuthenticationPluginResponse that indicates the result of the operation and any JSP the authentication controller must forward to.
public AuthenticationPluginResponse logout(HttpServlet in_servlet, HttpServletRequest in_request, User in_user) throws IOException, ServletException, AuthenticationPluginException
   Called by the authentication controller to perform authentication plug-in specific operations to allow a requesting user to logout. The implementing authentication plug-in returns an AuthenticationPluginResponse that indicates the result of the operation and any JSP the authentication controller must forward to.
public AuthenticationPluginResponse modify(HttpServlet in_servlet, HttpServletRequest in_request, User in_user, boolean in_is Administrative) throws IOException, ServletException, AuthenticationPluginException
   Called by the authentication controller to perform authentication plug-in specific operations to allow a requesting user to modify their credentials. The implementing authentication plug-in returns an AuthenticationPluginResponse that indicates the result of the operation and any JSP the authentication controller must forward to. Administrative users may modify authentication plug-in specific credentials in administrative mode. This mode is particular to the implementation of the authentication plug-in.
public AuthenticationPluginResponse register(HttpServlet in_servlet, HttpServletRequest in_request, User in_user, boolean in_is Administrative) throws IOException, ServletException, AuthenticationPluginException
   Called by the authentication controller to perform authentication plug-in specific operations to allow a requesting user to register. The implementing authentication plug-in returns an AuthenticationPluginResponse that indicates the result of the operation and any JSP the authentication controller must forward to.
public AuthenticationPluginResponse unregister(HttpServlet in_servlet, HttpServletRequest in_request, User in_user) throws IOException, ServletException, AuthenticationPluginException
   Called by the authentication controller to perform authentication plug-in specific operations to allow a requesting user to un-register. The implementing authentication plug-in returns an AuthenticationPluginResponse that indicates the result of the operation and any JSP the authentication controller must forward to.
public boolean importData(Long in_userId, String in_data) throwsAuthenticationPluginException
   Called to import data into this authentication plug-in as part of a batch/offline import process. It is expected that the supplied configuration data will be in some format acceptable by the plug-in. If any errors occur an AuthenticationPluginException will be to be thrown. The version of the method attempts to obtain a connection to the database using the connection pools singleton.
public boolean importData(Connection in_connection, Long in_userId, String in_data) throwsAuthenticationPluginException
   Called to import data into this authentication plug-in as part of a batch/offline import process. It is expected that the supplied configuration data will be in some format acceptable by the plug-in. If any errors occur an AuthenticationPluginException will be to be thrown.
public CredentialLocationDetails getCredentialLocationo
   Returns a CredentialLocationDetails object declaring the expected location of the credential. For example: Smart Card or Software Certificate Store. This information may be used to generate user interface facilities.
      To support the authentication plug-in model, several classes are used:
   AuthenticationPluginResponse
      (com.probaris.sp.authentication.AuthenticationPluginResponse)
   CredentialLocationDetails (com.probaris.sp.bean.CredentialLocationDetails)
   CertificateStoreDetails (com.probaris.sp.bean.CertificateStoreDetails)

AuthenticationPluginResponse provides a mechanism to encapsulate responses to requests on the plug-in. The calling mechanism is to interpret the data appropriately according to the invoked action that returned it. This class generally yields four different result types:
Success
   The action completed successfully
Canceled
   The action was canceled (by the requester)
Failed
   The action failed for expected or unexpected reasons
Redirect requested
   The action needs more information, so the infrastructure must redirect or forward the requestor to some specified location.

CredentialLocationDetails is an interface implemented by various classes used to declare to the infrastructure (and user interface) from where to obtain user credentials. There are no methods declared within the interface due to the potentially complex descriptions needed to properly identify credential locations. One implementation of this is the CertificateStoreDetails class. CertificateStoreDetails implements (or rather declares) the CredentialLocationDetails interface. Once the infrastructure determines what class is returned, it can use the encompassed information to generate the code necessary to obtain required data. CertificateStoreDetails is specifically used for the Signature authentication plug-in implementation class. Depending on the configuration of the implementation, the data contained within the CertificateStoreDetails instance will declared to the infrastructure that the user's certificate is to be obtained from a “Smart Card” or the local certificate store. In other instances, the returned CredentialLocationDetails may be null to declare that the infrastructure need not worry about where the user's credentials come from.

There are four actions each authentication plug-in implements:
Register
   Registers users so that they may authenticate using the specific authentication plug-in. Upon registering, an implementation-specific user credential entry is inserted into the database. This data is then used by the specific implementation to authenticate the user.
Unregister
   Removes users from the set of users able to authenticate using the specific authentication plug-in.
Modify
   Updates the implementation-specific credential data stored in the database (for the relevant user).
Login
   Attempts to authenticate the requesting user using the data supplied by the requester and credential data stored in the database. The implementation-specific logic is used to determine whether authentication is successful or not
Logout
   Attempts to log the authenticated user out. In most case there are no implementation-specific operations.

Each action must return a valid AuthenticationPluginResponse declaring the outcome of the action. If the action requires user input, the response object will instruct the infrastructure to redirect (or forward) the requestor to some URL. Generally this URL points to an implementation-specific user interface. There are no rules as to where the user may be redirect; however, as a convention, if the user interface is rendered using relevant JSPs, the location should be something like: <base URL>/authentication/<plug-in name>/<page>.

The default system installation has two authentication plug-in implementations: Password and Signature.

The default Password authentication plug-in implementation allows users to authenticate using their registered email address and a password. There is only one instance of this plug-in implementation and no configuration options are available. Therefore, the configuration dataset for this either empty or null.

If allowed, user may register or be registered to authenticate using the Password instance of the Password authentication plug-in. Upon registering, a password must be supplied that will be used for authentication. This password will be mangled before being stored in the database. The mangling process takes the plain text password pre-pended with two randomly generated seed characters and performs an MD5 hash function over it. The hashed value is then encoded using Base64 and pre-pended with the two random seed characters. The result is the key used to identify the credential.

Plain-text password: <password>
Randomly generated character: <c1>
Randomly generated character: <c2>
Hashed and seeded password: MD5 (<c1> + <c2> + <password>)
Credential Key: <c1> + <c2> + Base64 (<hashed and seeded password>)

This key is then used to authenticate the user during the authentication process.

Because the user's email address is a required piece of data during the process, it is used to find relevant set of credential data. This data, if found, will contain the previously generated key from which the two randomly generated seed characters may be obtained. The seed characters are then pre-pended to the supplied password and an MD5 hash function is applied to it. The result is compared with the stored credential key and if there is a match, the user is authenticated.

The following describes the implementation specifics for the authentication plug-ins.
Login
   Method Parameters
in_servet
   The HttpServlet controlling this request—this value is expected to be valid
in_request
   The HttpServletRequest containing the request parameters from the plug-in specific user interface—this value is expected to be valid
   Request Parameters
pw_action
   An indicator of the requested action—this value is used to determine how to process the request. Expected values are “login”, “cancel”, or null.
pw_userid
   The email address or user identifier for the user attempting to authenticate with the system—this value is to look up the user's credential key.
pw_password
   The plaintext password of the user attempting to authenticate with the system—an MD5 hashing algorithm is applied to this value and it is compared with the user's credential key.
   Outputs
      An AuthenticationPluginResponse declaring the outcome of the authentication attempt and any actions the controller should perform:
      Success
         The user successfully authenticated.
      Cancel
         The user canceled the authentication attempt.
      Redirect
         The implementation requests the controller to forward (or redirect) to the specific location. This will generally be to the implementation-specific login page.
   Details
If pw_action is equal to “login”, then the authentication attempt is processed. If it equals “cancel”, then a cancel notification is returned to the controller. Else, any other value indicates an authentication attempt is not being made so verification is skipped and control is directly forwarded to the login user interface (/WEB-INF/jsp/authentication/password/login.jsp).
Processing an authentication attempt is done as follows. The pw_userId value is used to obtain a list of UserCredential (com.probaris.sp.bean.UserCredential) objects relevant to this plug-in implementation. If any are returned, they are used to validate the pw_password value. The key of each UserCredential is matched to the value generated using the method described above (see Generating a Credential Key). If a match is found, the user's credentials are assumed to be valid and the authentication attempt is successful. However, if a match is not found, the authentication attempt fails and the user is forwarded to the login page with an error messaging declaring the failure.
Logout
   Method Parameters
in_servet
   The HttpServlet controlling this request—this value is expected to be valid
in_request
   The HttpServletRequest containing the request parameters from the plug-in specific user interface—this value is expected to be valid
in_user
   The authenticated User requesting to log out of the system
   Request Parameters
      None
   Outputs
      An AuthenticationPluginResponse declaring the outcome of the logout attempt and any actions the controller should perform—this value will always indicate a successful operation.
   Details
      Because no implementation-specific operation needs to be done, this method simply returns with a successful notification.
Register
   Method Parameters
in_servet
   The HttpServlet controlling this request—this value is expected to be valid
in_request
   The HttpServletRequest containing the request parameters from the plug-in specific user interface—this value is expected to be valid
in_user
   The User being registered for this authentication plug-in
in_is Administrative
   A Boolean flag indicating whether this operation is being performed within an administrative role
   Request Parameters
pw_action
   An indicator of the requested action—this value is used to determine how to process the request. Expected values are “register”, “cancel”, or null.
pw_new_password1
   The requested plaintext password—this value must be at least 4 characters long.
pw_new_password2
   The re-entered requested plaintext password—this value must match the value of
      pw_new_password1.
   Outputs
      An AuthenticationPluginResponse declaring the outcome of the authentication attempt and any actions the controller should perform:
      Success
         The user successfully registers.
      Cancel
         The user canceled the registration attempt.
      Redirect
         The implementation requests the controller to forward (or redirect) to the specific location. This will generally be to the implementation-specific registration page.
   Details
      If pw_action is equal to “register”, the registration attempt is processed. If it equals “cancel”, then a cancel notification is returned to the controller. Else, any other value indicates the registration attempt is not being made so verification is skipped and control is directly forwarded to the registration user interface (/WEB-INF/jsp/authentication/password/register.jsp).
      Processing a registration attempt is done as follows. The pw_new_password1 and pw_new_password2 values are compared for equality. If equal, pw_new_password1 is validated such that it is at least four characters long. If it validates, then an attempt is made to store the registration information (or user credentials) in the database. If any errors occur, the user will be redirected back to the registration form where the error message is displayed; else, a success code is sent back to the controller.
      Administrative roles and non-administrative roles display the same behavior.
Unregister
   Method Parameters
in_servet
   The HttpServlet controlling this request—this value is expected to be valid
in_request
   The HttpServletRequest containing the request parameters from the plug-in specific user interface—this value is expected to be valid
in_user
   The User being un-registered from this authentication plug-in Request Parameters
None
   Outputs
      An AuthenticationPluginResponse declaring the outcome of the un-register attempt and any actions the controller should perform:
      Success
         The user is successfully un-registered.
   Details

Given a user, that user is removed from the set of users allowed to authenticate using this authentication plug-in. Upon a successful call, the credentials associated with the specified user (relative to this authentication plug-in) will be removed from the database caused that user to no longer be able to authenticate using this authentication plug-in.
Modify
   Method Parameters
in_servet
   The HttpServlet controlling this request—this value is expected to be valid
in_request
   The HttpServletRequest containing the request parameters from the plug-in specific user interface—this value is expected to be valid
in_user
   The User being registered for this authentication plug-in
in_is Administrative
   A Boolean flag indicating whether this operation is being performed within an administrative role
   Request Parameters
pw_action
   An indicator of the requested action—this value is used to determine how to process the request. Expected values are “register”, “cancel”, or null.
pw_password
   The user's original plaintext password—this value must match the one stored within the user's credentials.
pw_new_password1
   The requested plaintext password—this value must be at least 4 characters long.
pw_new_password2
   The re-entered requested plaintext password—this value must match the value of
      pw_new_password1.
   Outputs
      An AuthenticationPluginResponse declaring the outcome of the modification attempt and any actions the controller should perform:
      Success
         The user successfully modified their credentials.
      Cancel
         The user canceled the modification attempt.
      Redirect
         The implementation requests the controller to forward (or redirect) to the specific location. This will generally be to the implementation-specific modification page.
   Details
If pw_action is equal to “modify”, the modification attempt is processed. If it equals “cancel”, then a cancel notification is returned to the controller. Else, any other value indicates the registration attempt is not being made so verification is skipped and control is directly forwarded to the modification user interface (/WEB-INF/jsp/authentication/password/modify.jsp).
Processing a modification attempt is done as follows. First the in_is Administrative is checked to see what mode to operate in. If in_is Administrative is true, then verification of knowledge of the original password is skipped. Else, the data from in_user is used to obtain a list of UserCredential objects relevant to this plug-in implementation. If any are returned, they are used to validate the pw_password value. The key of each UserCredential is matched to the value generated as describe above (see Generating a Credential Key). If a match is found, the user's credentials are assumed to be valid and the modification routine may continue. However, if a match is not found, the modification attempt fails and a forwarding request is returned to the controller requesting to give control to the modify page with an error messaging declaring the failure. If continuing, the pw_new_password1 and pw_new_password2 values are validated such that they match and are at least 4 characters long. If valid, the user's credential is updated.

The default Signature authentication plug-in implementation allows users to authenticate using a digital certificate that gets transferred to the system using a digital signature. By using a digital signature, the user's certificate may be sent to the server in a secure manner. This process is similar to the process in which the SSL infrastructure is able to obtain the client's digital certificate. However, by implementing a proprietary means to obtain the user's certificate, flexibility is gained in how the user is prompted and where the certificate comes from (i.e., Smart Card or Certificate Store).

In one embodiment, there are two types of Signature authentication plug-ins: Certificate and Smart Card. Both types work the same as far as the server is concerned; however, each force the client to choose a certificate from different locations. To configure the different instances of this plug-in implementation, configuration data must exist in the database. The configuration data for this particular implementation is embedded within an XML document that complies with the following DTD:

<!ELEMENT signature-authentication-dataset (action-time-out?,
certificate-store)>
<!ELEMENT action-time-out EMPTY>
<!ATTLIST action-time-out seconds CDATA #REQUIRED>
<!ELEMENT certificate-store EMPTY>
<!ATTLIST certificate-store location (1|2|3|4) #REQUIRED>
<!ATTLIST certificate-store name CDATA #REQUIRED>

As shown in the above DTD, the Signature authentication plug-in takes in two pieces of data: a time out (action-time-out) and a certificate store location (certificate-store).

The timeout value declares how long the server will allow between sending a challenge phrase and receiving a digital signature applied to that phrase. If the reply is within the timeout, the signature is considered to be valid and will be processed; else, the signature will be not be trusted (a possible replay attack) and therefore processing will be halted. If not supplied, the default value is 30 seconds.

The certificate store location declares from which certificate store to allow a user to choose certificates and signing keys. This data is generally used to differentiate the different Signature plug-in instances. The certificate store is defined using a location value and a name. The location value maps to the different certificate store locations (available on a Microsoft Windows machine). The locations are defined as follows:
1=Local machine store
   The global certificate store on the local (client) machine
2=Current user store
   The user's certificate store on the local (client) machine
3=Active Directory store
   Some Active Directory server
4=Smart Card store
   A Smart Card store connected to the local (client) machine (i.e., ActivCard)

The name value indicates the name of the certificate store to use. Generally this value is either empty or “MY”. “MY” is used to declare the user's certificate store rather than the certificate authority certificate store (“CA”). For Smart Cards, this value may be irrelevant; therefore, an empty value will suffice.

Using the above configuration options, it is possible to create several Signature plug-in instances, although the examples discussed herein relate to certificates and SmartCards.

The configuration for the “Certificate” instance of the Signature plug-in implementation declares the certificate store to be the user's certificate store on their local machine. The complete configuration data is as follows:

<?xml version=‘1.0’ encoding=‘utf-8’?>
<!DOCTYPE signature-authentication-dataset [

<!ELEMENT signature-authentication-dataset (action-time-out?,
certificate-store)>
<!ELEMENT action-time-out EMPTY>
<!ATTLIST action-time-out seconds CDATA #REQUIRED>
<!ELEMENT certificate-store EMPTY>
<!ATTLIST certificate-store location (1|2|3|4) #REQUIRED>
<!ATTLIST certificate-store name CDATA #REQUIRED>]>

<signature-authentication-dataset>

```
  <action-time-out seconds=“30” />
  <certificate-store location=“2” name=“MY” />
```

</signature-authentication-dataset>

The configuration for the “Smart Card” instance of the Signature plug-in implementation declares the certificate store to be a Smart Card connected to the user's local machine. The complete configuration data is as follows:

<?xml version=‘1.0’ encoding=‘utf-8’?>
<!DOCTYPE signature-authentication-dataset [

<!ELEMENT signature-authentication-dataset (action-time-out?,
certificate-store)>
<!ELEMENT action-time-out EMPTY>
<!ATTLIST action-time-out seconds CDATA #REQUIRED>
<!ELEMENT certificate-store EMPTY>
<!ATTLIST certificate-store location (1|2|3|4) #REQUIRED>
<!ATTLIST certificate-store name CDATA #REQUIRED>]>

<signature-authentication-dataset>

```
  <action-time-out seconds=“30” />
  <certificate-store location=“4” name=“ ” />
```

</signature-authentication-dataset>

From the user's point of view, the different Signature plug-in implementation instances appear different. The “Certificate” instance asks the user to choose a certificate from their software certificate store and the “Smart Card” asks them to choose from their Smart Card. Due to browser implementations, the user may or may not be asked to choose a certificate when a single certificate is available in the requested certificate store. From the server's (or the plug-in) point of view, no matter which store the user's certificate is pulled from, processing will be the same.

In order to perform the register, modify or login operation on this implementation, the user's certificate (and public key) must be obtained. Typically, web applications that require the user's certificate use SSL and turn on its client authentication functionality. Due to the closed nature of this mechanism, the plug-in is not able to declare the certificate store or clear the certificate from the request (useful for logging out or changing certificates). Therefore, using the mechanism of digital signatures, it is possible to securely obtain the user's certificate while maintaining the ability to control the environment.

To implement this, the plug-in generates a challenge phrase that is sent to the client so that the user may digitally sign it. This challenge phrase contains the following pieces of data concatenated by “:”:
Current timestamp (milliseconds since Jan. 1, 1970, 00:00:00 GMT)
Random number
Additional information
For example: <TIMESTAMP>:<RND>[:<additional data>]

Depending on the action being performed, the <additional data> may be necessary. For authentication and registration, this piece of information is left out. However, for modifying (or changing) certificates, this value indicates which stage of the modification process is executing.

This challenge is then signed by the plug-in using the private key from a short-lived key pair generated by the plug-in each time it is initialized. Because the challenge is sent to the client in plain text and no protected copy of it is stored by the plug-in, it is necessary to verify that the client does not alter the challenge or even attempt to make up a challenge in an attempt to gain access to the system using a replay attack.

The challenge and the signature of the challenge are then sent to the client. Using a certificate chosen from a certificate store (explained above), the client digitally signs the challenge and sends all three (challenge, signature of the challenge with plug-in's key, and signature of the challenge with the client key) back to the plug-in.

At this point, the plug-in verifies that the challenge is valid by testing it against the signature of it using the plug-in's key. If the challenge verifies, then processing continues; else it stops and the action fails. If continuing, the timestamp from the challenge is parsed and compared with the current time, if the difference between them is greater than the configured timeout value (default is 30 seconds), the transaction is deemed un-trusted and the action fails. However, if the difference falls within the timeout, the signature of the challenge using the client's key is then verified. If valid, the signing certificate is obtained and used to complete the action being performed by the plug-in.

The following provides the implementation specifics:
Login
   Method Parameters
in_servet
   The HttpServlet controlling this request—this value is expected to be valid
in_request
   The HttpServletRequest containing the request parameters from the plug-in specific user interface—this value is expected to be valid
   Request Parameters
sig_action
   An indicator of the requested action. This value is used to determine how to process the request. Expected values are “login”, “cancel”, or null.
sig_pkcs7
   A PKCS#7 envelope containing the digital signature (and certificate) of the user attempting to authenticate
sig_token
   The plaintext challenge token used to verify that the user is submitting a legitimate authentication attempt as well being the piece of data that signed. The client's signature of this token is stored in sig_pkcs7 and the server's signature of this token is stored in sig_serverSignedToken. The value of this token is generated on the server, sent to the client, and then returned back to the server for verification.
sig_serverSignedToken
   The server's signature of the challenge token stored in sig_token. This signature is use to verify that the challenge token was not altered by the client.
   Outputs
      An AuthenticationPluginResponse declaring the outcome of the authentication attempt and any actions the controller should perform:
      Success
         The user successfully authenticated.
      Cancel
         The user canceled the authentication attempt.
      Redirect
         The implementation requests the controller to forward (or redirect) to the specific location. This will generally be to the implementation-specific login page.
   Request Parameter Outputs
sig_pageTitle
   The title of the page to display depending on the stage of the process.
sig_pageAction
   The URL of the action to use when submitting the authentication request form. This value will change depending on the stage of the process.
sig_pageActionLabel
   The display name of the action to use on the submit button on the authentication request form. This value will change depending on the stage of the process.
sig_pageActionName
   The value of the action to use on the submit button on the authentication request form. This value will change depending on the stage of the process.
sig_pageSubTitle
   The page subtitle to display relative to the stage of the process.
sig_token
   The server generated challenge token to be signed by the user.
sig_serverSignedToken
   The signature of the server generated challenge token to be signed by the user.
sig_certStoreLocation
   The certificate store location value to use to force the appropriate interface.
sig_certStoreName
   The certificate store name value to use to force the appropriate interface.
   Details
If sig₁₃ action is equal to “login”, then the authentication attempt is processed. If it equals “cancel”, then a cancel notification is returned to the controller. Else, any other value indicates an authentication attempt is not being made so verification is skipped and control is directly forwarded to the certificate retrieval user interface (/WEB-INF/jsp/authentication/signature/getCertificate.jsp).
Processing an authentication attempt is done as follows. The sig_token, pw_serverSignedToken, and pw_pkcs7 values are retrieved. First, the value of sig_token is validated using the value of pw_serverSignedToken. If not validated, an error message is returned to the user. If validated, then the user's X.509 certificate is parsed from the sig₁₃ pkcs7 value and the user identifier for that user is found. If the digital signature is not valid, or a user is not found, an error is returned; else the use is authenticated and processing continues.
Logout
   Method Parameters
in_servet
   The HttpServlet controlling this request—this value is expected to be valid
in_request
   The HttpServletRequest containing the request parameters from the plug-in specific user interface—this value is expected to be valid
in_user
   The authenticated User requesting to log out of the system
   Request Parameters
   None
   Outputs
      An AuthenticationPluginResponse declaring the outcome of the logout attempt and any actions the controller should perform—this value will always indicate a successful operation.
   Details
      Because no implementation-specific operation needs to be done, this method simply returns with a successful notification.
Register
   Method Parameters
in_servet
   The HttpServlet controlling this request—this value is expected to be valid
in_request
   The HttpServletRequest containing the request parameters from the plug-in specific user interface—this value is expected to be valid
in_user
   The User being registered for this authentication plug-in
in_is Administrative
   A Boolean flag indicating whether this operation is being performed within an administrative role
   Request Parameters
sig_action
   An indicator of the requested action. This value is used to determine how to process the request. Expected values are “register”, “cancel”, or null.
sig_pkcs7
   A PKCS#7 envelope containing the digital signature (and certificate) of the user attempting to register.
sig_token
   The plaintext challenge token used to verify that the user is submitting a legitimate registration attempt as well being the piece of data that signed. The client's signature of this token is stored in sig_pkcs7 and the server's signature of this token is stored in sig_serverSignedToken. The value of this token is generated on the server, sent to the client, and then returned back to the server for verification.
sig_serverSignedToken
   The server's signature of the challenge token stored in sig_token. This signature is use to verify that the challenge token was not altered by the client.
   Outputs
      An AuthenticationPluginResponse declaring the outcome of the authentication attempt and any actions the controller should perform:
      Success
         The user successfully registers.
      Cancel
         The user canceled the registration attempt.
      Redirect
         The implementation requests the controller to forward (or redirect) to the specific location. This will generally be to the implementation-specific registration page.
   Request Parameter Outputs
sig_pageTitle
   The title of the page to display depending on the stage of the registration process.
sig_pageAction
   The URL of the action to use when submitting the registration request form. This value will change depending on the stage of the process.
sig_pageActionLabel
   The display name of the action to use on the submit button on the registration request form. This value will change depending on the stage of the process.
sig_pageActionName
   The value of the action to use on the submit button on the registration request form. This value will change depending on the stage of the process.
sig_pageSubTitle
   The page subtitle to display relative to the stage of the process.
sig_token
   The server generated challenge token to be signed by the user.
sig_serverSignedToken
   The signature of the server generated challenge token to be signed by the user.
sig_certStoreLocation
   The certificate store location value to use to force the appropriate interface.
sig_certStoreName
   The certificate store name value to use to force the appropriate interface.
   Details
      If sig_action is equal to “register”, the registration attempt is processed. If it equals “cancel”, then a cancel notification is returned to the controller. Else, any other value indicates the registration attempt is not being made so verification is skipped and control is forwarded to the registration user interface (/WEB-INF/jsp/authentication/signature/getCertificate.jsp) after generating the challenge token and signature of it.
      Processing a registration attempt is done as follows. The sig_token, sig_serverSignedToken, and sig_pkcs7 values are retrieved. First, the value of sig_token is validated using the value of sig_serverSignedToken. If not validated, an error message is returned to the user. If validated, then the user's X.509 certificate is parsed from the sig_pkcs7. The users certificate is then stored in the database.
      There is not behavior associated with the administrative role for this method. To register a user using this plug-in in an administrative mode requires the use of the command-line utility.
Unregister
   Method Parameters
in_servet
   The HttpServlet controlling this request—this value is expected to be valid
in_request
   The HttpServletRequest containing the request parameters from the plug-in specific user interface—this value is expected to be valid
in_user
   The User being un-registered from this authentication plug-in Request Parameters
None
   Outputs
      An AuthenticationPluginResponse declaring the outcome of the un-register attempt and any actions the controller should perform:
      Success
         The user is successfully un-registered.
   Details
      Given a user, that user is removed from the set of users allowed to authenticate using this authentication plug-in. Upon a successful call, the credentials associated with the specified user (relative to this authentication plug-in) will be removed from the database caused that user to no longer be able to authenticate using this authentication plug-in.
Modify
   Method Parameters
in_servet
   The HttpServlet controlling this request—this value is expected to be valid
in_request
   The HttpServletRequest containing the request parameters from the plug-in specific user interface—this value is expected to be valid
in_user
   The User being registered for this authentication plug-in
in_is Administrative
   A Boolean flag indicating whether this operation is being performed within an administrative role
   Request Parameters
sig_action
   An indicator of the requested action. This value is used to determine how to process the request. Expected values are “modify”, “modify_stage1”, “modify stage2”, “cancel”, or null.
sig_pkcs7
   A PKCS#7 envelope containing the digital signature (and certificate) of the user.
sig_token
   The plaintext challenge token used to verify that the user is submitting a legitimate registration attempt as well being the piece of data that signed. The client's signature of this token is stored in sig_pkcs7 and the server's signature of this token is stored in sig_serverSignedToken. The value of this token is generated on the server, sent to the client, and then returned back to the server for verification.
sig_serverSignedToken
   The server's signature of the challenge token stored in sig_token. This signature is use to verify that the challenge token was not altered by the client.
   Outputs
      An AuthenticationPluginResponse declaring the outcome of the modification attempt and any actions the controller should perform:
      Success
         The user successfully modified their credentials.
      Cancel
         The user canceled the modification attempt.
      Redirect
         The implementation requests the controller to forward (or redirect) to the specific location. This will generally be to the implementation-specific modification page.
   Request Parameter Outputs
sig_pageTitle
   The title of the page to display depending on the stage of the process.
sig_pageAction
   The URL of the action to use when submitting the certificate retrieval form. This value will change depending on the stage of the process.
sig_pageActionLabel
   The display name of the action to use on the submit button on the certificate retrieval form. This value will change depending on the stage of the process.
sig_pageActionName
   The value of the action to use on the submit button on the certificate retrieval form. This value will change depending on the stage of the process.
sig_pageSubTitle
   The page subtitle to display relative to the stage of the process.
sig_token
   The server generated challenge token to be signed by the user.
sig_serverSignedToken
   The signature of the server generated challenge token to be signed by the user.
sig_certStoreLocation
   The certificate store location value to use to force the appropriate interface.
sig_certStoreName
   The certificate store name value to use to force the appropriate interface.
   Details
      If sig_action is equal to “modify”, “modify_stage1”, or “modify_stage2” the modification attempt is processed. If it equals “cancel”, then a cancel notification is returned to the controller. Else, any other value indicates the modification attempt is not being made so processing is skipped and control is directly forwarded to the modification instructions user interface (/WEB-INF/jsp/authentication/signature modifyInstructions.jsp).
      Processing a modification attempt is done as follows. First the in_is Administrative is checked to see what mode to operate in. If in_is Administrative is true, then the user is shown an error page described that administrative functions may only be done using the command-line utility. Else, processing continues.

There are three stages of the verification process:
1) Initialization
2) Authentication
3) Modification

In the initialization stage, the challenge token is created using the current time, a random number, and an indicator that the next stage is authentication. This information is sent to the client and the user's current authentication certificate is requested. Once submitted to the server, the authentication stage starts and the user is authenticated as they are in the login process. This process includes verification of the challenge token using the server's signature of it, verification of the user's certificate by validating the user's signature of the challenge token, and then matching the MD5 hash of the user's certificate with one that is stored in the database. If authenticated, the user may continue to the modification stage, else an error message is displayed and the user is prevented from continuing. If continuing, another challenge token is created using the current time, a random number, and an indicator that the next stage is modification. This information is sent to the client and the user's new authentication certificate is requested. Once submitted to the server, the modification stage starts and the user certificate is retrieved. This process includes verification of the challenge token using the server's signature of it and verification of the user's certificate by validating the user's signature of the challenge token. If the new certificate is properly obtained, it is then stored in the database as the user credentials.

Data Capture, Reporting and Auditing

The present invention includes a variety of features for data capture, reporting, and auditing of forms data.

Data Capture and Data Export

Upon saving or routing of a form in accordance with the present invention, its data contents are captured in the database. The database can reside in highly secure areas of the corporate network, behind, if desired, multiple firewalls (see architecture described with reference to FIGS. 1, 2 and 3). Once captured, the data can be carefully managed for data security and backed up frequently. Because the forms are logically rather than physically routed, and data never leaves the server, users gain edit or view access via secure, encrypted links to a single section of a single instance of a form only after such users are explicitly authorized.

Once captured, form data is immediately available for other purposes, including: (1) display to process participants and others with viewing rights to the form; (2) status reporting; (3) routing decisions (based on routing behavior plugins); (4) transfer decisions by robot accounts; (5) data integration with legacy applications in the enterprise via a web services API; and (6) export to application data files under the control of authorized users. Thus, data never needs to be re-keyed and, because data is always centrally maintained, a form can never be “lost”. For auditing purposes, a form instance, once created, cannot be deleted except by an administrator.

Status Reporting

Because forms are logically routed, and data always resides in the central database server, status reporting is up to date and accurate. A key benefit to organizations is that managing a business process requires less labor by administrators and managers, and is completed more quickly.

User Reporting

Any user with authorized access can determine where a process stands by referring to his or her “In-Process” folder. Users can also drill down to view more detailed information about process status. A complete routing history of the form is available. The latest form contents can be viewed, including newly completed sections of the form.

Management Reporting

The present invention allows for a range of management reporting facilities for enterprise managers and process owners. Enterprise managers can receive a variety of management reports, pertaining to users, usage, and form volumes in the system. They can also receive exception reports of different kinds (e.g., forms that have waited more than 30 days in any stage for processing).

Users in the system can be designated “Process Managers” for specific forms. Process managers can track all instances of the forms for which they have responsibility at any stage. This is useful, for example, to forecast up-coming workloads. Process managers also have access for the complete data contents of all finalized forms, and can easily export data to desktop application files including Excel, Access, and comma delimited text files.

Detailed Access Logs

Because form access is logical, rather than physical, and always flows through the database, the system is in a position to log complete records of every access to form data. A complete record is maintained of userid and date/time stamps for every kind of data access and form transaction, including: viewing form data; editing form data; rendering a PDF image of a form for printing; routing a form (including transfers, withdrawals, suspensions, finalizations); copying forms; sending blank forms; sending for review or edit; revision and comment history.

Revision and Comment History

The current state of form data is saved whenever a form is routed. This data is preserved in the database in its original state, even if the form section is later modified. Similarly, comments can be sent between senders and recipients with every routing transaction. Users can access both revision and comment histories by drilling down from the routing history of the form. Thus, using access logs, routing history, and comment history organizations can preserver a comprehensive record of their business processes managed in accordance with the present invention.

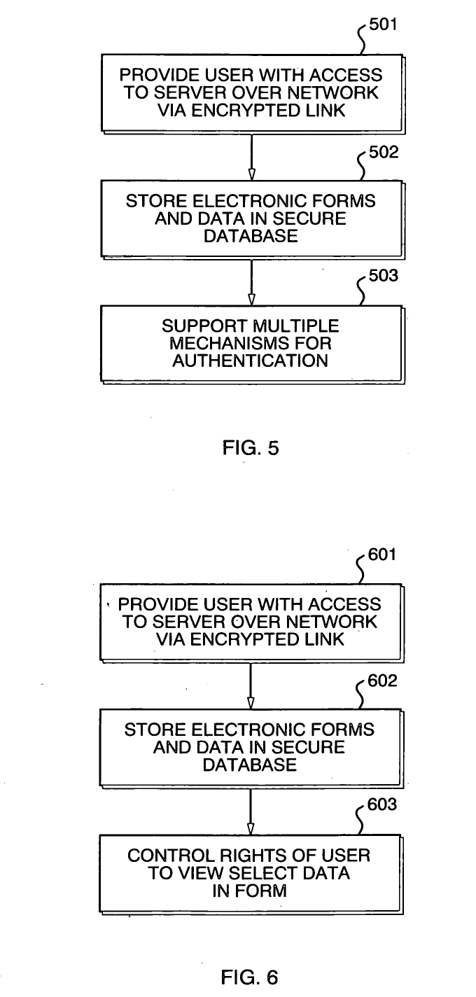

FIGS. 5 through 11 are flow charts illustrating preferred embodiments of methods of the present invention.

With reference to FIG. 5, a method for routing an electronic form is illustrated. The electronic form comprises at least two sections, at least one of the sections comprising at least one data field for receiving data input by one or more users. In step 501, the users are provided with access to a front-end server over a network via an encrypted link. In step 502, the electronic forms and the data are stored in a secure back-end database. In step 503, multiple mechanisms are supported for allowing the user to authenticate to the front-end server.

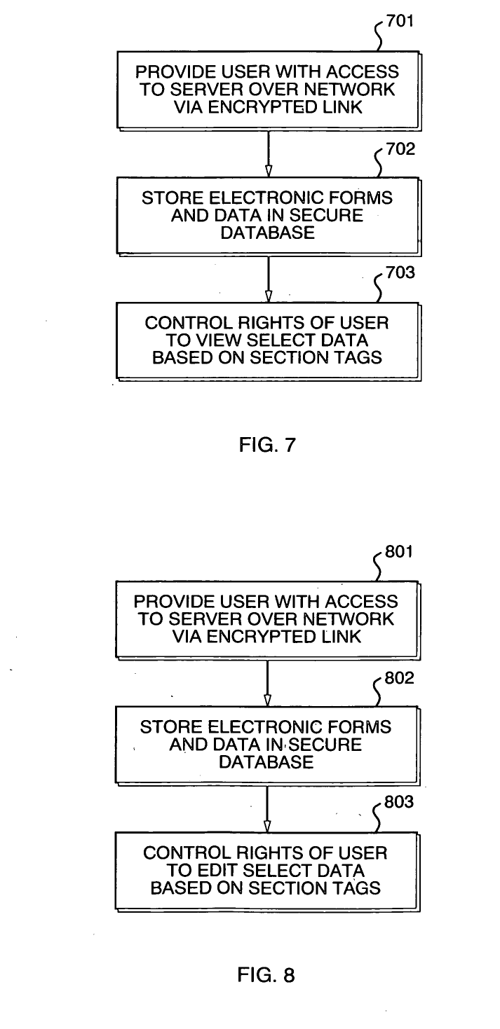

With reference to FIG. 6, a method for routing an electronic form is illustrated. The electronic form comprises at least two sections, at least one of the sections comprising at least one data field for receiving data input by one or more users. In step 601, the users are provided with access to a front-end server over a network via an encrypted link. In step 602, the electronic forms and the data are stored in a secure back-end database. In step 603, rights of the user to view select data in the electronic form are controlled by the server, wherein an electronic signature is applied to one or more of the sections that include the select data.

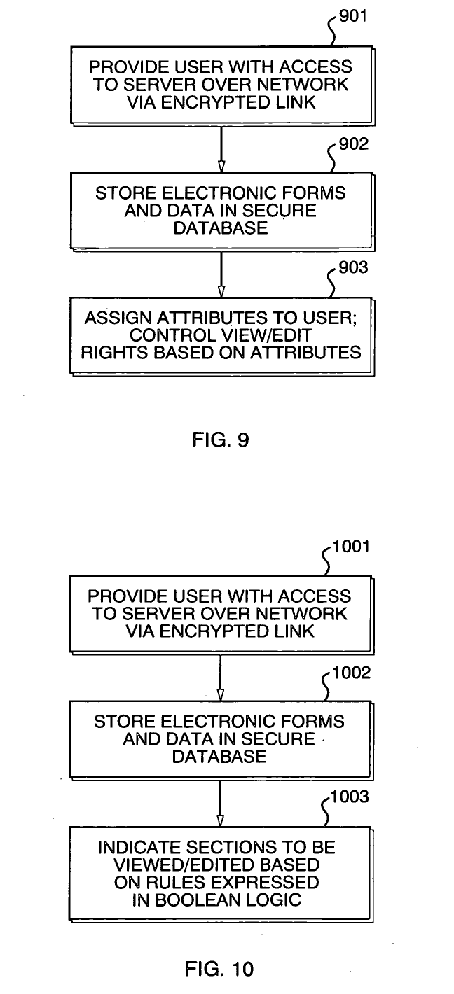

With reference to FIG. 7, a method for routing an electronic form is illustrated. The electronic form comprises multiple sections, wherein the sections are indicated by tags and at least one of the sections comprises at least one data field for receiving data input by one or more users. In step 701, the users are provided with access to a front-end server over a network via an encrypted link. In step 702, the electronic forms and the data are stored in a secure back-end database. In step 703, rights of the user to view select data in the electronic form are controlled by the server based on the section tags.

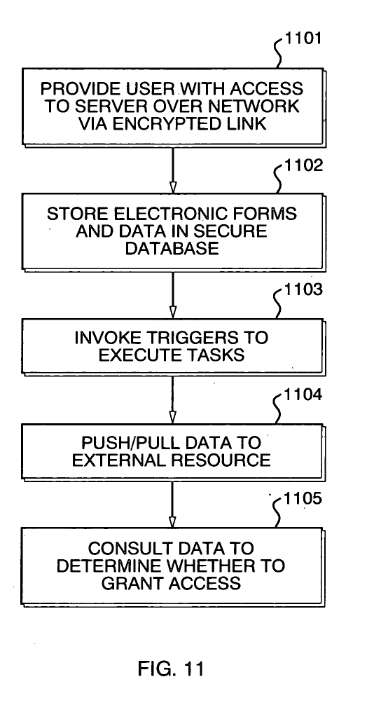

With reference to FIG. 8, a method for routing an electronic form is illustrated. The electronic form comprises multiple sections, wherein the sections are indicated by tags and at least one of the sections comprises at least one data field for receiving data input by one or more users. In step 801, the users are provided with access to a front-end server over a network via an encrypted link. In step 802, the electronic forms and the data are stored in a secure back-end database. In step 803, rights of the user to edit at least one of select sections and select data in the electronic form are controlled by the server based on the section tags.

With reference to FIG. 9, a method for routing an electronic form is illustrated. The electronic form comprises at least two sections, wherein the sections are indicated by tags and at least one of the sections comprises at least one data field for receiving data input by one or more users. In step 901, the users are provided with access to a front-end server over a network via an encrypted link. In step 902, the electronic forms and the data are stored in a secure back-end database. In step 903, attributes are assigned to the users wherein a form creator indicates, using one or more of the tags, which of the sections of the form can be viewed or edited by the users based on the attributes assigned to the users.

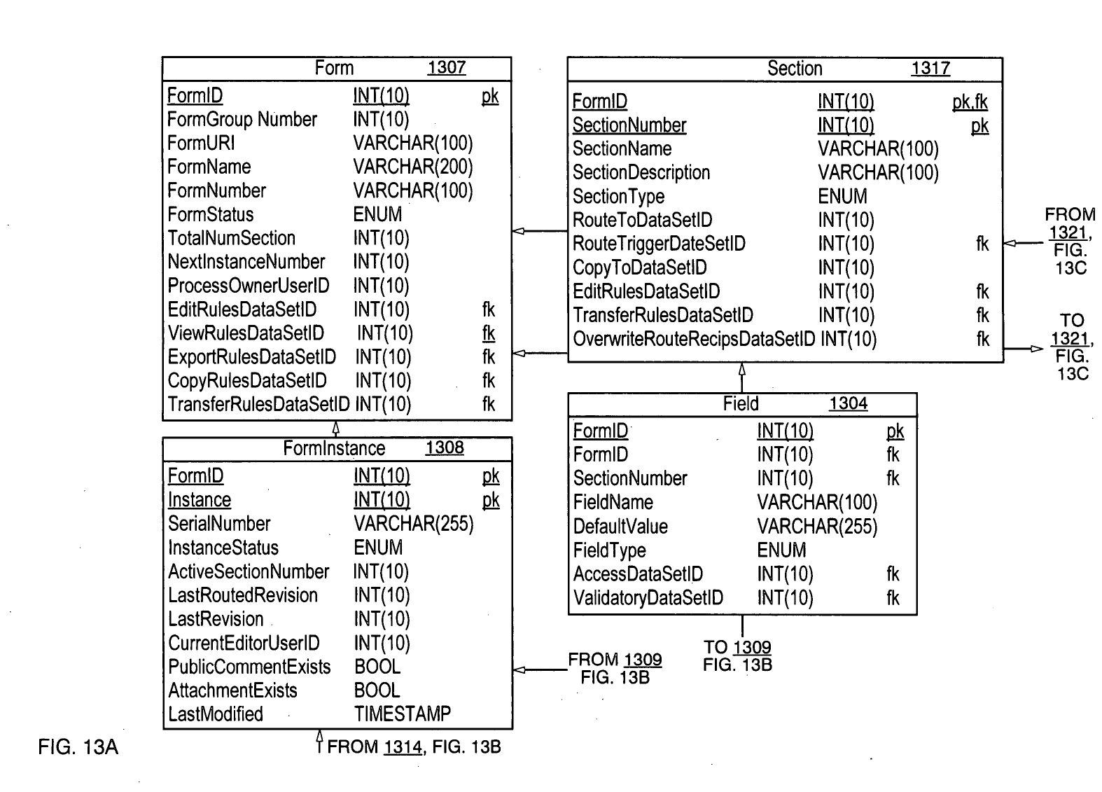

With reference to FIG. 10, a method for routing an electronic form is illustrated. The electronic form comprises at least two sections, wherein the sections are indicated by tags and at least one of the sections comprises at least one data field for receiving data input by one or more users. In step 1001, the users are provided with access to a front-end server over a network via an encrypted link. In step 1002, the electronic forms and the data are stored in a secure back-end database. In step 1003, a form creator indicates, using one or more of the tags, which of the sections of the form can be viewed or edited by the users based on rules expressed in boolean logic.

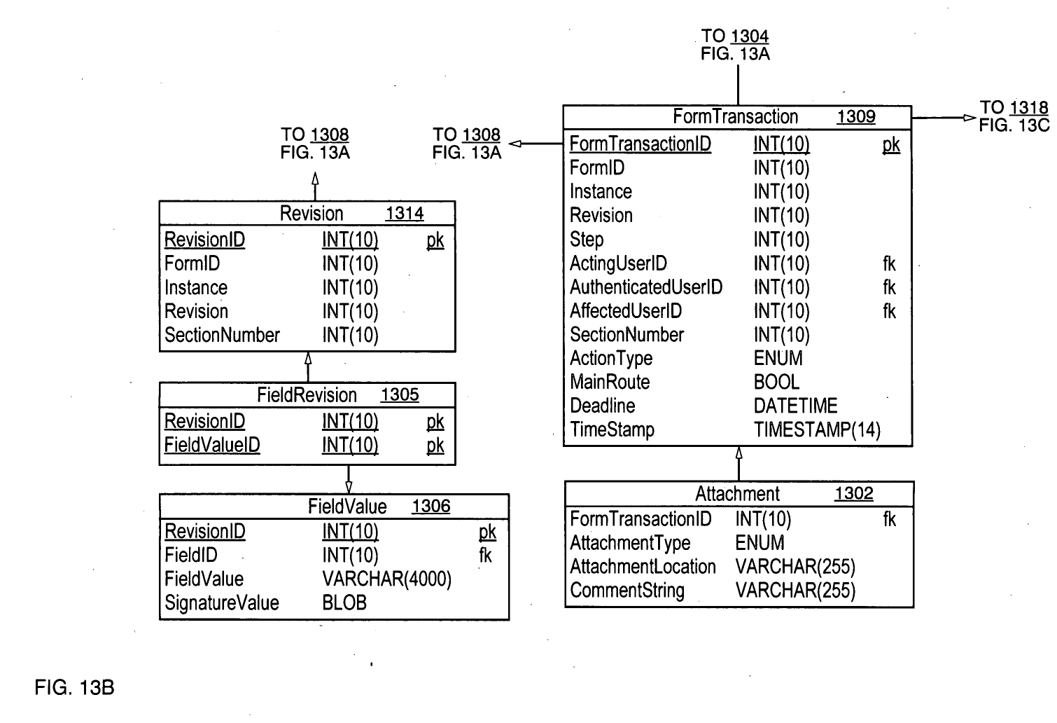

With reference to FIG. 11, a method for routing an electronic form is illustrated. The electronic form comprises at least two sections, at least one of the sections comprising at least one data field for receiving data input by one or more users. In step 1101, the users are provided with access to a front-end server over a network via an encrypted link. In step 1102, the electronic forms and the data are stored in a secure back-end database. In step 1103, one or more triggers are invoked to execute a set of one or more tasks upon the user inputting the data into one of the electronic forms and routing the form. In one embodiment, the one or more tasks comprise at least one of pushing the data to an external resource and pulling additional data from an external resource, in step 1104. In another embodiment, in step 1105, the data stored in the external resource is consulted to determine whether to grant a second user with access to a physical location.

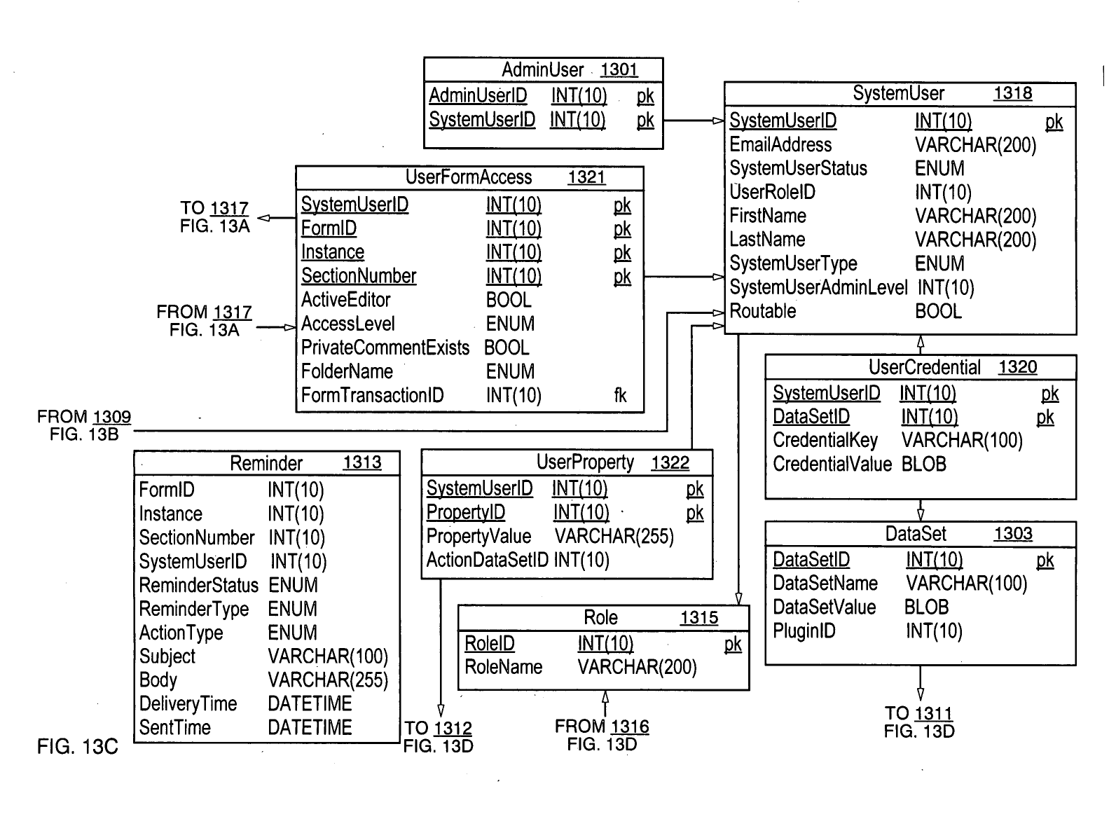

An exemplary use case of the method described with reference to FIG. 11 is illustrated with reference to FIG. 12, which is a variation of FIG. 2 described previously. Other use cases will be known to those skilled in the art and are within the scope of the present invention. In step 1201, user 1 invites a user 2 to a meeting held within a protected facility 1200, such that only users who can present appropriate credentials may enter. The invitation is made by user 1 using a form built in accordance with the present invention. In particular, user 1 originates a specialized visitor request form, filling in the appropriate information, such as the identity of user 2 and of facility 1200. User 1 then routes the form to user 2. User 2 receives the form and fills in the appropriate section that contains details about the user and any relevant credentials. User 2 submits the form back to user 1. User 1 verifies the information submitted by user 2 and finalizes the form (i.e., validates the credentials of user 2). In step 1202, the information submitted by way of the form is stored in the database 201 upon finalization. In step 1203, the finalization action triggers the inventive system to transfer data in the database 201 (in this case, information that will allow user 2 to access facility 1200) to physical access system 1205, where it is stored in database 1206. When user 2 attempts to access the facility 1200 for the meeting, in step 1204, the physical access system 1205 is consulted to determine if the credentials of user 2 imply authorization to access the front door of the facility 1200. Upon finding the appropriate record in its database 1206, physical access system 1205 allows user 2 to open the door to the facility 1200.

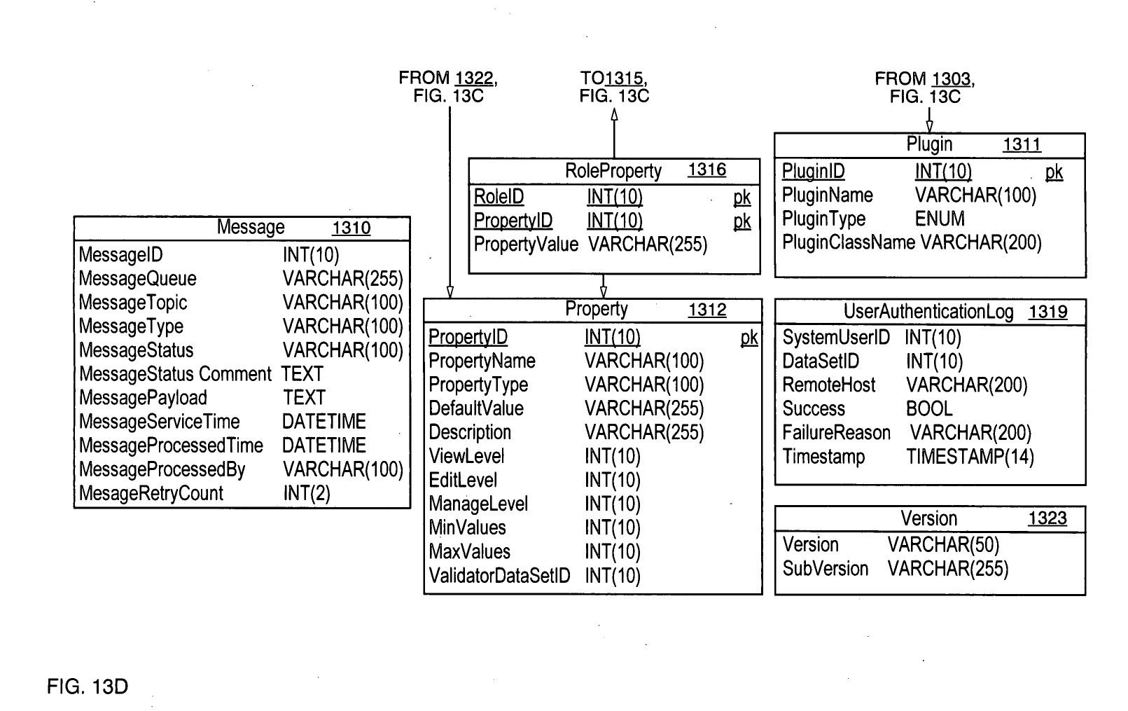

FIGS. 13a and 13b depict an exemplary database schema that may be used in connection with a one embodiment of the present invention.

The AdminUser table 103 maintains a mapping of which users are able to manage (or impersonate) other users of the system. This is typically used in the case of users that are of the type “Robot User”, where some “Normal” user, identified by its internally unique identifier (AdminUserID) may be able to manager zero or more “Robot” users.

Each form may contain one or more attachments in the form of a comment or a file. The Attachment table 1302 maintains such information. Each attachment is associated with a particular revision of a form instance using a unique transaction identifier (TransactionID).

The DataSet table 1303 contains configuration data for various features of the present invention. Most of the configuration data stored in this table (in the DataSetValue field) is in the form of XML documents; however, this is not enforced. Example of data sets that are stored in this table include plug-in instance configuration data and authentication rule sets.

Each section of a form has zero or more fields. These fields are declared in the Fields table 1304. Each field is associated with a particular section of a particular form using the internal unique form identifier (FormID) and the internal relative section identifier (SectionNumber). All fields must have a name and type and may, optionally, have a default value. To determine the authorization a user has to view the contents of a particular field, the AccessDataSetID may reference a rule set that can be used.

The FieldRevision table 1305 is used to map a field and its corresponding data to a revision of a form instance. The FieldValue table 1306 contains the value for each unique field. A field is identified within the Field table 1304, and a unique instance of a particular field is identified using the FieldRevision table 1305, which maps a field and its value to a particular instance of a form.

The forms installed in the inventive system are described in the Form table 1307. Each form has a unique internal identifier (FormID), as well as a unique external identifier (FormURI). The external identifier is required to be a URI, in the preferred embodiment. Optionally, each form may have rules assigned to determine authorization to perform certain tasks on that form. The following rule sets are defined in this table: edit, view, copy, transfer, and export.

Each form may have zero or more instances associated with it. Those instances are described in the FormInstance table 1308. Each form instance is associated with a form via the form's internal unique identifier (FormID). Each form instance is distinguished from other instances of the same form using a form instance number, which is unique only for instances of a given form. A form instance's serial number should be unique across all instances of a given form.

Transactions on a form are recorded in the FormTransaction table 1309. Using the form's unique internal identifier (FormID), the form instances identifier (Instance) and the form instance's revision number (Revision), a transaction can be mapped to the particular revision of a form instance. Along with the revision of a form instance, all transactions records declare an acting user, the action taken by that user, and optionally an affected section and/or an affected user.

Messages queued to be processed by the message queue of the inventive system are stored in the Message table 1310. Each message is given a queue name that declares what queue should process it. Also, a topic name is given to allow a queue processor to determine if it can process that type of message. The payload of each message is generally in an XML document stored in the Payload column of this table.

Each plug-in installed in connection with the system must be defined in the Plugin table 1311. This table contains the class location, name, and type of a particular plug-in. The DataSet table is then referenced to declare configuration data for each plug-in, declaring a “plug-in instance”.

The Property table 1312 contains the definition of properties for use within the inventive system. Some properties are to be associated with user profiles and some with roles. Each property has at least a name and a declaration of what set it belongs to, user or role (PropertyType). Optionally, a property may declare a default value and a plug-in that can be used to validate the value a user might set for the property. Authorization to view, edit, and manager a particular property are declared in the ViewLevel, EditLevel, and ManageLevel fields where the acting user must have the appropriate administrative level to be authorized.

Reminders may be set up when a section of a form is routed to another user and stored in the Reminder table 1313. Each reminder is associated with a relevant section of some form instance using the form's unique internal identifier (FormID), the form instances identifier (Instance) and the relative section number (SectionNumber).

Each instance of a given form may have zero or more revisions, those revisions are maintained in the Revision table 1314. Each form instance revision is associated with a form and a form instance using the internal unique identifier of a form and the form instances relatively unique instance identifier.

Each user of the inventive system must be assigned a role from the set of roles, which are stored in the Role table 1315. Each role has a name and an associated set of properties (stored in the RoleProperty table) that make up its privileges. The privileges granted to a user assigned to a particular role are defined in the RoleProperty table 1316. This table declares values for role properties by mapping a role, using a unique role identifier (RoleID), to a property, using a unique property identifier (PropertyID).

The sections of each form are described in the Section table 1317. Each section is associated with a form using the form's internal unique identifier; and each section related to a given form is uniquely identified using the SectionNumber column, which is the section's order number in the form. Each section has a descriptive name and a set of rules that are used to determine a user's authorization to functions on that section. The following rule sets are defined in this table: copy, edit, transfer, and overwrite route recipients. Each section may or may not declare a route behavior plug-in to be used to determine how to route the form (RouteToDataSetID) and a route trigger plug-in to be used to trigger events when the section is routed (RouteTriggerDataSetID).

All users of the system are declared in the SystemUser table 1318. Each user must have a unique email address (EmailAddress) and a unique internal identifier (SystemUserID). Also, each user is assigned a role (declared in the Role table), a type (“normal”, “robot”, “anonymous”), and an administrative level.

Each attempt to authenticate to the system will be logged within the UserAuthenticationLog table 1319. Due to the nature of the data collected during the authentication process, not all fields for each record will be filled in.

The UserCredential table 1320 contains credential information for use by authentication plug-ins. Each user credential record is associated with a user (via SystemUserID) and a particular authentication plug-in instance (DataSetID). The CredentialKey and CredentialValue fields are formatted specifically for the relative authentication plug-in implementation.

Access to each form instance by a particular user is maintained by the UserFormAccess table 1321. Access is determined at the granularity of a form instance's section for a given user.

A user of the system may have zero or more properties which make up their “user profile”. The UserProperty table 1322 contains values for each user property and is associated with a Property, using the property's unique identifier (PropertyID), and a particular SP user (SystemUserID).

The Version table 1323 is used for documentation purposes; it declares the version number for the database schema.

1. An electronic form routing system, the electronic form comprising at least two sections, at least one of the sections comprising at least one data field for receiving data input by one or more users, the system comprising:
a front-end server accessible to the users over a network via an encrypted link; and
a secure back-end database for storing the electronic forms and the data;
wherein the system supports multiple mechanisms for allowing the user to authenticate to the front-end server.

2. An electronic form routing system, the electronic form comprising at least two sections, at least one of the sections comprising at least one data field for receiving data input by one or more users, the system comprising:
a front-end server accessible to the users over a network via an encrypted link; and
a secure back-end database for storing the electronic forms and the data;
wherein rights of the user to view select data in the electronic form is controlled by the server and wherein an electronic signature is applied to one or more of the sections that include the select data.

3. An electronic form routing system, the electronic form comprising multiple sections, wherein the sections are indicated by tags and at least one of the sections comprises at least one data field for receiving data input by one or more users, the system comprising:
a front-end server accessible to the users over a network via an encrypted link; and
a secure back-end database for storing the electronic forms and the data;
wherein rights of the user to view select data in the electronic form is controlled by the server based on the section tags.

4. An electronic form routing system, the electronic form comprising multiple sections, wherein the sections are indicated by tags and at least one of the sections comprises at least one data field for receiving data input by one or more users, the system comprising:
a front-end server accessible to the users over a network via an encrypted link; and
a secure back-end database for storing the electronic forms and the data;
wherein rights of the user to edit at least one of select sections and select data in the electronic form is controlled by the server based on the section tags.

5. An electronic form routing system, the electronic form comprising at least two sections, wherein the sections are indicated by tags and at least one of the sections comprises at least one data field for receiving data input by one or more users, the system comprising:
a front-end server accessible to the users over a network via an encrypted link; and
a secure back-end database for storing the electronic forms and the data;
wherein the users are assigned attributes and wherein a form creator indicates, using one or more of the tags, which of the sections of the form can be viewed or edited by the users based on the attributes assigned to the users.

6. An electronic form routing system, the electronic form comprising at least two sections, wherein the sections are indicated by tags and at least one of the sections comprises at least one data field for receiving data input by one or more users, the system comprising:
a front-end server accessible to the users over a network via an encrypted link; and
a secure back-end database for storing the electronic forms and the data;
wherein a form creator indicates, using one or more of the tags, which of the sections of the form can be viewed or edited by the users based on rules expressed in boolean logic.

7. An electronic form routing system, the electronic form comprising at least two sections, at least one of the sections comprising at least one data field for receiving data input by one or more users, the system comprising:
a front-end server accessible to the users over a network via an encrypted link; and
a secure back-end database for storing the electronic forms and the data;
wherein, upon the user inputting the data into one of the electronic forms and routing the form, one or more triggers are invoked to execute a set of one or more tasks.

8. The system of claim 7 wherein the one or more tasks comprise at least one of pushing the data to an external resource and pulling additional data from an external resource.

9. The system of claim 8 wherein the data stored in the external resource is consulted to determine whether to grant a second user with access to a physical location.

10. A method for routing an electronic form, the electronic form comprising at least two sections, at least one of the sections comprising at least one data field for receiving data input by one or more users, the method comprising:
providing the users with access to a front-end server over a network via an encrypted link;
storing the electronic forms and the data in a secure back-end database; and
supporting multiple mechanisms for allowing the user to authenticate to the front-end server.

11. A method for routing an electronic form, the electronic form comprising at least two sections, at least one of the sections comprising at least one data field for receiving data input by one or more users, the method comprising:
providing the users with access to a front-end server over a network via an encrypted link;
storing the electronic forms and the data in a secure back-end database; and
controlling rights of the user to view select data in the electronic form by the server,
wherein an electronic signature is applied to one or more of the sections that include the select data.

12. A method for routing an electronic form, the electronic form comprising multiple sections, wherein the sections are indicated by tags and at least one of the sections comprises at least one data field for receiving data input by one or more users, the method comprising:
providing the users with access to a front-end server over a network via an encrypted link;
storing the electronic forms and the data in a secure back-end database; and
controlling rights of the user to view select data in the electronic form by the server based on the section tags.

13. A method for routing an electronic form, the electronic form comprising multiple sections, wherein the sections are indicated by tags and at least one of the sections comprises at least one data field for receiving data input by one or more users, the method comprising:
providing the users with access to a front-end server over a network via an encrypted link;
storing the electronic forms and the data in a secure back-end database; and
controlling rights of the user to edit at least one of select sections and select data in the electronic form by the server based on the section tags.

14. A method for routing an electronic form, the electronic form comprising at least two sections, wherein the sections are indicated by tags and at least one of the sections comprises at least one data field for receiving data input by one or more users, the method comprising:
providing the users with access to a front-end server over a network via an encrypted link;
storing the electronic forms and the data in a secure back-end database; and
assigning attributes to the users
wherein a form creator indicates, using one or more of the tags, which of the sections of the form can be viewed or edited by the users based on the attributes assigned to the users.

15. A method for routing an electronic form, the electronic form comprising at least two sections, wherein the sections are indicated by tags and at least one of the sections comprises at least one data field for receiving data input by one or more users, the method comprising:
providing the users with access to a front-end server over a network via an encrypted link;
storing the electronic forms and the data in a secure back-end database; and
wherein a form creator indicates, using one or more of the tags, which of the sections of the form can be viewed or edited by the users based on rules expressed in boolean logic.

16. A method for routing an electronic form, the electronic form comprising at least two sections, at least one of the sections comprising at least one data field for receiving data input by one or more users, the method comprising:
providing the users with access to a front-end server over a network via an encrypted link;
storing the electronic forms and the data in a secure back-end database; and
invoking one or more triggers to execute a set of one or more tasks upon the user inputting the data into one of the electronic forms and routing the form.

17. The method of claim 16 wherein the one or more tasks comprise at least one of pushing the data to an external resource and pulling additional data from an external resource.

18. The method of claim 17 wherein the data stored in the external resource is consulted to determine whether to grant a second user with access to a physical location.
